(19) United States
(12) Patent Application Publication
(10) Pub. No.: US 2018/0113986 A1
(43) Pub. Date: Apr. 26, 2018

(54) METHOD AND SYSTEM FOR QUANTITATIVE CLASSIFICATION OF HEALTH CONDITIONS VIA A MOBILE HEALTH MONITOR AND APPLICATION THEREOF

(71) Applicant: Jiping Zhu, Flushing, NY (US)

(72) Inventor: Jiping Zhu, Flushing, NY (US)

(21) Appl. No.: 15/298,947

(22) Filed: Oct. 20, 2016

(51) Int. Cl. G06F 19/00

(52) U.S. Cl. CPC G06F 19/3418; G06F 19/322; G06F 19/3431

(57) ABSTRACT

A real time health monitor deployed on a mobile device is disclosed. From one or more sensors sensing health information of a user, the real time health monitor automatically obtains at least one health related measurement. The real time health monitor computes at least one of a vitality index and a health index based on at least one health related measurement and classifies, based on the vitality and health indices, the health of the user into some predetermined health condition classes. The real time health monitor then transmits the classified health condition class(es), via network connection, to a health service engine and receives health assistance information that is adaptively determined in accordance with the health condition class(es).

### BACKGROUND

### 1. Technical Field

The present teaching generally relates to mobile device application. More specifically, the present teaching relates to using mobile device application for monitoring and quantitatively classifying health conditions.

### 2. Technical Background

In the age of proliferation of handheld or mobile and wearable devices, daily life functions are more and more facilitated via communicating devices via the ubiquitous network connections. This includes health care related functions. For example, as shown in FIG. 1A, a wearable mobile device 120 can be used to keep track of the physical activities such as a number of steps that a user 110 has walked via, e.g., detected motion, and then send such activity data to an application 130 installed on a user's smart phone 125 so that the user can keep track of the level of activity each day via the mobile device. This use of wearable device in connection with a smart phone is to facilitate a user to monitor his/her own activity level via an application running on the smart phone.

As another example of the existing art related to wearables, as shown in FIG. 1B, in elderly care industry, a user 135 can carry a device with an emergency button thereon (not shown) so that when the user feels that he/she is in an emergency situation, such as a fall or in a health crisis situation, the user can physically activate the emergency button on the device to trigger a signal sent from the device to an emergency handling service 145. The signal may be routed to the emergency handling service 145 via a network 140 through a home-based (or facility-based) wireless base station 137. Although relying on also interconnection between a user and the emergency handling service 145, the user device in this prior art requires a user to self-initiate the emergency call. This prior art solution does not work well in situations in which a user is not able to self-initiate the emergency call.

Another type of prior system related to wearables is shown in FIG. 1C, where a user has a wearable device 150 which can detect the user's vital signs 160 and track the user's physical location via, e.g., a positioning service 155. When any of pre-determined vital sign signals an emergency situation of the user, the wearable device 150 generates an emergency trigger and sends this emergency trigger to a relay network 160, which is specifically constructed and connected to a monitoring center 165. To deliver the emergency trigger to a monitoring center 165, the rely network 160 may allocate appropriate relay units, e.g., 160-a, 160-b, 160-c, 160-d, 160-e, and 160-f to accomplish the delivery of the emergency trigger. This prior art system, although can automatically detect abnormal vital signs and trigger emergency when any vital sign falls within a range that warrants an emergency trigger, it has several drawbacks. First, it is only for emergency situation. That is, users are usually those who are under the surveillance of doctors due to some worrisome health conditions. For example, a doctor may distribute such a device to a patient who has severe artery blockage but not yet had a heart attack. Second, as the system works with a specifically designed relay network 160, it is used in a limited specialized in-network situation. Given those drawbacks, such prior art systems cannot be used by users in the general population who are healthy, sub-healthy, or although not healthy but not yet in a situation that requires emergency watch-out.

In today's society, in which the general population are paying more attention to preventative health care rather than merely react to health problems, none of the above prior art techniques provide a solution that allow both healthy and unhealthy people to live their lives in a more healthy way before health problems occur. Given the proliferation of wearables, mobile devices, and the ubiquitous network connections, new solutions are needed to allow the general population to benefit from real-time or timely health related consultations to facilitate personal health management via continuous monitoring of health condition and quantitative evaluation to facilitate on-the-point and networked health consultation, starting from when a person is healthy to prolong healthy period and enhance life quality.

### SUMMARY

The teachings disclosed herein relate to methods, systems, and programming for advertising. More particularly, the present teaching relates to methods, systems, and programming related to exploring sources of advertisement and utilization thereof.

In some embodiments, a real time health monitor deployed on a mobile device is disclosed. From one or more sensors sensing health information of a user, a wearable device automatically obtains at least one health related measurement. The real time health monitor computes at least one of a vitality index and a health index based on at least one health related measurement and classifies, based on the vitality and health indices, the health of the user into some predetermined health condition classes. The real time health monitor then transmits the classified health condition class(es), via network connection, to a health service engine and receives health assistance information that is adaptively determined in accordance with the health condition class(es).

In some embodiments, a health service engine is disclosed that provides health assistance to users of real time health monitors deployed on mobile devices. Via network connections, the health service engine receives from a real time health monitor deployed on a mobile device of a user, information of a location of the user and health information of the user, wherein the health information is estimated by the wearable device based on at least one of a vitality index and a health index associated with vitality and health of the user, respectively, which are computed by the real time health monitor in accordance with at least one health related measure of information sensed by one or more sensors. Upon receiving the information from the real time health monitor, the health service engine obtains health condition classification of the user, classified based on the at least one of the vitality index and the health index. Based on the health condition class(es) of the user, the health service engine determines, adaptively with respect to both the location of the user and the health condition of the user, health assistance to be provided to the user in response to the user's current health condition and delivers such adaptively determined health assistance to the user of the real time health monitor.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIGS. 1A-1C (PRIOR ART) illustrate prior art system configurations in using wearables in health care industry;

FIG. 2 depicts a high level configuration of a system in which a mobile device having a real time health monitor deployed thereon to continuously monitors vital/health data of a user and quantitatively classifies the user's health condition which is sent to the cloud to allow the user to receive online health assistance information, according to an embodiment of the present teaching;

FIG. 3A illustrates exemplary types of health data that a real time health monitor deployed on a mobile device is capable of continuously monitoring/measuring, according to an embodiment of the present teaching;

FIG. 3B illustrates exemplary types of vitality related data that a real time health monitor deployed on a mobile device is capable of continuously monitoring/measuring, according to an embodiment of the present teaching;

FIG. 3C illustrates exemplary types of peripheral instruments/devices from which a real time health monitor deployed on a mobile device can gather various health information on a continuous basis, according to an embodiment of the present teaching;

FIG. 3D illustrates exemplary types of mobile devices which can be used to deploy a real time health monitor, according to an embodiment of the present teaching;

FIG. 4A shows a time dependent curve representing relationship between age and a vitality index, according to an embodiment of the present teaching;

FIG. 4B shows a vitality index curve with critical points which are used to classify different health conditions of a person, according to an embodiment of the present teaching;

FIG. 4C shows a health index curve with different critical points that are used to classify health conditions of a person, according to an embodiment of the present teaching;

FIG. 5 shows exemplary heath condition classes that a real time health monitor is capable of classifying based on continuously monitored/measured vital/health information, according to an embodiment of the present teaching;

FIG. 6 illustrates exemplary types of online health assistance information that can be delivered to a user of a real time health monitor deployed on a mobile device, according to an embodiment of the present teaching;

FIG. 7 illustrates exemplary types of health intelligence that a user receives vis a real time health monitor deployed on a mobile device, provided based on the continuously monitored/measured health information from the real time health monitor, according to an embodiment of the present teaching;

FIG. 8A depicts an exemplary architecture of a real time health monitor deployed on a mobile device capable of continuously monitoring and classifying a user's health condition and delivering feedback online health assistance information, according to an embodiment of the present teaching;

FIG. 8B is a flowchart of an exemplary process of a real time health monitor deployed on a mobile device, according to an embodiment of the present teaching;

FIG. 9A depicts an exemplary high level system diagram of a peripheral data obtainer in a real time health monitor that connects with various instruments/devices for gathering monitored health information of a user, according to an embodiment of the present teaching;

FIG. 9B illustrates exemplary types of peripheral instruments/devices that a real time health monitor can be connected to gather monitored health information, according to an embodiment of the present teaching;

FIG. 9C depicts an exemplary high level system diagram of an emergency handling unit of a real time health monitor deployed on a mobile device, according to an embodiment of the present teaching;

FIG. 9D is a flowchart of an exemplary process of an emergency handling unit of a real time health monitor deployed on a mobile device, according to an embodiment of the present teaching;

FIG. 9E illustrates the connection between a real time health monitor deployed on a mobile device and various emergency contacts who can be notified in an emergency situation, according to an embodiment of the present teaching;

FIGS. 9F-9I illustrate exemplary GUIs that a real time health monitor presents to a user in different settings to facilitate the handling of the emergency situation, according to an embodiment of the present teaching;

FIG. 9J depicts an exemplary high level system diagram of an SOS handling unit of a real time health monitor deployed on a mobile device, according to an embodiment of the present teaching;

FIG. 9K shows an exemplary SOS calling scheme based on which a real time health monitor facilitate a user to request rescue, according to an embodiment of the present teaching;

FIG. 9L is a flowchart of an exemplary process for an SOS handling unit of a real time health monitor deployed on a mobile device, according to an embodiment of the present teaching;

FIG. 9M illustrates the connection among real time health monitors of different types of users in case of an emergency situation, according to an embodiment of the present teaching;

FIGS. 9N-9O illustrate exemplary GUIs that a real time health monitor presents to a user in different settings to facilitate the handling of a rescue, according to an embodiment of the present teaching;

FIG. 10 depicts an exemplary high level system diagram involving an online health condition determiner performing model based health condition classification based on continuously monitored user health data, according to an embodiment of the present teaching;

FIG. 11 is a flowchart of an exemplary process in which an online health condition determiner residing in a real time health monitor deployed on a mobile device classifies health conditions based on continuously monitored/measured vital signs/health information, according to an embodiment of the present teaching;

FIG. 12 is a flowchart of an exemplary process of an online health condition determiner residing on a server that classifies a person's health condition based on health information from the cloud that is continuously monitored/measured via a real time health monitor deployed on a mobile device, according to an embodiment of the present teaching;

FIG. 13 depicts an exemplary internal system diagram of an online health condition determiner, according to an embodiment of the present teaching;

FIG. 14 is a flowchart of an exemplary process of an online health condition determiner, according to an embodiment of the present teaching;

FIG. 15A depicts an exemplary internal system diagram of a vitality/health indices generator, according to an embodiment of the present teaching;

FIG. 15B is a flowchart of an exemplary process for an vitality/health indices generator, according to an embodiment of the present teaching;

FIG. 16A depicts an exemplary system diagram of an overall health condition classifier, according to an embodiment of the present teaching;

FIG. 16B is a flowchart of an exemplary process of an overall health condition classifier, according to an embodiment of the present teaching;

FIG. 17 depicts exemplary types of health classification models that are used in model based health condition classification, according to an embodiment of the present teaching;

FIG. 18A depicts the exemplary system diagram of a mechanism for generating various classification models for health condition classification, according to an embodiment of the present teaching;

FIG. 18B shows examples of models for classifying different health conditions, according to an embodiment of the present teaching;

FIG. 18C shows an example of a multi-dimensional Gaussian model that can be used for classifying health conditions, according to an embodiment of the present teaching;

FIG. 19 is a flowchart of an exemplary process for obtaining different health condition classification models, according to an embodiment of the present teaching;

FIG. 20A depicts an exemplary system diagram of a vitality based condition estimator, according to an embodiment of the present teaching;

FIG. 20B depicts an exemplary system diagram of a health data based condition estimator, according to an embodiment of the present teaching;

FIG. 20C depicts an exemplary system diagram of a disease specific vitality based condition estimator, according to an embodiment of the present teaching;

FIG. 20D depicts an exemplary system diagram of a disease specific health data based condition estimator, according to an embodiment of the present teaching;

FIG. 21A is a flowchart of an exemplary process for health data/vitality based condition estimators, according to an exemplary embodiment of the present teaching;

FIG. 21B is a flowchart for an exemplary process for disease specific health data/vitality based condition estimators, according to an exemplary embodiment of the present teaching;

FIG. 22 illustrates exemplary types of data used for health condition classification, according to an embodiment of the present teaching;

FIG. 23A depicts an exemplary system diagram of a health condition classifier, according to an embodiment of the present teaching;

FIG. 23B is a flowchart of an exemplary process for a health condition classifier, according to an embodiment of the present teaching;

FIG. 23C depicts an exemplary internal system diagram of an assistance information presentation unit, according to an embodiment of the present teaching;

FIG. 23D is a flowchart of an exemplary process for determining adapted GUI presentation parameters based on a user's specific situation, according to an embodiment of the present teaching;

FIG. 23E is a flowchart of an exemplary process of adapting presentation of online assistance information based on role of a user, toggle status of a GUI, and user preferred presentation parameters, according to an embodiment of the present teaching;

FIG. 24 depicts an exemplary framework of an online health service incorporating interconnected devices enabling real time monitoring and classification of health conditions, cloud based data center, a health service engine driving service entities responding to continuously classified health conditions, according to an embodiment of the present teaching;

FIG. 25 is a high level flowchart of an exemplary process of an online health service incorporating interconnected devices enabling real time classification of health conditions, cloud based data center, a health service engine driving service entities responding to continuously classified health conditions, according to an embodiment of the present teaching;

FIG. 26 illustrates the anyone, anytime, and anywhere nature of an online health service, according to the present teaching;

FIG. 27 illustrates exemplary types of medical condition responding entities in a health service framework, according to an embodiment of the present teaching;

FIG. 28 illustrates exemplary types of health care organizations that connect to the cloud to utilize big data in the cloud and the analytics stored therein, according to an embodiment of the present teaching;

FIG. 29 depicts an exemplary internal system diagram of a backend health service engine, according to an embodiment of the present teaching;

FIG. 30 is a high level flowchart of an exemplary process of a health service engine, according to an embodiment of the present teaching;

FIG. 31 depicts an exemplary internal system diagram of a response determiner responding to continuously classified health conditions, according to an embodiment of the present teaching;

FIG. 32 is a flowchart of an exemplary process for a response determiner that responds to continuous classified health conditions, according to an embodiment of the present teaching;

FIG. 33A depicts an exemplary system diagram for a response execution network in connection with other relevant components of a health service engine, according to an embodiment of the present teaching;

FIG. 33B depicts an exemplary system diagram of a rescue strategy determiner of a health service engine, according to an embodiment of the present teaching;

FIG. 33C depicts an exemplary system diagram of an SOS handling unit of a health service engine, according to an embodiment of the present teaching;

FIG. 34A illustrates exemplary types of events/situations that trigger generation of health care solution recommendations, according to an embodiment of the present teaching;

FIG. 34B depicts an exemplary system diagram for a health care recommendation generator, according to an embodiment of the present teaching;

FIG. 35A illustrates exemplary categories of situations for which real time feedbacks may be adaptively provided based on different health condition classifications, according to an embodiment of the present teaching;

FIG. 35B illustrates exemplary types of real time feedback related to life style factors adaptively generated based on monitored/measured health data, according to an embodiment of the present teaching;

FIG. 36 depicts the general architecture of a mobile device that may be used to implement a specialized system incorporating a real time health monitor; and

FIG. 37 depicts the general architecture of a computer which can be used to implement a specialized system incorporating the present teaching on health service engine 2410.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure generally relates to systems, methods, medium, and other implementations directed to enhancing current art of a mobile device deployed with a real time health monitor to enable improved real time health related services. Specifically, a real time health monitor is disclosed herein that is capable of continuously classifying a person's health condition into different classes based on trained models, by measuring/gathering various vital signs as well as health data of a user. The models are trained/constructed for both general health and with respect to the person's specific health/medical history. The continuously classified health condition is transmitted, e.g., with the monitored health related information (including monitored vital signs, health data, as well as other information), to the cloud to enable a health service provider to appropriately respond, in real time, to the person's health condition and provide suitable online health care assistance. Such online health assistance includes different level of services, determined based on the health conditions classified automatically based on the monitored health information. Different levels of services may include, but not limited to, (1) providing general health information when the classification of the monitored data indicates that the person is in a healthy condition, (2) caution the person when the classification of the monitored data reveals a decline in health condition or a trend towards a less desirable health direction by, e.g., suggesting measures on how to maintain a healthy life style, (3) alerting the person when classification of the monitored data indicate that the person may be developing some illness with some appropriate recommendation to address it by, e.g., providing the contact information of a local specialist selected based on the health condition classification, (4) warning the person if the classification of the monitored data indicates that the person may soon encounter a serious medical condition and providing, e.g., instructions in terms of how to handle (e.g., taking some medicine immediately), (5) emergency response when the classification of the monitored data indicates a serious medical condition by, e.g., notifying emergency contacts related to the person (e.g., relatives or responsible doctors) and organizing/scheduling/dispatching necessary resources needed for the rescue.

The real time health monitor may be implemented in hardware, as a software/firmware application, and can be deployed on a mobile device via any means that is known today or in the future. This includes, but not limited to, downloading it from a website, activation of a scan of a bar code, and/or a single click for installation, etc. Details of the present teaching related to the above aspects are provided below.

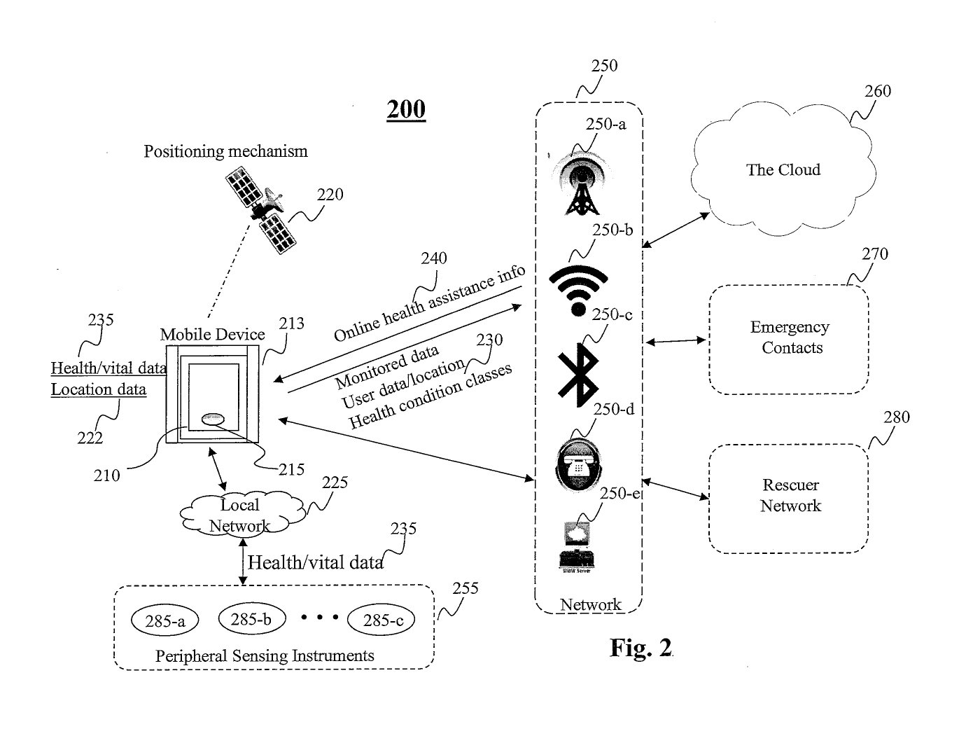

FIG. 2 depicts a high level configuration of a system 200 in which a real time health monitor 210 deployed on a mobile device 213 continuously monitors vital/health data of a user and quantitatively classifies the user's health condition which is sent, via the mobile device, to the cloud to allow the user to receive online health assistance information, according to an embodiment of the present teaching. In this exemplary configuration, the system 200 comprises a real time health monitor 210 deployed on a mobile device 213, a positioning mechanism 220, optionally one or more peripheral sensing instruments/devices 255, a network 250, and the cloud 260. The real time health monitor 210 is capable of communicating with, via the network 250, various emergency contacts 270 and/or rescuers in a rescuer network 280 when needed (determined by the real time health monitor 210).

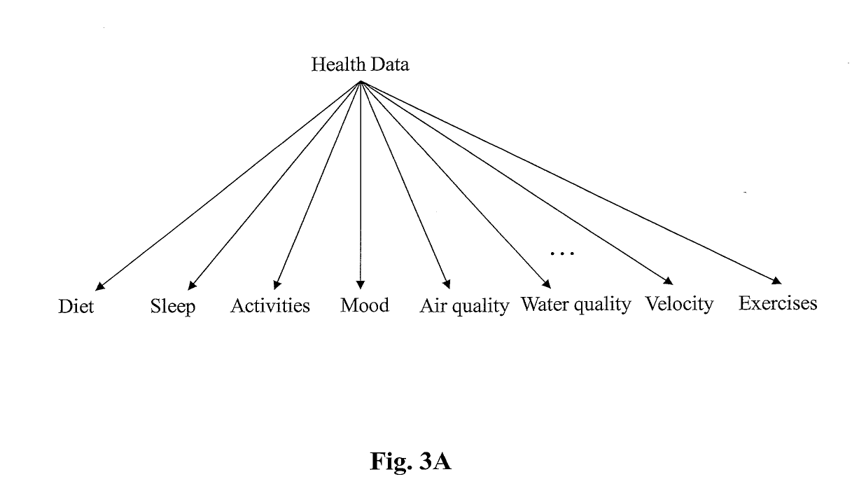

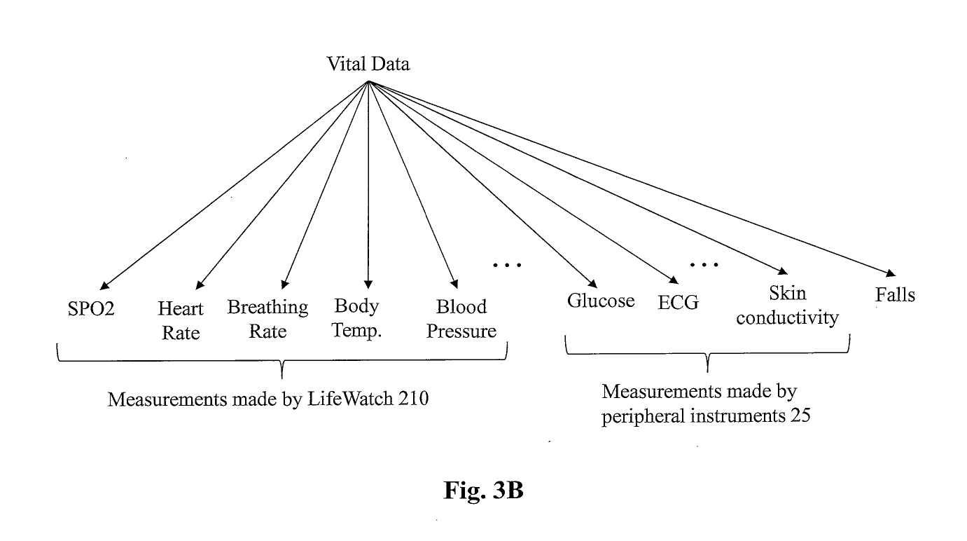

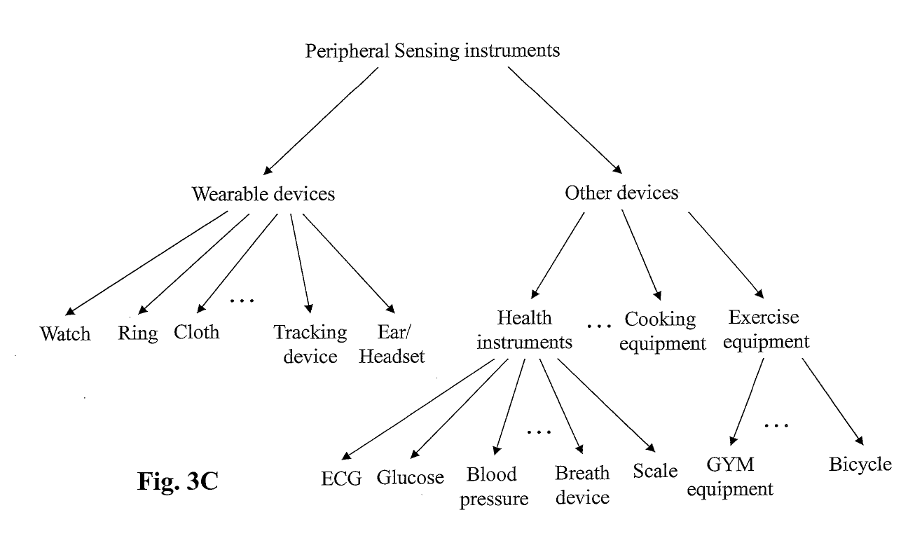

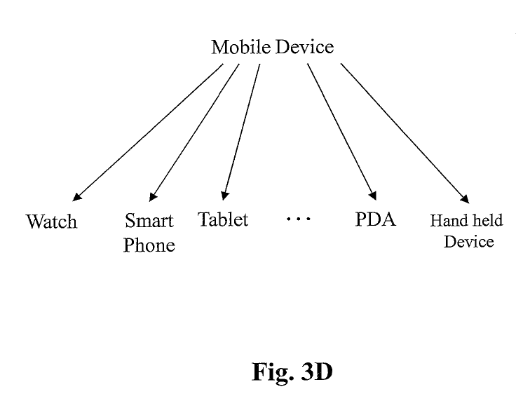

The real time health monitor 210 is designed to monitor various types of health related information, which includes health data and vital signs and either measured by the real time health monitor 210 or gathered from, e.g., the peripheral sensing instruments via a local network 225 (e.g., home wireless connection such as Bluetooth, etc.). Some exemplary health data that can be monitored are illustrated in FIG. 3A. Some exemplary vital signs that can be monitored by the real time health monitor 210 are illustrated in FIG. 3B.

The real time health monitor 210 is capable of classifying, in situ or through a backend server, the monitored health related information into one or more health condition class(es). The real time health monitor 210 is continuously connected to the network 250, sending relevant information (including monitored information 235, user's location, and/or classified health condition classes) to the cloud 260 so that such information may be utilized by a backend health service provider (disclosed later) to determine how to respond to the health condition of the user of the real time health monitor 210. In case of emergency, the real time health monitor 210 may be configured to handle the emergency situation by reaching out, automatically, to various emergency contacts via the network 250 and/or triggering SOS calls, automatically, to rescuers in the rescuer network 280 to effectuate timely rescue.

The network 250 may include wired and wireless networks, including but not limited to, cellular network 250-a, wireless network 250-b, Bluetooth network 250-c, Public Switched Telephone Network (PSTN) 250-d, the Internet 250-e, or any combination thereof. For example, the real time health monitor 210 may be wirelessly connected via Bluetooth 250-c to a cellular network 250-a, which may subsequently connected to a PSTN 250-d, and then reach to the Internet 250-e before reaching to the cloud 260. Similarly, the local network 225 may also be at least one of different types of networks, including, but not limited to, wired or wireless connections such as cellular, Bluetooth, Internet, telephone lines, or any other form of home/facility based network connections (not shown).

In operation, the real time health monitor 210 continuously monitors the vital/health data 235 related to a user, e.g., of the mobile device 213. With respect to vital signs, they are continuously measured and calibrated with respect to various conditions such as skin temperature, body movement, moisture level of the physical environment, etc. With respect to health data, it is known that there are various factors that affect the health of people and that can be controlled in order to enhance the heath. Such factors include diet, sleep (how well a person sleeps and how much a person sleeps), mood (e.g., stress affects health), and level of activity (e.g., exercise). According to the present teaching, such health data may also be continuously monitored by the real time health monitor 210. Measurements of the health data may also be calibrated skin temperature, body movement, moisture level of the physical environment, etc.

As discussed herein, the real time health monitor real time health monitor 210 is configured to be able to communicate with one or more peripheral sensing instruments 255 via a local network 225 to collect additional measurements of health related information (vital signs or other health data) continuously monitored by the corresponding peripheral sensing instruments 255. While there may be some limitation as to what the real time health monitor 210 may be able to measure near the vicinity of the physical body of a person, the ability of the real time health monitor 210 to continuously monitor health related information is expanded by gathering, wired or wirelessly, additional measurements from peripheral instruments 255. For example, a glucose level detected using a special instrument may be transmitted from the glucose instrument to the real time health monitor 210. An electrocardiogram (EKG or ECG) device may also be connected via the local network 225 to the real time health monitor 210 to transmit detected heart related measuresreal time health monitor 210. Optionally, a peripheral sensing instrument may also be configured to detecting the atmosphere such as air quality or the metal level in drinking water and send such measurements to the real time health monitor 210 as health related data. In some embodiments, measurements made by the peripheral instruments 255 may also be entered manually into the real time health monitor 210, e.g., by a user. This may be a useful operation mode when, e.g., the local network 225 is not operational.

The continuously monitored health related information, i.e., vital signs and health data, either measured by the real time health monitor 210 or by any of the peripheral sensing instrument 255, are then used, in situ (or alternatively in a server as will be disclosed later), by the real time health monitor 210 to classify the person's health condition into different classes. The classification is carried outbased on different models, trained using big data available in the cloud 260. As will be disclosed in detail below, such models may be generic, disease-specific, and individualized with respect to the person who is a user of the real time health monitor 210.

In addition to the vital signs/heath data, the real time health monitor 210 also continuously monitors the location of the mobile device 213. This is via communication with a positioning mechanism 220. Exemplary positioning mechanism may include, but not limited to, GPS. Location information may also be determined via other means (not shown in FIG. 2) such as via the network location estimated based on, e.g., Bluetooth network access point, wireless network access point, IP address of a router in a home network associated with, e.g., the Internet service, etc. With this functionality, the physical location of the user of mobile device 213 can be also continuously monitored. Such detected location will facilitate various applications/functionalities of the real time health monitor 210, as will be disclosed below.

Upon monitoring measurements of various types of health related information, the health condition classes, as well as the location data associated with the user of the mobile device 213 where the real time health monitor 210 is deployed, the real time health monitor 210 may send such continuously obtained information to the cloud 260. In some embodiments, the real time health monitor 210 sends the measurements of the monitored data, health condition classifications obtained in situ, as well as the person's information and location data to the cloud 260. In some embodiments, the health condition classifications may be alternatively obtained by a server in the cloud 260 and in this situation, the real time health monitor 210 may send monitored data with the person's information to the cloud 260. The health condition classification may be performed in the cloud 260 or by some health service engine residing behind the cloud 260. In some embodiments, although the real time health monitor 210 may classify the health condition into different class(es) and send such classification to the cloud 260, a server residing in the backend may still perform classification of the person's health condition based on received monitored health related information (vital signs and health data).

In some embodiments, the real time health monitor 210 is configured to, in response to classified health condition class(es), automatically handle some responses needed to assist the person to get the medical attention the person needs. The real time health monitor 210 may be configured to communicate, when necessary, with one or more emergency contacts to inform them the health status of the user or initiate calls to a selected group of rescuers when, e.g., the person being monitored user is in a serious condition. For example, if the person being monitored is critically ill (e.g., heart attack), the real time health monitor 210 may detect that. In response to that, the real time health monitor 210 may automatically contact various emergency contacts 270 whom the person being monitored has previously identified and/or send SOS calls to a group of known rescuers 280. Details related to these functionalities are provided below.

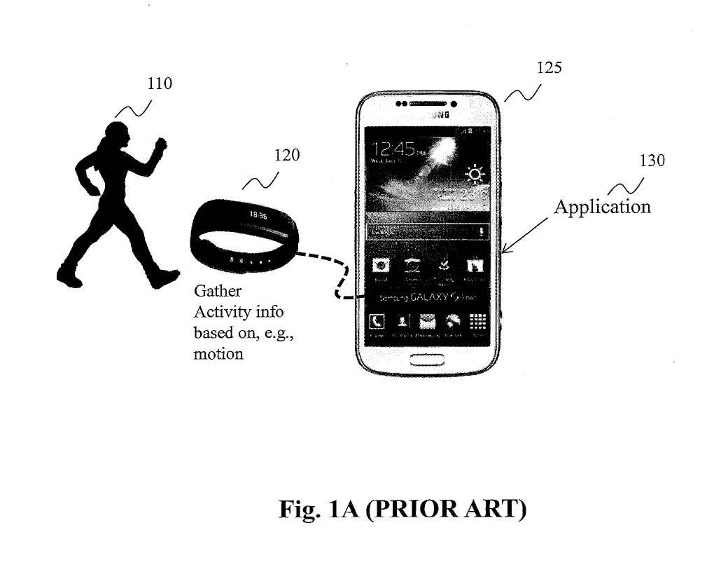

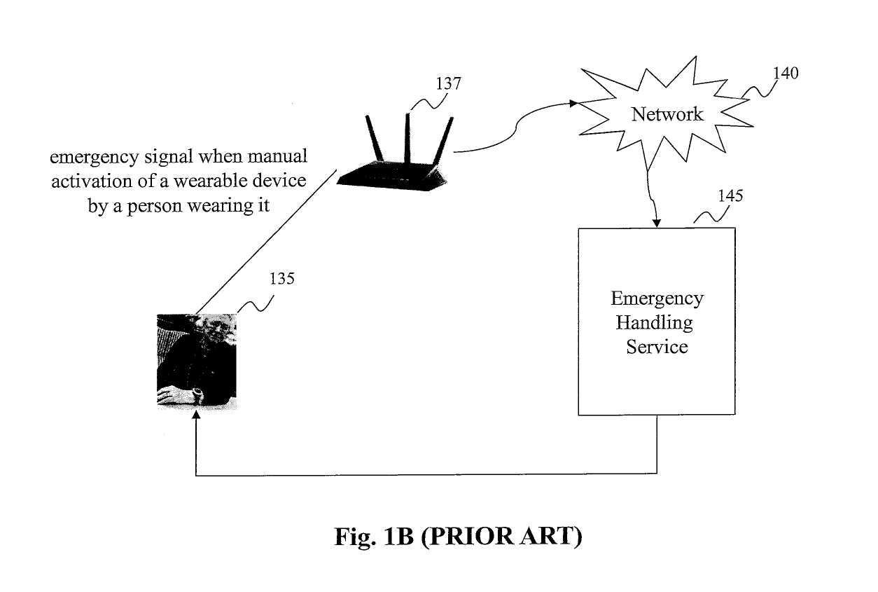

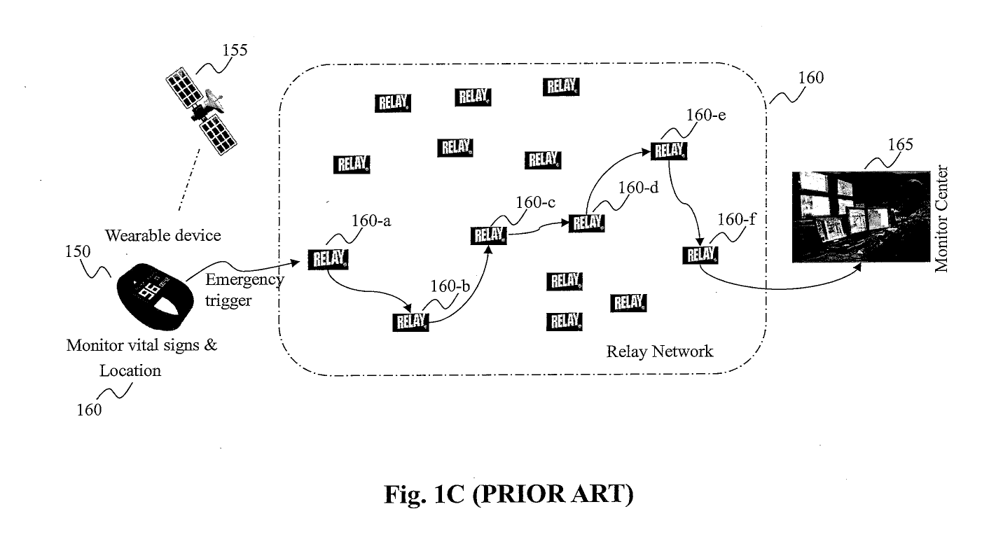

In FIG. 2, it is illustrated that the real time health monitor 210 may also present an actionable component, such as a button 215, which can be used by the person being monitored to activate a call for help in case of need. Although prior art as shown in FIG. 1B also allows a user to activate an actionable button to notify a designated center that help is needed, the real time health monitor 210 as disclosed herein will, when the button 215 is pressed, initiate automated emergency handling in situ, as will be discussed later.

Once the monitored information, which may also include health condition classifications, is sent to the cloud 260, the real time health monitor 210 receives feedback online health assistance information 240, which is provided in response to the information that the real time health monitor 210 sends to the cloud 260. When health condition classification is performed in situ and sent to the cloud 260, the online health assistance information 240 received from the cloud 260 may be responses directed to the health condition classification. If the health condition classification is to be performed by a server, the received online health assistance information 240 may include both the health condition classification obtained by, e.g., a health service engine behind the cloud (not shown) and the responses to such health condition classification.

In some embodiments, the online health assistance information is sent from the cloud to the real time health monitor 210, as illustrated in FIG. 2. In some embodiments, instead of sending to the real time health monitor 210, the online health assistance information may be transmitted to alternative destinations, including but not limited to, some other devices, including, but not limited to, a mobile device, a phone, a tablet, a computer such as a laptop or desktop, specified applications such as email inbox, or even in paper form as a postal mail to a third party. The person being monitored may specify one or more destinations as where the online health assistance information 240 is to be sent.

Responding to the health condition classifications, the online health assistance information may provide different types of information aimed to assist the person being monitored by the real time health monitor 210 to address health related issues. The timing to receive the online health assistance information may be real time, periodic, or as needed, which is determined, e.g., based on various considerations. For example, when the health condition is classified as a health emergency situation, the online health assistance information may be sent in real time to, e.g., asking the person to take some medication immediately or carrying out a rescue. If the health condition classification is that the person is healthy and the person subscribes services of monthly report, in this case, the online health assistance information may not be sent immediately in response to any non-urgent health condition classification but rather will be sent one month from the previous one sent to the person.

The content of the online health assistance information may also vary based on the health condition classification. For example, if it is detected that the blood pressure of the person being monitored by the real time health monitor 210 has been in a rising trend, before the blood pressure level exceeds a medically defined threshold that is considered abnormal, the content of the online health assistance information 240 may include recommended approaches to take to improve life style (e.g., diet, exercise, sleep, etc.) that may lead to slow-down or a reversal of the problematic trend. On the other hand, if the blood pressure starts to creep very close to or exceed the threshold, the online health assistance information 240 may include content on recommended local physician to visit or even the means to make an appointment with the recommended physician. If a person is in an emergency situation, the online health assistance information 240 may include content such as voice instruction from a physician directing the person or nearby family members to do, e.g., taking medicine or lying down, so that the person is safer until the rescue arrives.

The process of monitoring the health related information of a person and receiving online health related assistance as described above is continuous, anytime and anywhere. A person being monitored by the real time health monitor 210 can thus benefit from the online health assistance information 240 around the clock. The online health service via the real time health monitor 210 can be provided not only in emergency situations but also when the user is other health conditions, including in a perfect health condition, in a sub-health condition, or in a unhealthy condition. Thus, the real time health monitor 210 is more than an emergency handling mechanism and it also serves as a means to enable continuous health related consultation/services in different situations without having to visit or talk to a professional. Such consultation includes educating a user what is a healthy life style and how to live in a healthy life style (e.g., directed to currently healthy yet health conscious users), advising how to improve health (e.g., directed to users who start to slip in terms of health), suggesting what actions a person needs to take (e.g., directed to users who started to develop health problems), etc.

As disclosed above, the real time health monitor 210 is capable of monitoring both vital sign related information as well as health data. FIG. 3A illustrates exemplary types of health data that the real time health monitor 210 and/or peripheral instruments 255 are capable of continuously measuring/monitoring, according to an embodiment of the present teaching. Health data to be monitored by the real time health monitor 210 include, but not limited to, diet, sleep, mood, activity level, environmental factors such as air/water quality, velocity of the body (to detect a fall), etc. Some types of data that may be related to the well-being of the person being monitored by the real time health monitor 210 may also be monitored. Other types of data may be monitored to detect an accident. For example, monitoring the velocity or its rate of change of the body of the person is to, e.g., detect a fall of the person. Yet more types of health data may be for detecting some external factors that may affect the health of the person such as air or water quality.

FIG. 3B illustrates exemplary types of vital signs that the real time health monitor 210 is able to monitoring/measuring (either directly or via also the peripheral instruments 255), according to an embodiment of the present teaching. Vital sign related data to be monitored by the real time health monitor 210 include, but not limited to, heart rate, breathing rate, body temperature, blood pressure, peripheral capillary oxygen saturation (generally called SpO2, which estimates the amount of oxygen in the blood), etc. While some of the vital signs may be measured directly by the real time health monitor 210, additional vital signs may be gathered by the real time health monitor 210 via local network connections from other devices/instruments. Different types of vital sign related data may be gathered from the peripheral instruments 255. Examples include glucose level, the measurement from an EKG/ECG device, skin conductivity of the person measured by a peripheral devices, or a fall of the preson. The mechanism of the real time health monitor 210 to accomplish continuous monitoring of such health/vital data is disclosed in reference to various subsequent figures.

FIG. 3C provides some exemplary types of peripheral devices/instruments from which the real time health monitor 210 may gather additional health related information, according to an embodiment of the present teaching. As illustrated, a peripheral device/instrument can be either wearable or other (non-wearable) devices. With respect to wearable peripheral devices/instruments, they can be a watch, a ring, a piece of cloth, a tracking device, an ear set, a headset, etc. A person may wear multiple wearable devices each of which may be configured for measuring some health related information. Such wearable devices/instruments are capable of communicating with the real time health monitor 210 to transmit health related information to the real time health monitor 210. In some embodiments, a peripheral device may initiate the transmission whenever there is a reading on the monitored data. In some embodiments, a peripheral device may passively transmit the monitored data upon receiving a request from the real time health monitor 210.

Other (non-wearable) devices that can provide additional measurements to the real time health monitor 210 include, but not limited to, health instruments, cooking equipment, and exercise equipment. Peripheral health instruments may include EKG/ECG instrument, glucose measurement instrument, blood pressure device, breath measurement device, or a scale for measuring the weight of a person. Cooking equipment may include a microwave for detecting the serving portion, an oven for detecting the same, a blender to detect fruit/vegetable consumption, etc. (not shown). Exercise equipment may include a treadmill, an elliptical device, a bicycle, etc. for, e.g., measuring the distance run/walked or exercises performed per day/week.

In some embodiments, the real time health monitor 210 may request a sub-set of data monitored by and available from a peripheral device. For example, a treadmill is capable of collecting different types of data such as heart rate profile for each exercise session, or minutes walked with speed information, or calorie burned. The treadmill may be requested to send only a sub-set of data it can monitor based on, e.g., what the wearable device 210 requests (e.g., the heart rate profile), or send all the information it collected.

FIG. 3D illustrated exemplary types of mobile devices that can be used to deploy the real time health monitor 210, according to an embodiment of the present teaching. The illustrated types include, but not limited to, a watch, a smart phone, a tablet, a Personal Data Assistant (PDA), any type of hand held devices, or some mobile device that projects an interface on an external interface for human machine interfaces.

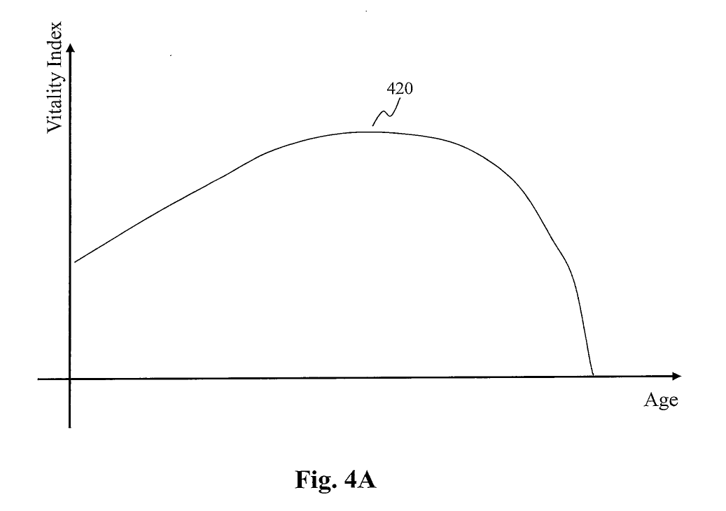

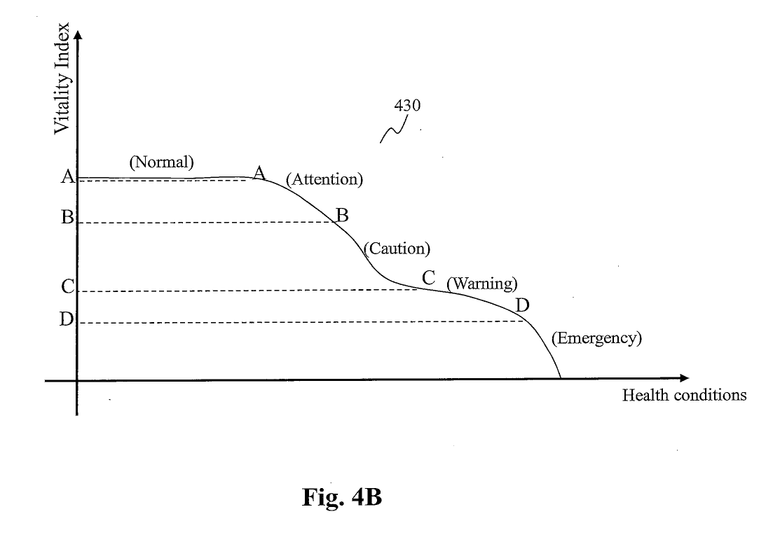

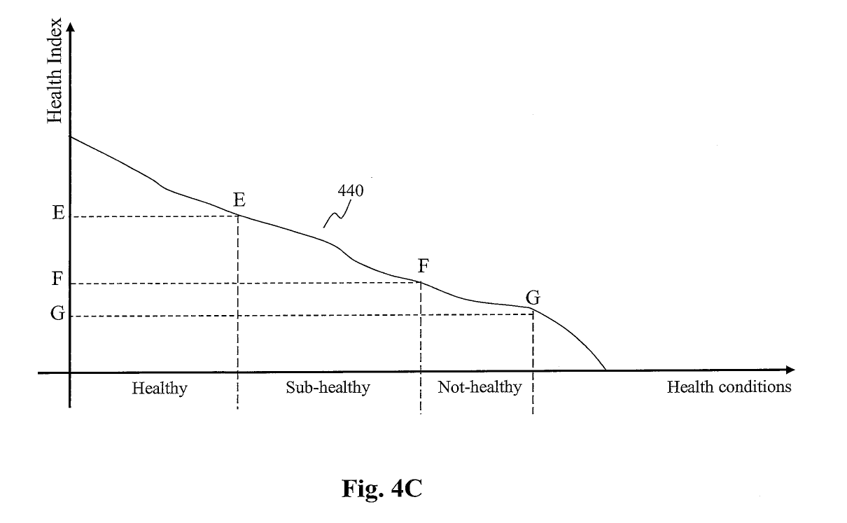

Before disclosing the details related to different aspects of the real time health monitor 210, some discussion herein is provided with respect to the concepts of vitality index, health index, as well as health conditions that can be classified based on vitality index and/or health index. FIG. 4A shows a time dependent curve 420 representing relationship between age and a vitality index, according to an embodiment of the present teaching. In FIG. 4A, the X axis represents age and Y axis represents vitality index. Vitality refers to a person's ability to overcome risks and can be measured based on vital signs. A vitality index corresponds to a quantified level of strength of a person's vitality. The curve 420 in FIG. 4A indicates that during a person's life span, vitality index changes with time. For example, on average, when a person is very young (e.g., as an infant or a child), the vitality index is relative low, indicating lesser ability to overcome health risks. The same can be said about when a person nears the end of life, the vitality index drops sharply, indicating the vulnerability in an elderly to overcome the risks related to health. In general, the vitality index in the middle portion (e.g., young and middle age of a person) of the plot in FIG. 4A is higher, indicating a higher level of ability during that period of one's life to combat health related risks.

FIG. 4B shows a vitality index curve 430 with critical points which are used to classify different health conditions of a person, according to an embodiment of the present teaching. The vitality curve 430 is in a coordinate system in which the X axis represents the codes for health conditions (classes) classified based on vital index and Y axis represents the vitality index. The vitality curve 430 illustrates the relationship between codes of health conditions (based on vitality index) and the vitality index measured from a person. On the curve 430, there are several critical vitality points, A, B, C, and D, each of which is representative of a transition from one health condition code to the next. For example, when the vitality index is equal to or above B, the person's health condition is normal. When the vitality index is between A and B, the person's health condition may have started to show some signs of concern (e.g., blood pressure level is right below the high end of normal range) and attention needs to be paid in order to maintain the normal health condition. When the vitality index is between B and C, some problematic vital signs (e.g., blood pressure level is above the normal range) may have been observed that indicates that the person may be in a sub-health situation and need to be cautious by, e.g., visiting a doctor to have a check out. When the vitality index is between C and D, the health condition is such that the person needs to be warned of the worrisome condition, e.g., a heart attack may be under way. When the vitality index is below D, the person likely already is in a dangerous health condition and needs to be immediately rescued.

FIG. 4C shows a health index curve 440 with different critical points that are used to classify health conditions of a person, according to an embodiment of the present teaching. This curve 440 is similar to curve 430 except that curve reflects the relationship between a health index (rather than vitality index for curve 430) and the health conditions of a person. In FIG. 4C, the points E, F, and G on curve 440 may correspond to critical points in the health index value that represent transition points from on health condition to the other. For example, when the health index value is equal or above E, the person's health condition may generally be considered “healthy.” When the health index value of a person is between F and E, the person's health condition may be generally classified as “sub-healthy.” When the health index of a person is between G and F, the person's health condition may be generally considered as “not healthy.” When the health index of a person is below G, the person's health condition may be classified as “critical condition” (not shown).

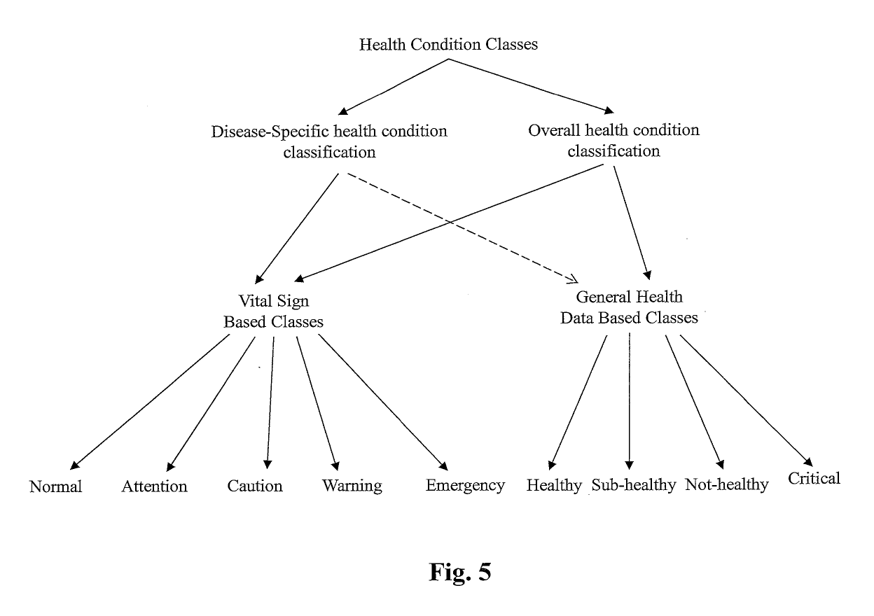

FIG. 5 shows exemplary heath condition classes that the real time health monitor 210 is capable of classifying based on continuously monitored/measured vital/health information, according to an embodiment of the present teaching. As shown, health condition classes may be from two different branches. For example, some classification may be directed to the overall health conditions. As another example, when it is known that some people may already have pre-existing conditions/diseases, health condition classification specific to the conditions/diseases that such people are suffering from may also be performed. With such separate classifications, a person may not only be monitored for the overall health in general but also be watched for with respect to the particular conditions/diseases associated therewith.

As a person's overall health condition may depend on not only the vital signs but also general health data related to the person's life style or mode, etc., health conditions may be estimated either based on vital signs or general health data or both. Thus, the overall health condition of a person may be dependent on both health condition classification estimated based on vital signs and the health condition classification estimated based on general health data such as diet, sleep, activity, mode, etc., as shown in FIG. 5. On the other hand, the disease-specific health condition classification may depend on vital related measures alone in monitoring for life threatening situations. However, in certain situations, a change in general overall health of a person may improve the condition associated with a disease. So, in a different embodiment, estimating disease-specific health conditions may also use information related to the overall health condition classification, as the dotted line shows in FIG. 5. As discussed with respect to FIGS. 4A and 4B, in some embodiments, health condition can be classified, using vital index, into different states such as normal, attention, caution, warning, and emergency. Health condition can be classified, based on health data and possibly also vital related data (not shown in FIG. 5), into several categories such as health, sub-healthy, and not-healthy, or possible rescue state.

The real time health monitor 210 as disclosed herein is designed to continuously monitor the vital signs/health data of a person, estimate the person's health conditions via model based classification, automatically react to the situation as needed, and report the same to the cloud 260. Backed by the cloud 260, a health service engine (discussed later) may then determine a response based on the classified health condition and execute the response. Depending on situation, there may be different responses. In some embodiments, the response from a backend system is to provide online health assistance information to the real time health monitor 210 (or any other specified destinations) generated in response to the health condition of the person at that point of time.

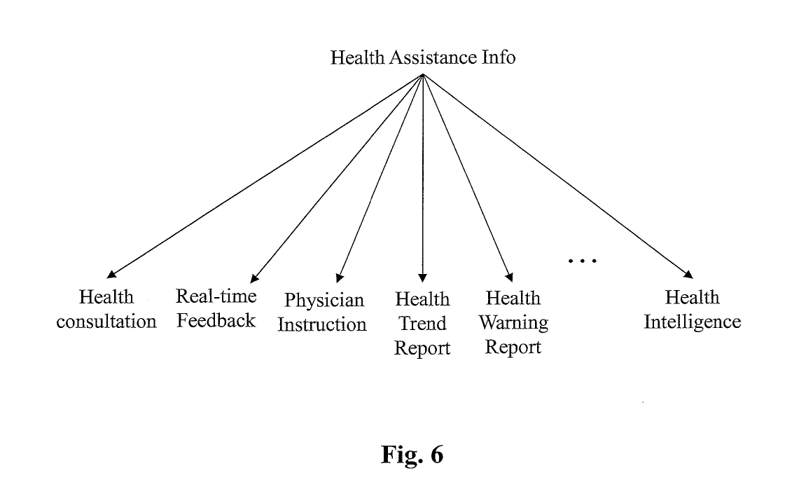

FIG. 6 illustrates exemplary types of online health assistance information that can be delivered to a person via either a real time health monitor 210 or other means as discussed previously, according to an embodiment of the present teaching. The online health assistance information may include general health consultation, real time feedback, physician online instruction, health warning report, health trend report, or health related intelligence. The real time feedback may correspond to an organized rescue (in case of emergency) or an urgent warning report (in case of warning health condition) indicating a likely medical event with, e.g., a recommendation for an immediately doctor visit. Depending on the health condition and the situation related to the locale of the person monitored by the real time health monitor 210, the health assistance information may include some physician instructions on, e.g., what emergency medicine to take (in case of warning). In some situations, a health condition may lead to a health assistance feedback with a suggestion to contact a specialist for a check-up (in case of alert). In some embodiments, when there is no urgent situation, the health assistance information may include materials on certain diet information or particular type of exercise that may be useful to help a user to improve the overall health (in case of caution). The online health assistance information may also be a health update report which may include information on trends in health care and possibly some health intelligence (in case of normal health condition).

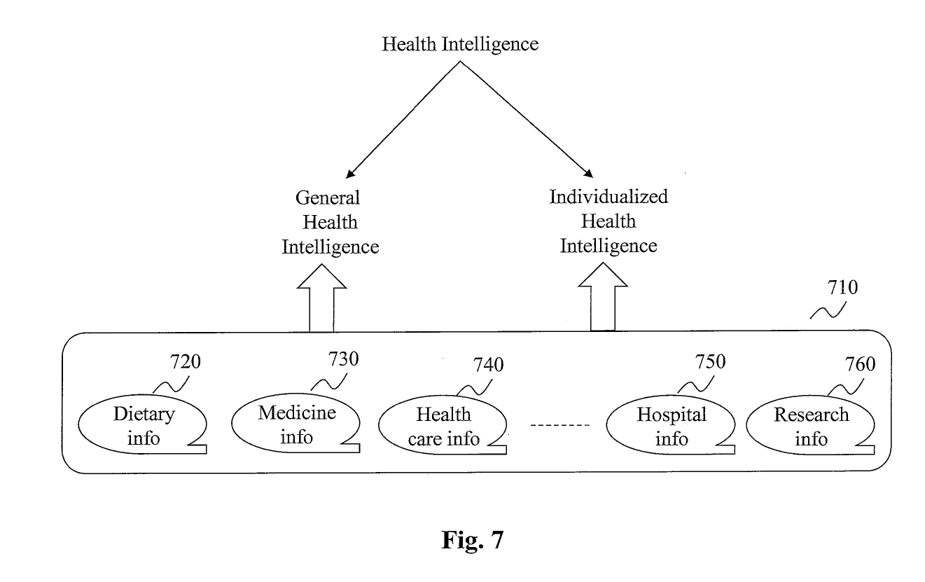

FIG. 7 illustrates exemplary types of health intelligence that a user may receive on a real time health monitor 210, provided based on the continuously monitored/measured health related information from the real time health monitor 210, according to an embodiment of the present teaching. The health intelligence may be provided to the real time health monitor 210 (or any other specified destinations) in different categories. For instance, health intelligence may be provided in terms of general health related intelligence. Examples of general health intelligence may include information related to, e.g., diet recommendations, exercises and their impact on health, or advancement in medicine or food industry.

In addition, the health intelligence may also be provided with individualized health intelligence that is specifically customized according to the particular health condition of the user of the real time health monitor 210. For example, if a user A suffers from type I diabetes, health intelligence related to type I diabetes may be automatically gathered by the health service engine and send to the real time health monitor 210. If another user B has cancer and is in a current state of remission, the individualized health intelligence provided to user B will be different, e.g., it may include information on the recent advancement on this particular type of cancer and information on how to maintain cancer free in this situation. Such individualized health intelligence may range from diet control, suitable exercise, local specialist ratings, any advancement in the medical industry on some specific disease, or success stories in terms of how to manage this particular disease.

Either category of health intelligence, whether general or individualized, may be drawn from a pool 710 of health related information, which may be gathered from different sources on the Internet. The health service engine may be designed to identify such useful sources of information, gather relevant content from such sources, monitor the changes in content at such sources, and manage accordingly the dynamics of the gathered content in pool 710. In some embodiments, the pool 710 may include gathered information related to different types of diet 720, updates on medicine/research 730, health care information 740 in general such as distribution of physicians and specialists, pharmacies, etc., hospital information 750, . . . , and updated information related to different health care related research 760. The general health care intelligence may be pulled from the pool 710 as general update on health intelligence without specific regards of particular situation of the person, while the individualized health intelligence may be pulled from the pool 710 in such a manner that content so gathered is with the individual's health history/situation in mind.

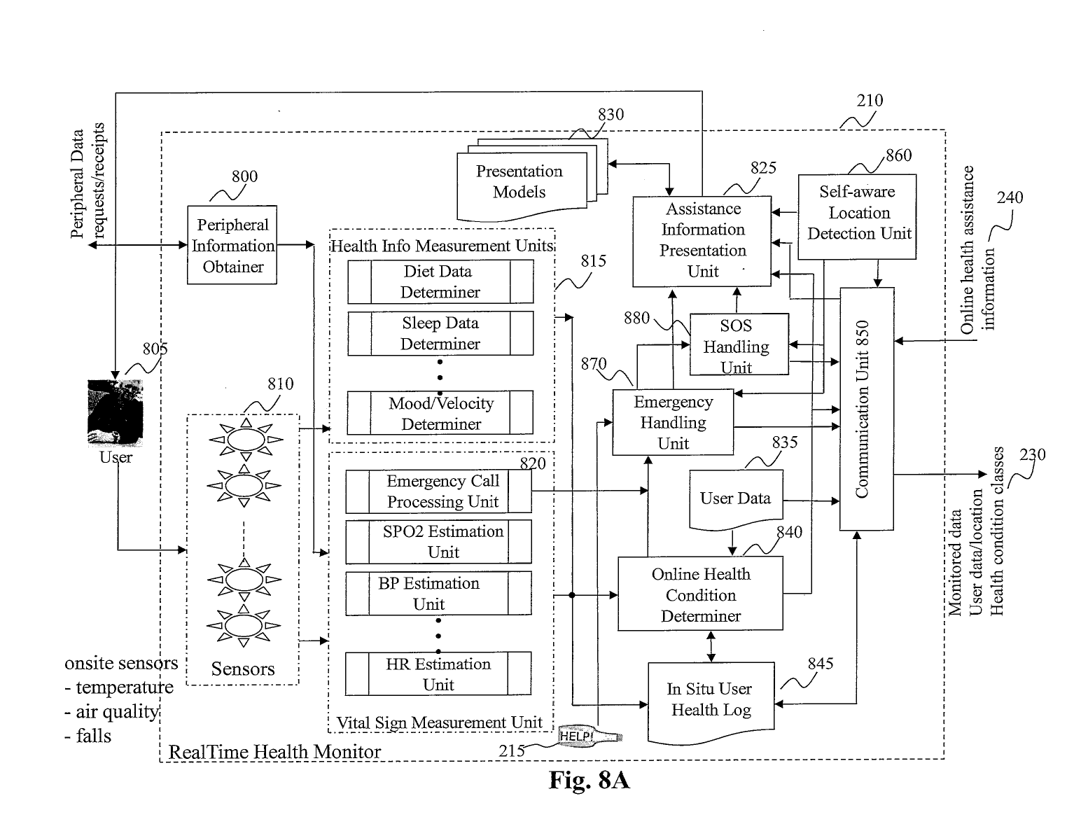

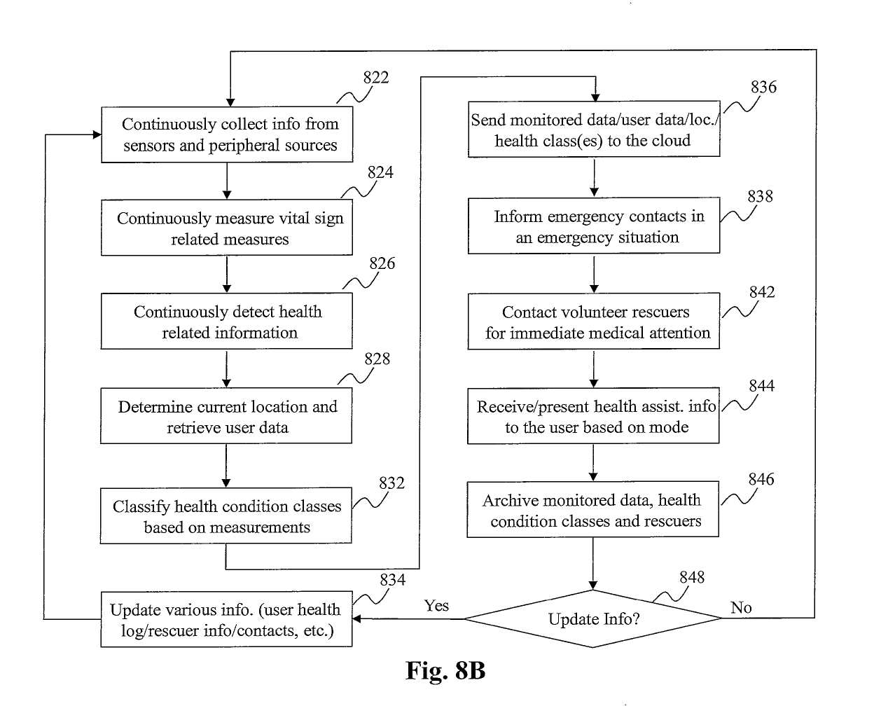

FIG. 8A depicts an exemplary architecture of a real time health monitor 210 capable of continuously monitoring and classifying a user's health condition and delivering feedback online health assistance information to a person monitored, according to an embodiment of the present teaching. As can be seen, the real time health monitor 210 may comprise sensors 810, health data measurement units 815, vital sign measurement units 820, an online health condition determiner 840, a self-aware location detection unit 860, a communication unit 850, and an assistance information presentation unit 825. The real time health monitor 210 may also comprise additional components including a peripheral data obtainer 800, via which the real time health monitor 210 communicates with other external or peripheral devices/instruments to gather additional health/environment data monitored by those devices/instruments. In addition, the real time health monitor 210 may also comprise components that can self-initiate emergency handling in situations that such handling is called for. Such components include an emergency handling unit 870 and an SOS handling unit 880. For example, when the real time health monitor 210 detects that the elderly person being monitored falls or the health condition of the elderly person is classified as emergency, these two components may be invoked to, e.g., inform certain emergency contacts and make SOS calls to certain personnel for the rescue when the person wearing the device 210 is in need of immediate care.

In operation, the sensors 810 are provided to facilitate the real time health monitor 210 to detect, in situ, various vital signs and/or health data. Each of such sensors may be designed to gather different types of information to be used to make measurements of vital signs/health data. For example, sensors 810 may include sensors for sensing, e.g., the velocity of the body of the person monitored by the real time health monitor 210, etc. Other sensory data may be obtained, by the peripheral data obtainer 800, from, e.g., any of the peripheral instruments 255. The sensed data, including the ones from in situ and the ones from the peripheral instruments 255, are then sent to the health information measurement unit 815 and the vital sign measurement unit 820 for computing health related data.

One of the sensors may be associated with the emergency button 215. Such a sensor may correspond to an actionable button on the mobile device 213 or a soft button rendered on an interface of the real time health monitor 210. When this button is activated, a signal is sent to the vital sign measurement unit 820 which includes an emergency call processing unit therein, which may be dedicated to process an emergency call with, e.g., a high priority.

Based on information provided by sensors (810 and 255), the health data measurement units 815 compute different measurements with respect to different types of health data via corresponding health data determiners (e.g., diet, sleep, mood, activities, velocity, etc.). Similarly, based on the sensed information, the vital sign measurement unit 820 includes different estimation units, each of which computes at least one measure with respect to a different vital sign (e.g., SpO2, blood pressure, heart rate, breathing rate, body temperature, etc.).

The determined health data (from heath data measurement unit 815) and vital signs (from vital sign measurement unit 820) are then fed to the online health condition determiner 840, which carries out the classification of the person's health condition based on the computed vital signs and health data. In classifying the person's health condition, the online health condition determiner 840 does so based on both user's data 835, which includes both general information about the user as well as specific health/medical information of the user. General information about the user includes, but not limited to, personal and medical identifications of the user, birth date, age, gender, weight, height, contact information, etc. Specific information related to the person's health or medical related information such as medical history, family members' medical history, past/current medical conditions, general medical information such as medicine/food allergies, blood type, past operations and details thereof, etc. may be stored in the real time health monitor 210 and may be retrieved when needed. For example, when an emergency situation occurs and emergency handling is activated, such information may be sent, together with the monitored data and the health condition classification, to, e.g., to a third party such as the cloud 260, to a backend health service provider, or to one or more rescuers. Examples of information that may be transmitted to a third party may include general user information such as name/identification/contact information, general medical information of the user such as blood type, allergies, user's medical history, or past/current medical conditions.

As mentioned above, the classification may yield different health conditions, sometimes indicating normal and routine condition, sometimes cautioning an undesirable movement in health trend, sometimes alerting a medical condition in progress that needs to be addressed, and sometimes an emergency situation that requires, e.g., immediately attention such as rescue. Such health condition classification may be sent, by the online health condition determiner 840, to the communication unit 850 so that such information can be forwarded to the cloud 260 which is connected to, e.g., a backend health service provider. When sending the health condition classification of the user monitored by the real time health monitor 210, relevant user's data 835 (e.g., identification of the user) and the physical location of the user are also sent to the cloud 260 via the communication unit 850. The user's physical location is obtained by the self-aware location detection unit 860.

Once the user health condition classification, together with user's location and user's information, is sent to the cloud 260, the communication unit 850 subsequently receives, via wired or wireless network connection, online health assistance information 240. As discussed previously, the online health assistance information 240 is determined according to the health condition classification derived by the online health condition determiner 840 based on the monitored health related information. As also discussed with respect to FIG. 5, different types of the online health assistance information may be delivered to a person when the person monitored by the real time health monitor 210 is in different health conditions. For example, when a person is in a normal health condition, the online health assistance information received may not be a real time feedback but rather general health intelligence sent on a timed schedule determined by, e.g., the terms of the subscribed service. If the classified health condition is sub-healthy which the real time health monitor 210 determines that it warrants a warning, e.g., the real time health monitor 210 detects that a particular disease may be developing (e.g., type II diabete), the received online health assistance information may be a real time feedback with a health warning report and recommendations of specialist for the person to visit to have a check. To educate the person on the potentially newly developed health condition, the online assistance information may also include health intelligence on the particular developing disease to help the person to better understand the health issue and ways to address.

In operation, when an emergency situation is detected, the real time health monitor 210 may automatically initiate an emergency handling protocol. An emergency situation may arise under different conditions. For example, the person monitored by the real time health monitor 210 may activate the emergency button 215. Alternatively, the emergency may be detected based on monitored data. For instance, the real time health monitor 210 may sense that there is a sudden increase of velocity, usually signaling a fall, which may trigger an emergency classification. This is shown in FIG. 8A, in which the input to the emergency handling unit 870 may be from the emergency button 215 or from the online health condition determiner 840.

When an emergency situation is detected, the emergency handling unit 870 may be invoked, which may respond by automatically contacting designated emergency contacts (specified by, e.g., the person monitored by the real time health monitor, by his/her guardians, by physicians, or by hospitals), determining whether an immediate rescue is needed, and if so, invoking the SOS handling unit 880 to call for rescue. The communication to the emergency contacts may be performed via the communication unit 850, e.g., in a manner (phone call, email, text messages, beep, etc.) that have previously been set up. If the SOS handling is activated, the SOS handling unit 880 may automatically reach out to a group of rescuers (e.g., via the communication unit 850), determined based on, e.g., geographical scope or choice of the person/guardian, etc. Responses received from the rescuers via the communication unit 850 may be further filtered to so that the most appropriate rescuer(s) for the situation can be selected. The selected rescuer(s) may then be informed (via 850) of the person's location and information needed (e.g., whether the person is conscious, blood type, age, important measurements that gave rise to the medical emergency, and medical history data) to facilitate the rescue.

In case of emergency, in addition to the emergency handling performed in situ by the real time health monitor 210, the real time health monitor 210 may also simultaneously transmit the emergency situation to the cloud 260 via the network, which allows it to subsequently receive the online health assistance information, which may include physician instruction guiding the person to take certain measures to keep safe until medical assistance arrives. This depends on the level of danger that person is in as detected by the real time health monitor 210. For example, if the real time health monitor 210 estimates that the person may be experiencing a pending heart attack, the online health assistance information may be provided in real time with immediate physician instruction as to what the person can do (e.g., take certain medication or lying down) to improve the situation or not let it worsen before the medical assistance arrives. Such real time feedback may also inform the person that the medical assistance has been organized and is under its way to the person's physical location. If a person is estimated in such a condition he/she will not able to read the instructions, the real time feedback may be delivered in an audio form.

The assistance information presentation unit 825 may be configured to present information to the person being monitored. In some embodiments, the assistance information presentation unit 825 is capable of adaptively determine the presentation parameters such as the font size, color, whether in text form or in audio form, etc. Such adaptation may be set to be performed automatically based on the person's known condition or a specific condition at the time of an emergency. For instance, the user data of the person being monitored may include various useful information that can be used for such adaptation, e.g., the person's eye sight (e.g., near sighted or far sighted and degree thereof), age (older users may need larger font size), health condition (blind or deaf). In some embodiments, when a person being monitored is in an emergency situation and developed more relevant conditions, then the delivery of the health assistance information may be further adapted based on the instant condition of the person. For example, the person may be unconscious or turn blind so that the initial adapted presentation style will no longer make sense and in this case, the assistance information presentation unit 825 is configured to determine appropriate presentation style for that time.

As such, upon receiving the health assistance information from the communication unit 850, the assistance information presentation unit 825 may dynamically determine how the health assistance information is to be presented in accordance with both pre-stored presentation models 830 (the initial adaptation for the person) as well as any information related to the current (emergency) situation. As pointed above, when the person is not in a health condition to read text in an emergency situation, the health assistance information presentation unit 825 may control, based on the health classification or emergency information, to activate voice synthesis module (not shown) in order to read the real time feedback physician instructions in audio form to the person. If a person is detected to likely experience a pending heart attack and the person is detected to be at his work place, the assistance information presentation unit 825 may decide to generate a loud warning sound or unique vibration to notify people around the person. The sound or vibration style may be chosen by the person or automatically determined by the assistance information presentation unit 825.

As discussed herein, in some situations, there may be no real time feedback of health assistance information (e.g., when the person is in a healthy condition). Instead, a report generated with a regular interval may be sent to the person. For example, when a person is in a healthy condition, a monthly report may be provided to the user via some preferred means (but not limited thereto), e.g., a hard copy sent to home each month, an electronic version of the report sent to the person's designated email address via attachment, or if preferred, the report may be read to the person when the person connects with a certain health service hotline.

As such, the mode in which the health assistance information is to be presented may be determined based on the classified health conditions. With some health condition, the presentation of health assistance information has to be immediate and loud to invoke attention. In other health conditions, the presentation of the health assistance information may be delayed (e.g., to the end of the month) or via a channel that is not to be presented on the mobile device 213 but rather relay to some other destination, e.g., relay to an email inbox. In some situations, the health assistance information is delivered via a monthly hard copy report. As such, the determined mode includes a mode by which the health assistance information is not to be presented via the mobile device, a mode by which the health assistance information is not to be presented until a later time, and a mode indicating that the health assistance information is to be delivered via means other than the real time health monitor 210.

The real time health monitor 210 also includes an in situ user health log 845 which may record the time series of monitored vital signs and health data as well as the online health condition classifications over time. In addition, whenever there is important information from the cloud, such as a doctor's diagnosis after the person is, e.g., rescued, can also be recorded in the in situ user health log 845. The data recorded in the in situ user health log 845 can be used by the online health condition determiner 840 in subsequent classifications of the person's health condition. Due to limitation of size of the real time health monitor 210, the data recorded in the in situ user health log 845 may be regularly uploaded to the cloud 260 to create a backup copy. For instance, the communication unit 850 may monitor how full the in situ user health log 845 is and upload to the cloud when the space remaining in the in situ user health log 845 reaches a pre-set level. Alternatively, the real time health monitor 210 may also include such a determination mechanism embedded in the user health log 845 so that it may initiate on its own to activate the communication unit 850 to upload whenever needed.

Consistent with the functions of the components included in the real time health monitor 210, FIG. 8B is a flowchart of an exemplary process of the real time health monitor 210, according to an embodiment of the present teaching. The real time health monitor 210 continuously collects, at 822, different types of health information of the person being monitored by the real time health monitor 210. Such information is either continuously measured by the sensors 810 in the real time health monitor 210 and/or gathered from the peripheral instruments 255. Such collected sensor information is then used by the vital sign measurement unit 820 to continuously determine, at 824, the vital signs of the person. Similarly, the sensor information is also used by the health data measurement unit 815 to continuously estimate, at 826, the health data associated with the person.

The physical location of the person is determined, at 828, by the self-aware location detection unit 860. Based on the estimated vital signs and health data of the user, the online health condition determiner 840 proceeds to classify, at 832, based on different models (disclosed below), the health condition of the person. The classification is performed in accordance with both general knowledge in health care and specific information related to the person such as the person's health history. The continuously monitored data (vital signs and health data) as well as the estimated health condition class(es) are then sent, at 836 by the communication unit 850, to the cloud 260, together with the other and location information of the person. In a different embodiment, the classification of the person's health condition may be carried out in the cloud 260 or by a health service provider (discussed below) in the backend.

When an emergency situation occurs, due to either an activation of the emergency button 215 or an outcome of the health condition classification, the emergency handling unit 870 informs, at 838, selected emergency contacts of the person being monitored by the real time health monitor 210 and, if SOS is needed (e.g., determined by the emergency handling unit 870), the SOS handling unit 880 contacts, at 842, a selected set of rescuers to request immediate help.

After the monitored data, location, and/or the health condition classification being sent to the cloud 260, the communication unit 850 receives, at 844, online health assistance information 240 from the cloud 260 or a backend health service provider. When such received information is forwarded to the health assistance information presentation unit 825, the health assistance information presentation unit 825 determines, at 844, the mode(s) and style to be used to deliver the received online health assistance information to the user. With the determined mode/style, the online health assistance information is delivered, at 844, to the person as a response to the monitored health conditions.

In some embodiments, the real time health monitor 210 also archives, at 846, the continuously monitored health data, vital signs, and the health condition classifications in the user health log 845 on the real time health monitor 210. It is then checked, at 848, whether any of the in situ information residing on the real time health monitor 210 needs to be updated based on, e.g., corresponding information stored on a backend system. This may include, e.g., update the health log in 845, the emergency contact information, or a list of volunteer rescuers, etc. If there is no need to update the in situ information, the real time health monitor 210 continues the monitoring at 822. If any update is needed, the corresponding in situ information is updated, at 834, and the process then continues to 822 for the continued monitoring.

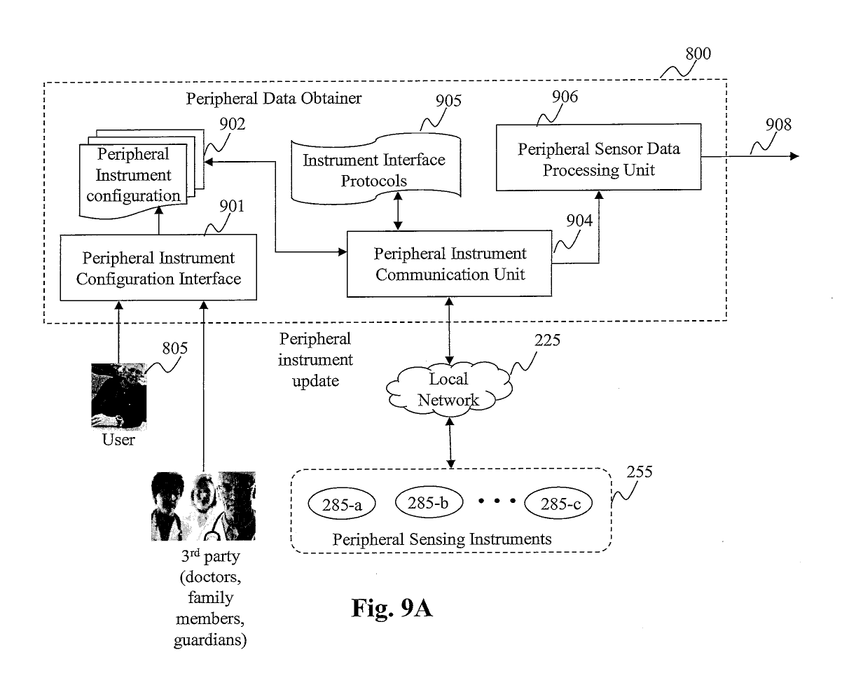

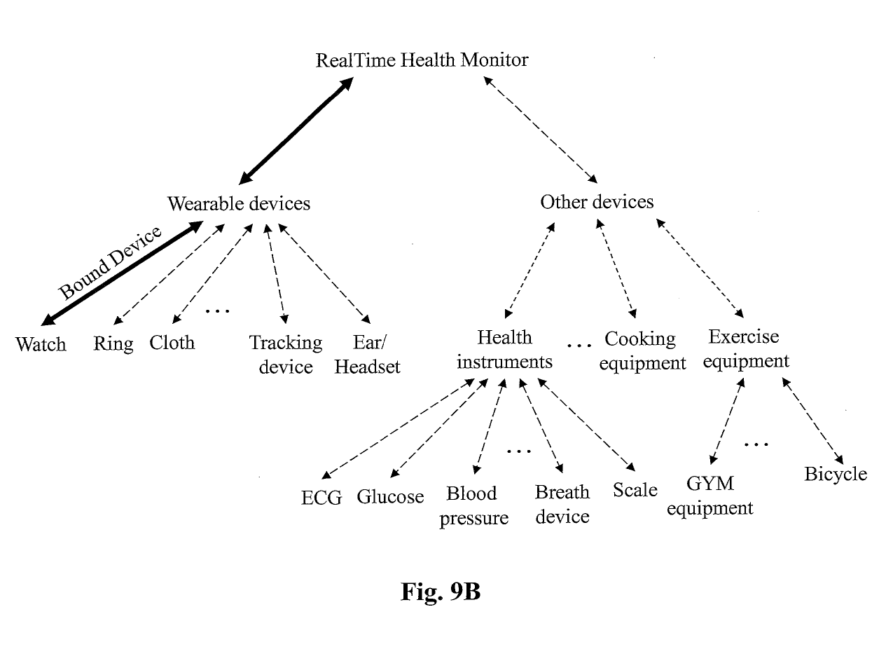

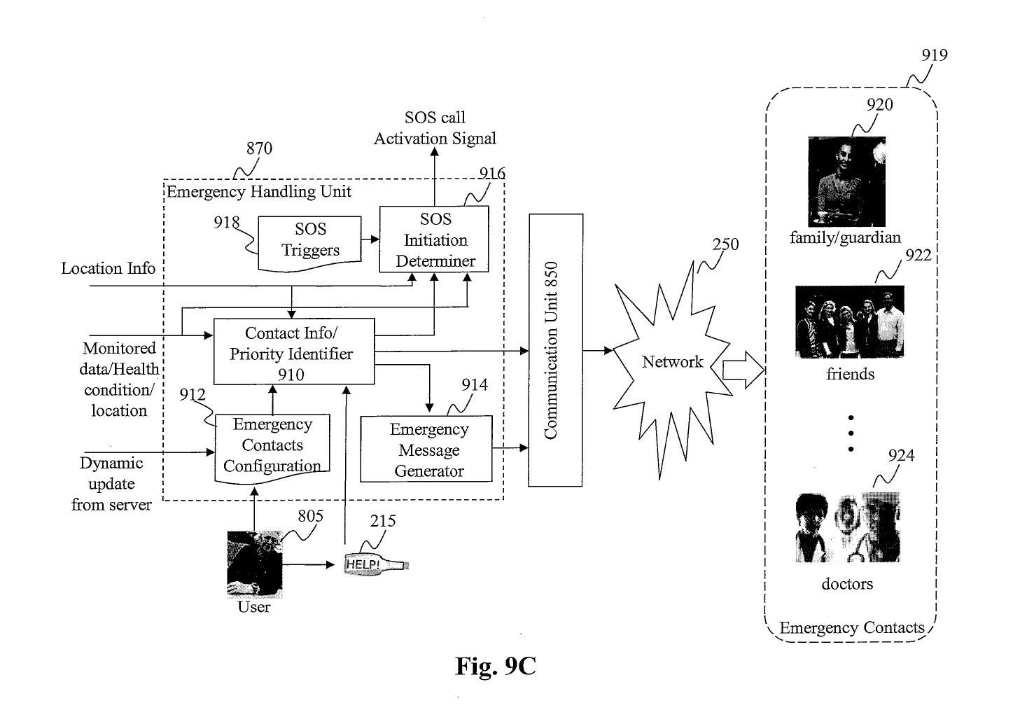

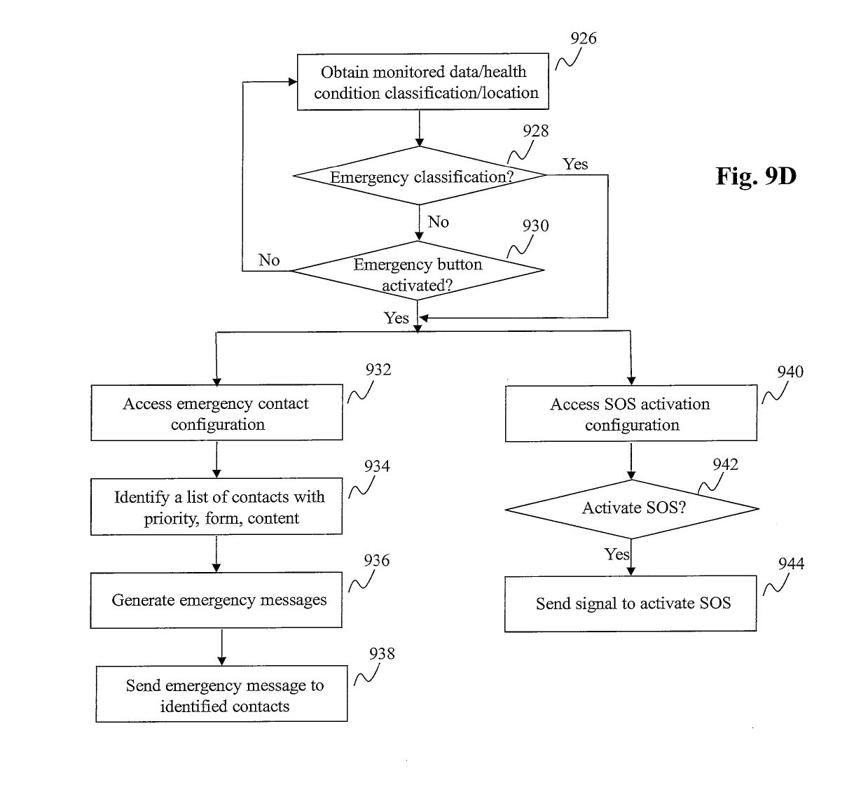

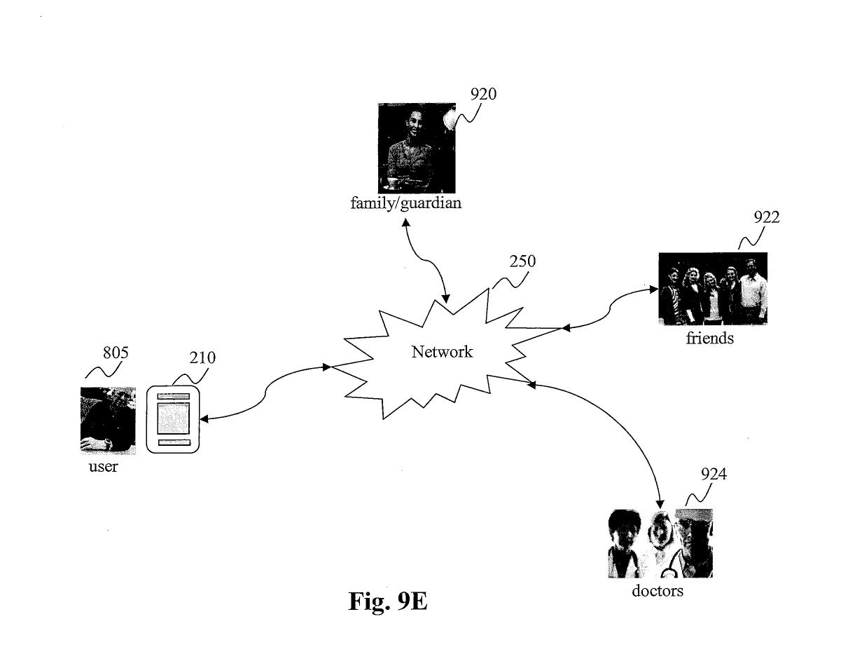

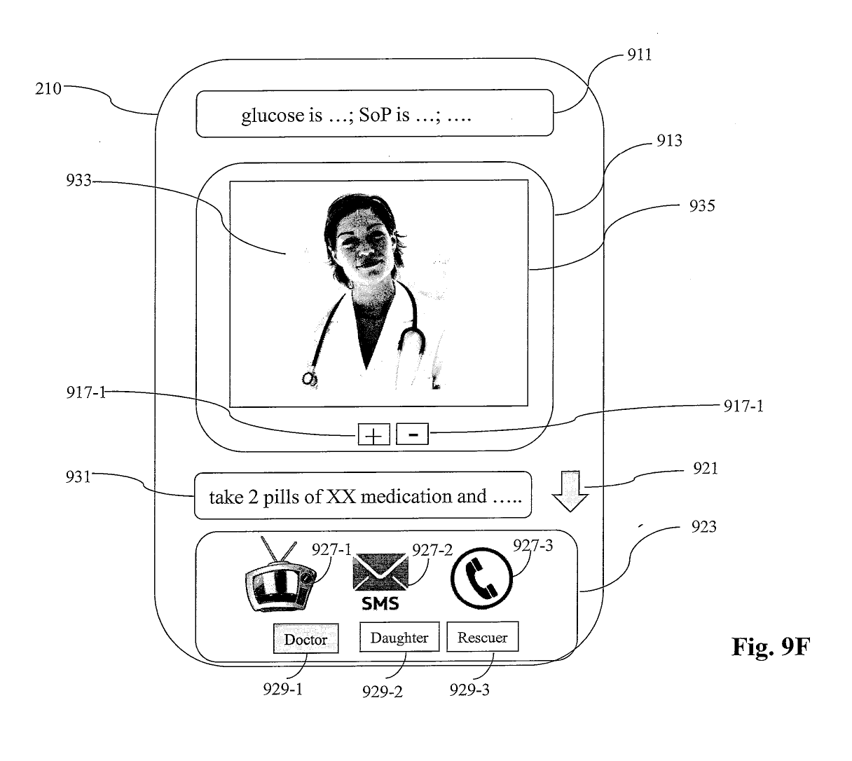

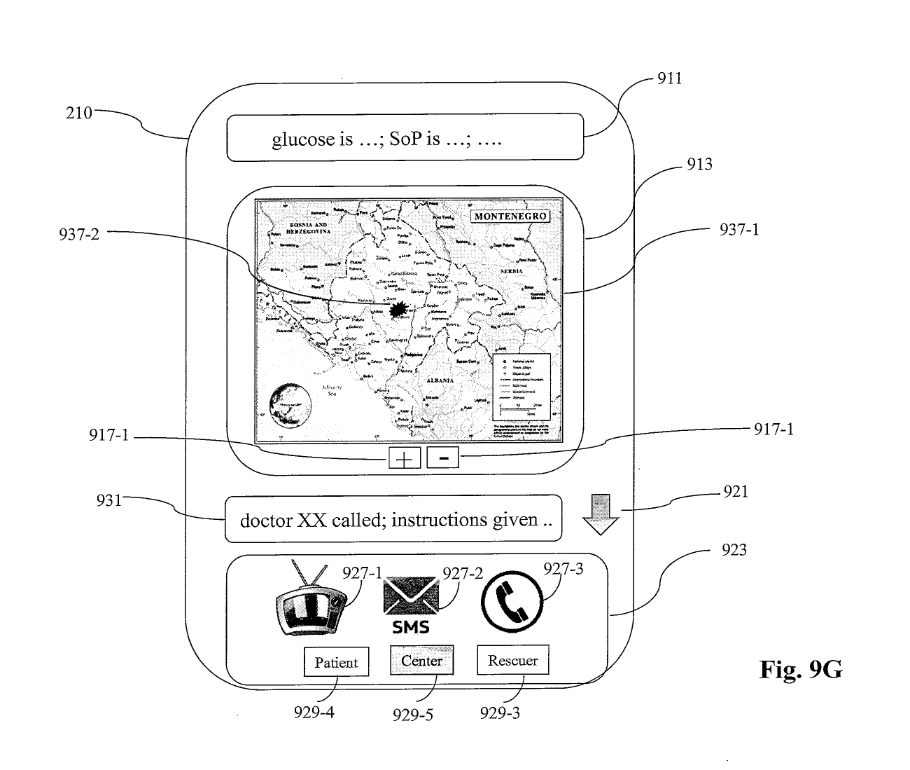

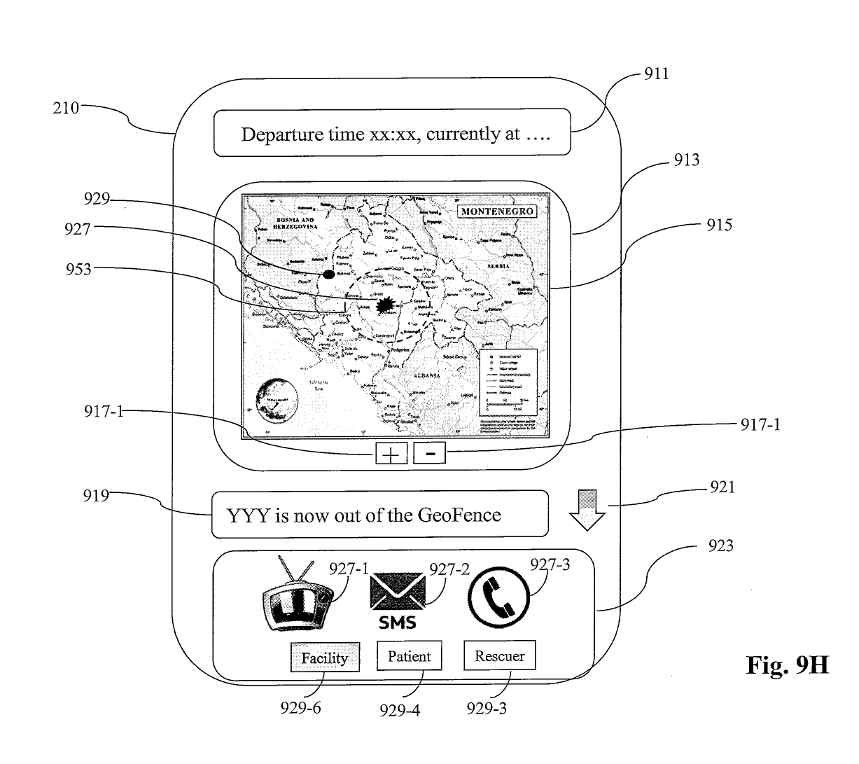

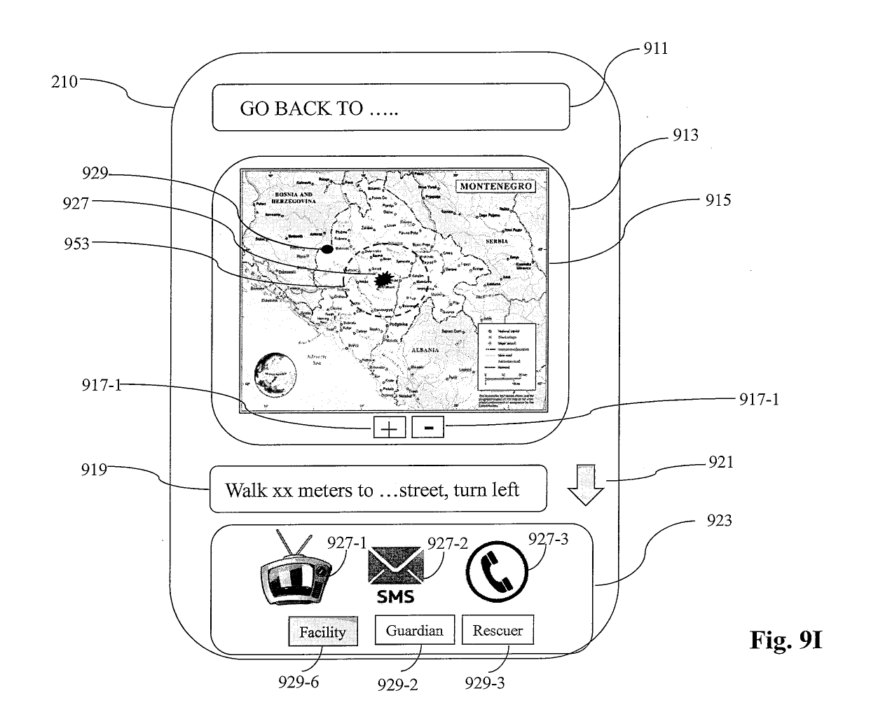

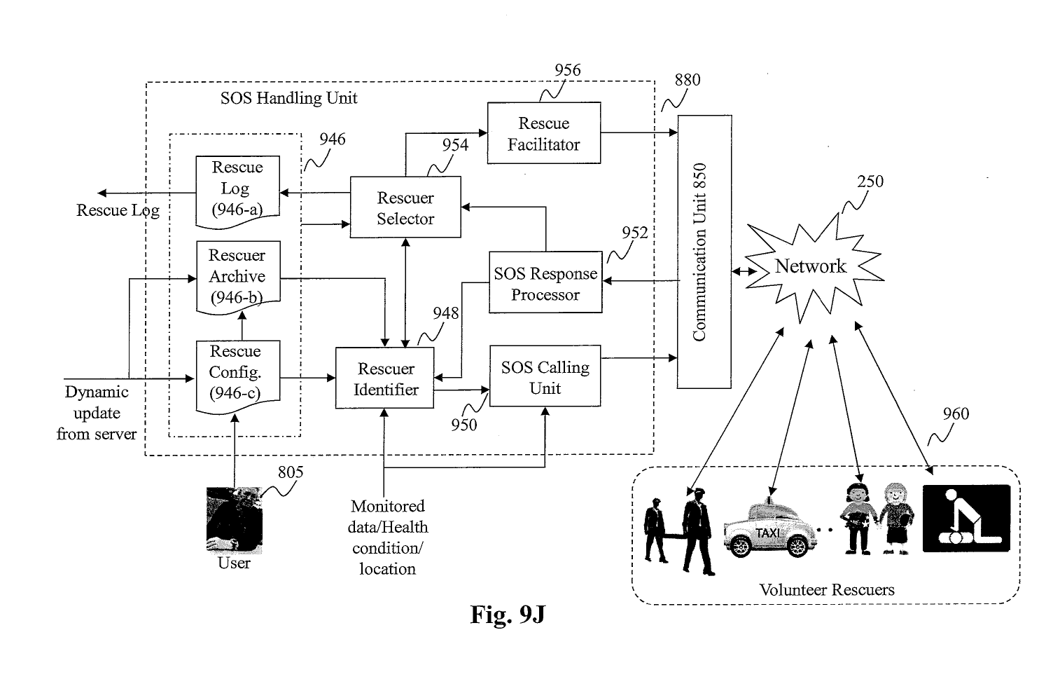

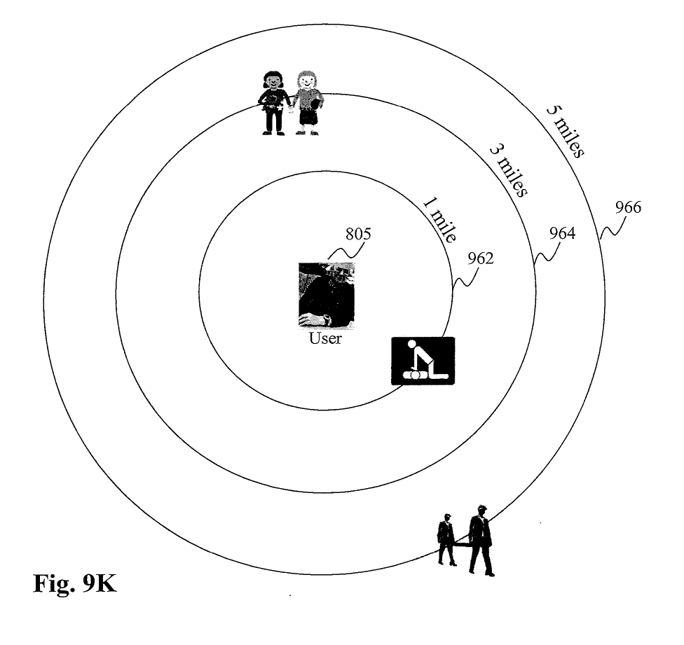

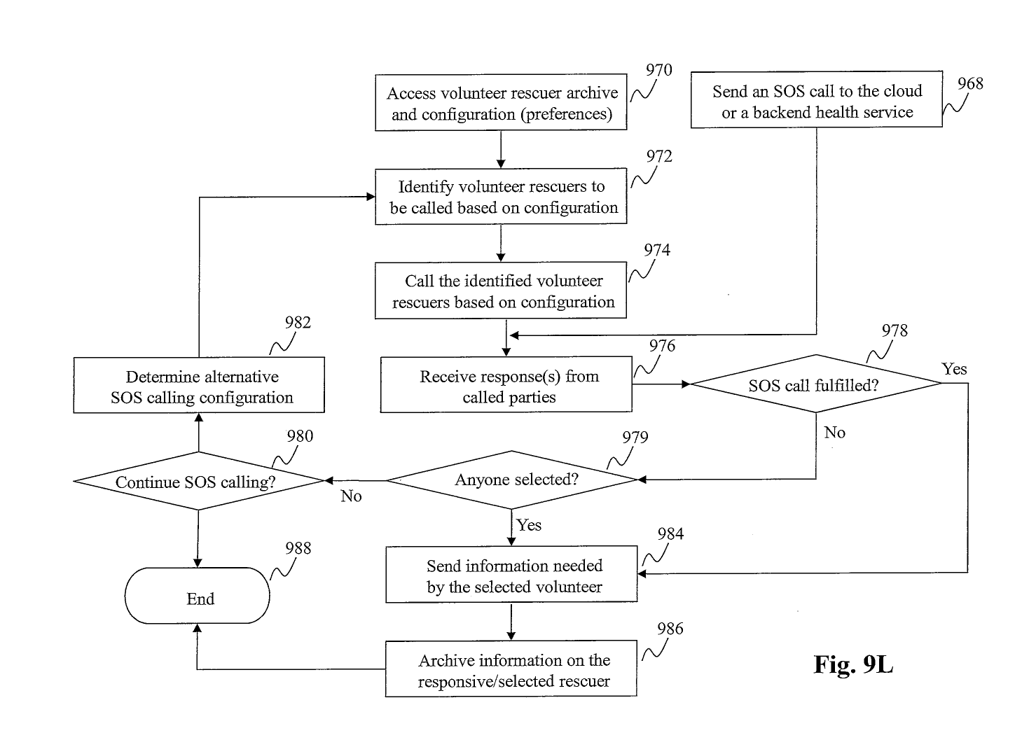

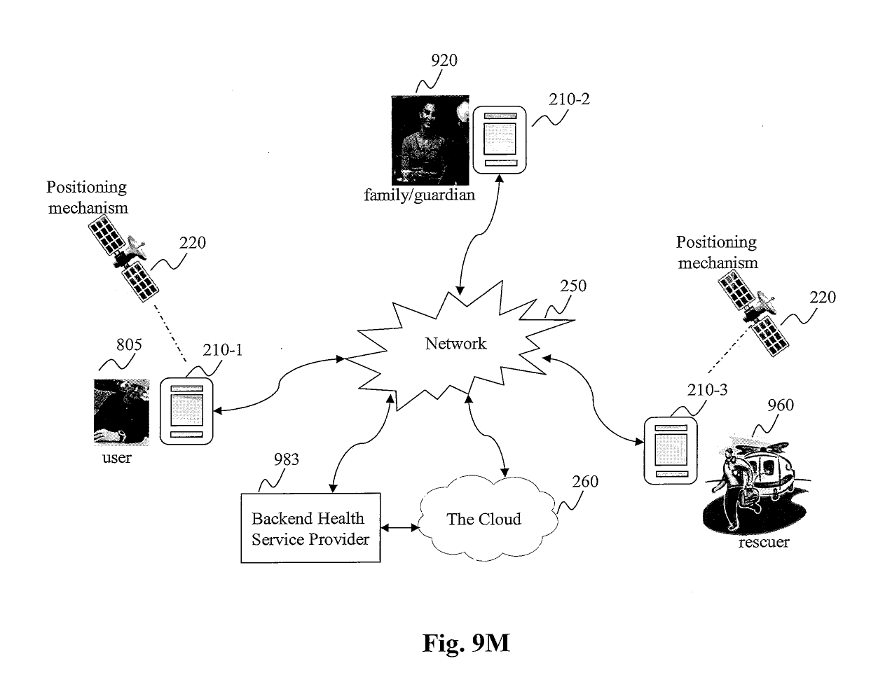

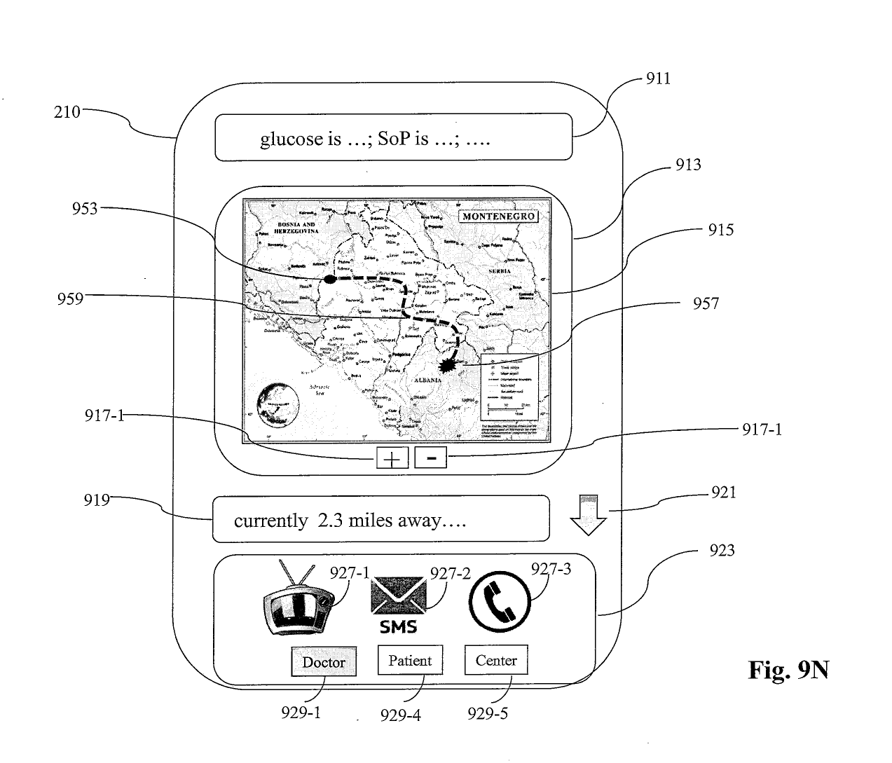

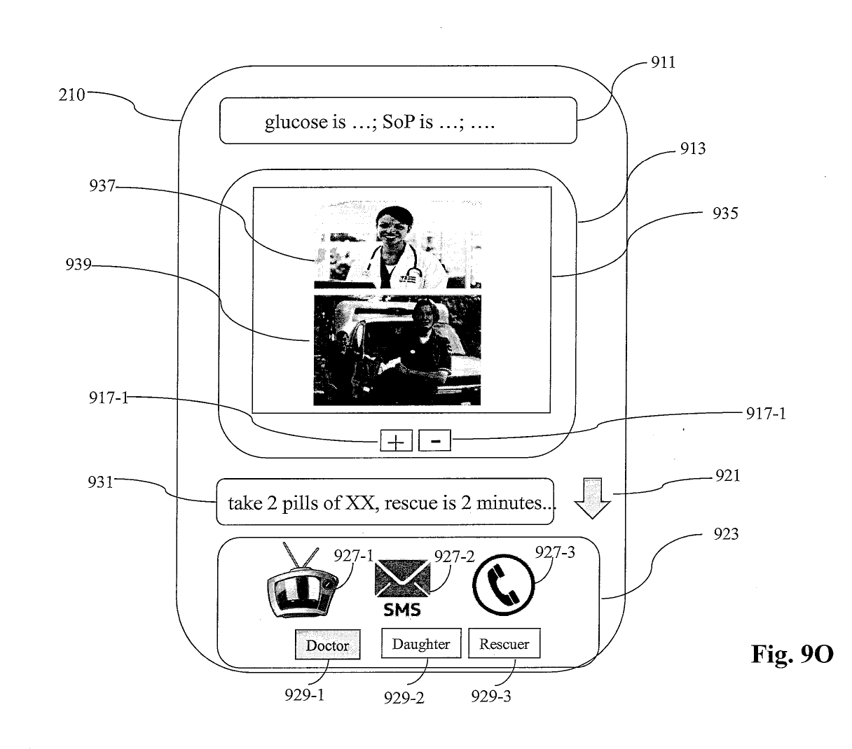

FIG. 9A depicts an exemplary system diagram of the peripheral data obtainer 800, according to an embodiment of the present teaching. In this exemplary embodiment, the peripheral data obtainer 800 comprises a peripheral instrument communication unit 904, a peripheral sensor data processing unit 906, and a peripheral instrument configuration interface 901. In some embodiments, the presence of various peripheral devices/instruments may need to be specified. For example, the user 805 may interface with the peripheral instrument configuration interface 901 to specify the peripheral devices that the real time health monitor 210 needs to communicate for data collections. The user 805 may add or subtract peripheral devices at any time via the peripheral instrument configuration interface 901. Such specification may also be provided by physicians who may prescribe certain monitoring devices for the user and can interface with the interface 901 to add or subtract peripheral devices applicable to the user 805.

Once specified, the peripheral device applicable is registered in the peripheral instrument configuration 902. In some embodiments, the registered information about each peripheral device may include device type (e.g., glucose measuring instrument), product name (e.g., maker and product no.). Based on provided information about the product, in some embodiments, the peripheral instrument configuration interface 901 may obtain online information as to the protocol via which the real time health monitor 210 can communicate with the peripheral device.

The peripheral instrument configuration 902 may record the information about existing peripheral instruments that are deployed and from which monitored data may be collected. The peripheral instrument configuration 902 may also include information to be used to control the regularity of the sampling. For example, for one instrument, the sampling regularity may be once each day. For another instrument, the sampling frequency may be higher or lower, depending on the need. Such peripheral instrument configuration may be either specified by the user 805 or by a third party, e.g., through the peripheral instrument configuration interface 901. The third party can also be, e.g., a guardian of the user 805 or a health care provider such as a physician/specialist or some other services such as a peripheral instrument maker that wants to test the instrument. The peripheral instrument configuration 902 may be dynamically updated. For example, the person may be given a new monitoring instrument with a revised regularity and in this case, the person may enter such information via the peripheral instrument configuration interface 901. Such updated instrument configuration information may also be automatically downloaded from a server by the peripheral instrument communication unit 904 and sent to the peripheral instrument configuration 902. Such downloaded information may also include the peripheral instrument communication protocol which is used to communicate with each of the deployed peripheral instruments.

Based on the information on deployed peripheral instruments and the corresponding monitoring regularity specified in the configuration 902, the peripheral instrument communication unit 904 communicates, according to the peripheral instrument communication protocol specified in 905, with each of the deployed peripheral instruments 255, via the local network 225, to gather monitored sensor data. As discussed above with regard to the local network 225 in reference to FIG. 2, the local network 225 may be any of a wired or wireless local networks connections, such as cellular, Bluetooth, Internet, telephone lines, or any other form of home/facility based network connections. Such gathered sensor data are then sent to the peripheral sensor data processing unit 906 so that they can be processed to yield the data that can be sent to the measurement units 815 and 820 for further computation.

FIG. 9B illustrates exemplary relationships between the real time health monitor 210 and various types of peripheral instruments, according to an embodiment of the present teaching. The communication between the real time health monitor 210 may be bi-directional as depicted in FIG. 9B. The communication between the real time health monitor 210 and each peripheral instrument may be conducted in accordance with a protocol appropriate for that peripheral instrument. In some embodiments, the real time health monitor 210 may be bound, in operation, to a specific peripheral instrument such as a watch (shown in FIG. 9B in solid line connection) and maintain the connection with rest of the peripheral instruments in an un-bound relationship. The bound peripheral instrument may have its own peripheral instruments so that the bound peripheral instrument may serve as a hub, gathering monitored health related information from peripheral instruments it connects to and then relay such information, either in their native form or in a processed form, to the real time health monitor 210. In FIG. 9B, it is illustrated that a wearable watch is bound to the real time health monitor 210.

FIG. 9C depicts an exemplary system diagram of the emergency handling unit 870 in connection with other system components, according to an embodiment of the present teaching. As discussed previously, the emergency handling unit 870 may be invoked when one of the conditions is satisfied. For example, the person monitored by the real time health monitor 210 may activate the emergency button 215 or the health condition classification may be “emergency” causing the emergency handling unit 870 being activated. In some embodiments, the emergency handling unit 870 comprises a contact info/priority identifier 910, an emergency message generator 914, and an SOS initiation determiner 916.

The emergency handling unit 870 also includes emergency contacts configuration 912, which records the emergency contacts related to the person monitored by the real time health monitor 210 and other meta information that may be used in determining whom and how to call in case of emergency. For instance, each emergency contact may be associated with a priority indicating the importance of the contact being informed of any emergency. An emergency contact who is the child of the person wearing the device may have a higher priority than another emergency contact who is a relative of the person. A person who is already designated as the guardian of the person may also have a higher priority than other emergency contacts. The meta information associated with each contact may include physical location of the contact so that if the contact is far away from the present location of the person wearing the device, the urgency of informing this contact may be adjusted even when the normal priority of the contact is high. The person (user 805) may also specify, in the emergency contact configuration 912, whom he/she prefers to notify in case of emergency. For instance, the person may specify that his/her general physician is preferred to be informed first in case of emergency. The configuration may also be remotely updated dynamically by authorized party. For example, if the person monitored by the real time health monitor 210 is no longer in a sound mind to make sensible decisions, the configuration may be specified by his/her guardian, a relative, a physician, a lawyer, a hospital, or some other authorized personnel. The meta data may also include, with respect to each emergency contact, a platform or manner the contact can be informed. For instance, some emergency contact may prefer to be contacted via phone. Some may prefer to be contacted via electronic mail. The emergency contact configuration 912 may also be dynamically updated when needed.

When the emergency handling unit 870 is invoked, the contact info/priority identifier 910 determines, based on information from different sources, a list of emergency contacts to be contacted. This list may include not only the contacts but also, optionally, an order in which such emergency contacts be informed, and the manner by which each of the contact is to be informed of the emergent situation of the person. Based on such a list, the emergency message generator 914 may then generate a message to each of the emergency contact based on the preferences specified for the contact in the emergency contact configuration 912. For example, if an emergency contact prefers to be informed via a text message, the emergency message generator 914 may generate textual content incorporating some information that is important such as the actual health condition classified (emergency) with optionally supporting information received. For instance, the received information include the monitored data (which includes any of the monitored vital signs or health data), the health condition classification(s) derived based on the monitored data, and the monitored location of the person. In some embodiments, the specific supporting evidence for the emergency situation may be carved out and transmitted to indicate to the emergency contact as to what gave rise to the emergency, such as specific detected poor vital signs, e.g., an extremely low blood sugar level or there has been a detected fall based on the sensory data from either the real time health monitor 210 or a relevant peripheral instrument.

The emergency message generated by 914 may also include information needed for the recipient to recognize who is in an emergency situation and relevant information related to the person in the emergency situation. For example, the emergency message may include some required personal information such as a name, gender, age, location of the person, medical identification of the person, type of emergency such as whether it is due to a dangerous vital sign or a detected fall or other situations that gives rise to the emergency. Additional necessary information may also be included in the emergency message such as medical/food allergies, blood type of the person so that such information may be used appropriated by others to determine how to handle the emergency.

In some embodiments, the emergency message has textual content. In some embodiments, the emergency message may include pictorial data such as a picture of an injury, for example, gathered from either the real time health monitor 210 (if it also includes a camera and can be activated to take a photo or even a video of the situation) or from a peripheral device/instrument in the vicinity of the emergency site. In some embodiments, the textual content of the emergency message may be converted to voice by the emergency message generator 914 with respect to a different emergency contact if the preferred means of notification is via voice message. For example, if a particular emergency contact prefers to receive notification in voice form, the emergency message generator 914 may then convert the emergency message directed to this emergency contact in voice form so that the emergency message is sent out in an audio form, either as a voice message or as a phone call to the emergency contact.

Such generated emergency message (text or audio) for each emergency contact to be contacted may then be sent to the communication unit 850 with, e.g., instructions as to where to send the message (e.g., phone number or email address). Such messages are then sent, by the communication unit 850 and via the network 250, to each of the identified emergency contacts. As shown in FIG. 9C, emergency contacts can include, but not limited to, family members/guardian 922, friends 920, or designated doctors 924. In some embodiments, the emergency contacts (relatives, guardians, physicians, friends, etc.) may be informed of different levels of detail depending on the role of each emergency contact and provided with different types of information to fulfill the level of detail determined. It may be pre-specified, with respect to each emergency contact, as to which level of detail and what type of information may be provided. In addition, the emergency message may also include information on whether rescuers have been contacted, which specific rescuers have been contacted, current status with regard to each called rescuer (e.g., responded or not), and current distance between a responding rescuer and the person in the emergency situation. In some embodiment, information included in the emergency message may enable an emergency contact's device to display, a graphical indication such as a graph or a map with the person's physical location as well as a responding rescuer's current location marked on the map.

Independent of contacting emergency contacts, the emergency handling unit 870 also determines, via the SOS initiation determiner 916, whether SOS is needed given the specification situation. The SOS initiation determiner 916 makes the determination based on, e.g., the pre-determined SOS triggers 918. For example, the SOS triggers 918 may specify under what conditions SOS handling is needed. Some condition may specify that if the person being monitored is an incapacitated elderly and if the emergency arose due to a serious situation (e.g., a fall, rapidly falling critical vital signs, etc.), then SOS is to be initiated. It may also be due to the fact that the detected air contains a high level of carbon-monoxide and the person being monitored is without any motion. Another condition may be that the person has a history of seizure, currently violent motion is detected, and the person is not responding to a request for response (suggesting that the person may be in a seizure). If any of the currently detected health related data meet some specified SOS triggering conditions in 918, the SOS initiation determiner 916 may then invoke the SOS handling unit 880.

FIG. 9D is a flowchart of an exemplary process for the emergency handling unit 870, according to an embodiment of the present teaching. Monitored data/health condition classification/location data are obtained at 926. Based on the classification, it is determined, at 928, whether there is an emergency classification. If no emergency classification is received, it is checked, at 930, whether the emergency button 215 has been activated, which is another situation that gives rise to an emergency situation. If the emergency button is activated, the emergency handling is carried out via steps 932-944. If no emergency exists, i.e., the classification for the health condition is not an emergency and the emergency button is not activated, the emergency handling is not activated and the process returns to step 926 to obtain the next batch of monitored data/health condition classification/location of the person.

In emergency handling, there are two paths of processing. One is related to generating a response to the emergency situation (steps 932-938) and the other related to the activation of SOS handling. At 932, the emergency contact configuration 912 is first accessed in order to determine which emergency contacts are to be notified of the emergency situation. The determination may be based on various considerations, including preferred contacts specified by the person being monitored, necessary contacts specified, e.g., by health care providers such as physicians/specialists, location of the person, the basis for the emergency situation. For instance, if the reason for the emergency is likely a seizure, particular specialist related to that problem may be contacted. A list of contacts is then generated, at 934, with information needed for notifying each of the identified emergency contacts, e.g., any preferred priority order, the manner by which the contact is made (email or voice message, etc.).

To send the notification to the emergency contacts, an emergency message is generated, at 936, which may include information related to the condition and the monitored data that gave rise to the emergency (detected fall, low blood sugar, etc.). For each of the emergency contacts, the content of the emergency message may be adapted to the intended recipient according to, e.g., the configuration provided in the emergency contact configuration file 912. For instance, for an emergency contact who is a medical specialist, data that gave rise to the detected emergency may be included in the message. For an emergency contact who is a relative, the message may include merely an indication that the person is in an emergency condition. In some embodiments, each emergency message may also be adapted in term of its form to satisfy the platform to where the message is to be delivered. As discussed above, some messages may be sent as text (email or short text message) and some may be sent as audio (a voice message to the recipient). Such adapted emergency messages are then sent, at 938, to the emergency contacts identified.

In determining whether the emergency situation is to trigger SOS handling, the SOS initiation determiner 916 first accesses, at 940, the SOS triggers 918 that may be used to define conditions under which SOS procedure needs to be activated. As discussed herein, the SOS triggering conditions may be specified by the person being monitored (e.g., who has a history of seizure and wants to be rescued whenever that happens) or by health care providers (e.g., the specialist of the person on diabetes may indicate that whenever an emergency situation occurs due to that the blood sugar level is below certain threshold, the person needs to be rescued). Based on such pre-determined SOS triggering conditions, the SOS initiation determiner 916 determines, at 942, whether the SOS handling unit 880 has to be invoked. If it is to invoke the SOS handling unit 880, the emergency handling unit 870 sends, at 944, a signal to the SOS handling unit 880 to activate it.

FIG. 9E illustrates the emergency contacts calling by the real time health monitor 210, according to an embodiment of the present teaching. As seen, in emergency situation, the real time health monitor 210 notifies, via the network 205, various emergency contacts determined to be appropriate given the nature of the emergency. FIG. 9F illustrates an exemplary user graphical interface for a person in an emergency situation, rendered by the real time health monitor 210, according to an embodiment of the present teaching. This illustrated emergency GUI is for a user in an emergency situation. The GUI is designed to facilitate the person in emergency situation. The interface has several areas, each of which is rendered with different types of information. For example, area 911 in FIG. 9F is provided to display a streamline, reporting the real time measurements of vital signs, optionally of those that gave rise to the emergency situation. The streamline display is continuous and real time update with some frequency. Area 913 is a region for displaying graphical or video information 935. Depending on what the user activate to display, the area 913 may display a real time face time conversation with a medical professional such as a physician or a nurse practitioner 933. If the user elects to have a real time communication with, e.g., a family member, the area 935 can be displayed with a video of a contacted family member (not shown). In the visual area 913, there are also some control 917-1 and 917-2 that can be used by the user 805 to enlarge or shrink the image size displayed.

In FIG. 9F, there is also area 931 for displaying communication content from the person who is in communication with the user 805, e.g., a physician 933. In this example, textual information may be displayed in a streamline fashion providing a physician's instruction on what the user can do to address the situation. In this specific example, the physician 933 asked the user to take 2 pills of certain medicine.

In the illustrated interface, there is also an area 923 with various illustrated actionable items that the user 805 can activate. This area may be configured as a communication center and through the actionable items in this area; the user 805 can elect different ways to communicate with different people. For example, in some embodiments, in an emergency situation, the real time health monitor 210 may pre-set default three people as the first priority, including doctor 929-1, a guardian (daughter in this case) 929-2, and a rescuer 929-3. The user can press on any of these three items and the real time health monitor 210 may then automatically set the default communication destination as the selected person. Such destinations include phone number via actionable item 927-3, text communication identification (e.g., identification for FaceBook, twitter, QQ, or WeChat) via actionable item 927-2, or video communication channel (e.g., identification for FaceTime, Skype, WeChat, etc.) via actionable item 927-1.

In some embodiments, for each elected person to communication, when the user elect an actionable item, the communication channel is automatically set up (dial through) so that the user can directly start the communication in that channel. For example, in FIG. 9F, the user elects “Doctor” (the actionable item 929-1 is pressed and it is shown as gray indicating it is selected) and video communication (the actionable item 927-1 is pressed) so that the doctor/nurse practitioner appears in the area 913 and the dialog between the user and the doctor can be conducted via live video. There is another actionable item 921, which corresponds to a button for getting more contacts for communication if the user wants to get connected with additional people. For instance, the user may have defined a priority list of people in addition to the default people. Through the item 921, the user can screw down the priority list and then elect the manner to conduct the communication. There is no need for the user to enter any contact information in order to communicate. Once the person to communicate with and the channel of the communication is selected, the channel is automatically established.

In some embodiments, depending on the role of the user, the interface of the real time health monitor 210 may be different. For example, a user can be either a person being monitored. The user may also play a role as a rescuer or a guardian. In an emergency situation, the interfaces presented to a guardian or a rescuer may be different from what is presented to a person who is monitored. Depending on the role of a user in an emergency situation, the real time health monitor 210 is configured to present different content in the interface in order to facilitate the user in playing in his/her role. FIG. 9G illustrates an exemplary interface presented to a user who is a guardian to a person who is in an emergency situation. In this example interface, what is presented to the user in area 913 is a map 937-1 marked with the location of the emergency 937-2. In the area 931, the content displayed is appropriate for a guardian, e.g., informing the guardian that doctor has been called to notify the emergency and the instructions from the doctor (e.g., take certain medication) has been provided to the person in the emergency situation. In the communication center area 923, although the actionable items related to choice of communication platform remain the same (video 923-1, text message 923-2, and phone call 923-3), the choices of parties to whom the communication channel can be automatically set up are different from that in FIG. 9F. In this example, the choices of parties that a guardian can contact in the emergency situation include the patient (the person in the emergency situation) 923-4, the center 923-5 which may correspond to a backend health service provider (which will be disclosed later herein), and a rescuer 923-3. In this example, the guardian user chooses to contact the backend health service provider center (923-5) with visual communication channel, which shows the map with a dynamically updated location of the person in the emergency situation.

In some embodiments, the real time health monitor 210 also supports the GeoFence service so that a user being monitored may be associated with a geographical fence and the person being monitored is to be monitored not only against the health but also against the GeoFence defined. Such service may be beneficial to users who suffer from certain health issues such as dementia. The GeoFence may be specified by physicians, nursing home, or guardians. The GeoFence associated with a user may be stored in the user data log 835 (FIG. 8A) and can be used by the online health condition determiner 840 as part of the monitoring. One of the situations that can give rise to an emergency situation is when the person being monitored is out of the GeoFence. In this situation, the real time health monitor 210 tracks the current location of the person and the emergency handling unit 870 may then notify relevant parties (e.g., the guardian or a backend health service provider) of the current location of the person against the GeoFence.

FIG. 9H illustrates an exemplary interface for an emergency related to GeoFence monitoring, according to an embodiment of the present teaching. This illustrated example may be for a guardian or a health service provider, where the content in the interface provides information related to the current situation of the person being monitored against a pre-specified GenFence. For instance, the area 911 is displayed with information on the time the person left the GenFence area and what is the current coordinate of the person. In the area 919, the emergency handling unit 870 of the real time health monitor 210 provides warning “YYY is now out of the GenFence.” The warning may be displayed in text as well as delivered via audio to get immediate attention.

In the area 913, a map may be rendered centering on a GenFence associated with the person being monitored. In the map, the geographical location 927 that the person being monitored should be is marked and the GenFence 953 is also marked. The current location of the person monitored is also marked at 929 so that it is visually visible how far the person is from the location that he/she should be. In the communication center 923, different parties may be selected to contact, including the facility 923-6 where the person being monitored resides, the patient (person being monitored) 923-4, or a rescuer 923-3 who can be called on to help the person wondered out of the GeoFence to get back to the facility. Similarly, if any of the parties and the communication channel are selected, the emergency handling unit 870 may automatically set up the channel without requiring the user to enter communication information. For example, if the facility 923-6 is selected and the user selects the video communication channel, a video may pop up in area 913 with personnel from the facility on the video to communicate with the user.

For the person being monitored, the emergency handling unit 870 of the real time health monitor 210 may also present a different interface for the purpose of guiding the person wondered off to get back to the location he/she is supposed to be. FIG. 9H illustrates an exemplary interface for the person wondering out of a GenFence, according to an embodiment of the present teaching. In FIG. 9I, the area 911 may display big capitalized text “GO BACK TO . . . ” to remind the user that he/she needs to get back within the GeoFence. The text may also be delivered in audio form or vibration as the situation requires. The area 913 may also be displayed a map with the marked locations of the place the person is supposed to be, the GenFence, as well as the current location of the person being monitored. To assist the user to get back to the presumed place, in area 919, specific directions are provided in real time to guide the person and such direction is dynamically computed based on the current location of the person as well as the location where the person is supposed to be at. Such directions may also be delivered to the person in audio form.

FIG. 9J depicts an exemplary internal system configuration of the SOS handling unit 880, according to an embodiment of the present teaching. The SOS handling unit 880 is configured to call rescuers to rescue the person who is in the detected emergency situation. The call to each rescuer may be carried out in different manners determined based on, e.g., prior configuration, user specified preferences, or dynamically determined means in order to reach a rescuer. For example, the call may be a phone call, a text message, or any other means available. The SOS handling unit 880 comprises a rescuer identifier 948, an SOS calling unit 950, an SOS response processor 952, a rescuer selector 954, and a rescue facilitator 956. The SOS calling is carried out via the communication unit 850, which reaches out to the rescuers 960 and receives responses from the rescuers before forward to the SOS handling unit 880.

The rescuer network can include anyone who is willing to act as a volunteer rescuer (960) or who works as a professional rescuer such as paramedics (not shown). Any user of the real time health monitor may volunteer as a rescuer and register with the real time health monitor deployed on the rescuer's mobile device. Such a registration may be sent to the cloud 260 so that the rescuer may become a member of a rescuer network and can be selected when the need arises to be called upon for a rescue. Each registered rescuer may provide information on his/her contact information, hours available, qualification such as CPR, giving shots, or perform blood transfusion, etc. Some organization may also participate as a sub-network of volunteer rescuers. Examples include a taxi company may participate in the volunteer rescue network. Individual taxi drivers (including professional or amateur drivers such as Uber drivers) may individually volunteer to be rescuers by installing the real time health monitor on their networked computing device in the cars. During working hours, such taxi drivers may activate their respective real time health monitors as volunteer rescuers. When a person is in an emergency situation, the real time health monitor of that person may quickly locate the nearby taxi drivers who are also volunteer rescuers in the rescuer network. In this way, the potential rescuers are all distributed to cover different geographical regions at any moment to enable speedy localization of nearby rescuers.

When the SOS handling unit 880 is activated, certain relevant information may also be forwarded to it. This includes the medical identification of the person, monitored data (which includes any of the monitored vital signs, health data, an indication that the person is out of a GenFence, a detected fall, or an activation of emergency button for help), the health condition classification(s) derived based on the monitored data, and the monitored location of the person. In some embodiments, the specific supporting evidence for the emergency situation may be carved out and transmitted as what gives rise to the emergency. Examples include detected poor vital signs such as an extremely low blood sugar level or there has been a detected fall based on the sensory data from either the real time health monitor 210 or a relevant peripheral instrument. Such data may be continuously monitored and provided to the candidate rescuers.

In some embodiments, the candidate rescuers may be informed of certain details of the emergency situation. For instance, the calls to candidate rescuers may include information on which specific rescuers have been contacted, current status with regard to each called rescuer (e.g., responded or not), and current distance between a responding rescuer and the person in the emergency situation. In some embodiment, information provided to a candidate rescuer may enable a rescuer's device to display, a graphical indication such as a graph or a map with the person's medical identification, physical location as well as the rescuer's current location marked on the map so that the candidate rescuer may visualize the distance to the person who needs help. In some embodiments, the locations of the person being monitored and the rescuer are gathered by a backend health service provider connecting to all parties and coordinating the multiple parties to facilitate the rescue. The locations of different parties received by the backend health service provide may be distributed to different mobile devices of different parties so that the real time health monitors residing on such mobile devices can utilize such information to display needed information to facilitate different parties to perform.

When a rescuer responds to an SOS call, the response may be confirmed by the real time health monitor 210 or by the backend health service provider that is facilitating the rescue. When a responding candidate rescuer is selected by the SOS handling unit 880, it may inform the backend health service provider or directly other contacted candidate rescuers that the emergency situation is to be handled by a particular rescuer. In the meantime the rescue facilitator 956 may gather relevant information about the person and send to the selected rescuer. For example, the confirmed rescuer may be provided with information in a continuous manner before he/she arrives at the emergency site. Such information may include real-time update on the person's condition, including live feed of the vital signs and other relevant information to facilitate the rescuer to conduct the rescue. Such information may also include medical information/history/conditions of the person being rescued such as blood type, allergies, illness the person is suffering, etc. Such continuous feed of information may be archived together with other related SOS handling information.

In operation, to determine a list of rescuer candidates, the rescuer identifier 948 accesses different types of information. For example, there may be in situ rescuer archive 946-b, which records all volunteer rescuers in the network, which may be organized with respect to geographical regions. For each rescuer, additional information may also be recorded such as his/her expertise (specialized in rescuing seizure sufferers) or hours he/she is available for rescue related activities. The rescuer archive 946-b may also store different contact information of each rescuer. Based on different requirements associated with each emergency situation, usually a sub-set of rescuers archived may be chosen as candidates to whom the SOS calls are to be made. For example, a rescuer needs to be in a vicinity of the person who needs to be rescued. In addition, it is also possible that a rescuer may need to be more familiar with the health condition that gave rise to the emergency situation. For instance, the person who needs to be rescued may be in a state that requires CPR so that only rescuers who know how to do CPR should be contacted.

To facilitate the selection of rescuers to be contacted, there may be a rescue configuration file 946-c, according to the present teaching. The rescue configuration 946-c may store information related to rescue scheme or strategy. For instance, a rescue strategy may dictate that SOS calling can be achieved in several stages/phases, each of which may be associated with some particular limitation. In some embodiments, the limitation can be a distance between the rescuers being called and the person in an emergency situation. In some embodiments, the limit to distance associated with the first stage of SOS calling may be one mile, i.e., any rescuer being called is within one mile range from the person in need of help. The limit associated with the second stage of SOS calling may be 3 miles and is applied when the first stage of SOS calling does not yield any rescuer. Similarly, the limit associated with yet the third stage of SOS calling may further relax the calling range to 5 miles.

FIG. 9K illustrates the distance based SOS calling strategy. Centering on the person 805 who needs to be rescued, there are three exemplary concentric rings, corresponding to different geographical limits as to SOS calling to contact rescuers. During the SOS calling in the first stage, the radius of the geographical coverage may be limited to one mile (962) distance from the person 805. If the SOS calling within the first geographical range does not yield any response, the scope is extended to a coverage corresponding to 3 miles radius (964), and then 5 miles radius (966). There may also be a time limit set between each extension of scope and such time limit may be dynamically determined or adjusted against a default limit based on the urgency of the situation. For instance, a default time limit may be three minutes, i.e., if the first round of calling rescuers within one mile radius does not yield any response in three minutes, the scope is extended to 3 miles, etc. But if the situation is very urgent, e.g., the person had a heart attack and needs to be rescued in a critically important short period of time, the time limit of three minutes may be adjusted to one minute.

Other rescue strategy may also be stored. For instance, the rescue configuration 946-c may provide a mapping between different health conditions and the rescuers in the rescuer archive 946-b so that for a specific health condition, the rescuer identifier 948 may look up the mapping and identify the rescuers in the archive 946-b who are qualified to handle the current rescue related to the specific health condition. The rescue configuration may also contain information from the person being monitored about his/her preferences when it comes to rescue. For instance, the person being monitored may have previously specified to prefer to be rescued by professional rescuers. Some may prefer to be rescued by female rescuers. Some may specify that when being rescued, no blood transfusion due to religious belief. Such stored rescue configuration information aims to assist the rescuers identifier 948 to narrow down to the rescuers who are appropriate to contact.

Upon information from the rescue configuration 946-c, the rescuer identifier 948 determines an initial list of rescuers that meet the conditions specified in the configuration 946-c, together with their contact information from the rescuer archive 946-b. The initial list is then sent to the SOS calling unit 950, which will then carries out the task of calling the rescuers via the communication unit 850. The term “calling” is a general term referring to contacting for help without being limited to making phone calls. As such, calling a rescuer as used in this disclosure may be via an email, a phone call, or a text message pushed to a candidate rescuer. In some embodiments, rescuers may also be contacted via some application deployed on some devices. Such an application may connect a network of rescuers, including both professional rescuers and volunteer rescuers who agree to serve as rescuers in case of need. Such rescuers may also be a person who is monitored by the real time health monitor 210. As the real time health monitor 210 can be used by people of all health conditions, including healthy people and sub-healthy people, a large population of users of the real time health monitor 210 may be in a condition that allows them to act as rescuers in case of need. Such users may sign up with certain rescue organizations or other rescue facilitating services as volunteer rescuers who may be called upon when the need arises. For example, a backend health service provider (will be disclosed later) may provide rescue coordinating services by leveraging its network of professional rescuers (such as paramedics or hospitals) and a wider range of volunteer rescuers.

The backend health service provider mentioned above may correspond to a server that connects different parties via its service platform, including hundreds of thousands of mobile devices having the real time health monitors 210 deployed thereon, the cloud 260, a network of emergency contacts of the its service subscribers, individuals and organizations that may be called upon by the backend health service provider to handle medical emergency situations, etc. More details about this backend health service provider will be provided later. In case of an emergency situation, when the backend health service provider is called upon for initiating a rescue, it may act as a facilitator and organizer to ensure that the rescue be coordinated in a way appropriate and effective for the situation, the rescue will take place timely and orderly, and successfully, and the recordation of the entire process be complete, and when necessary, personnel be physically dispatched to the real scene when needed.

The SOS calls placed to the selected volunteer rescuers may furnish the called rescuer with different types of information, including the location of the person who needs immediate rescue, the conditions the person suffers from, and the additional information about the person such as age group, gender, etc. In some embodiments, sensitive private information may be concealed such as name of the person and certain health condition of the person, etc. When the SOS calls reach the selected volunteer rescuers 960, some rescuer(s) may respond to the call. The response may be provided in different forms. For example, if an application serves as the platform for the call, a response may correspond to, e.g., a press on a soft acceptance button. Any other alternatives may also be used to implement the mechanism of responding to an SOS call. A response from a rescuer may also incorporate various types of relevant information, such as the name of the rescuer, the current location of the rescuer, estimated time to arrive, etc.

A positive response to an SOS call, when received by the communication unit 850, may be forwarded to the SOS response processor 952, which may then analyze the response signal to extract certain information such as the identification of the responding rescuer, current location of the responding rescuer, or estimated arrival time. Such parsed information may then be sent to the rescuer selector 954, which may select one or more responding rescuers based on various considerations, e.g., the estimated arrival time or location of the rescuer or even the level of qualification of the responding rescuer (e.g., information from the rescuer archive 946-b).

Once the rescuer is selected, the rescue facilitator 956 may be invoked to gather detailed relevant information related to the emergency situation and send to the selected rescuer. Such relevant information may include the precise location of the emergency, the nature of the emergency, information about the person who is in the urgent need, and any other information that may be helpful to the rescuer. Such relevant information is then sent to the selected rescuer via the communication unit 850.

In some embodiments, once a rescuer is selected, information related to the selected rescuer may be forwarded from the rescuer selector 954 to a rescue log (946-a). In some implementations, volunteer rescuers who actually rescued others may be recorded and may be rewarded in some prescribed manner. In some embodiments, rescuers who responded yet not selected may also be recorded in the rescue log 946-a and the response they made may also lead to some reward based on the role they played during the process. Some of the reward may be in the form of exchange of services. In other situations, monetary reward may also be possible, e.g., the family of the person being rescued may pay monetary reward to the volunteer rescuer who acted to the SOS call.

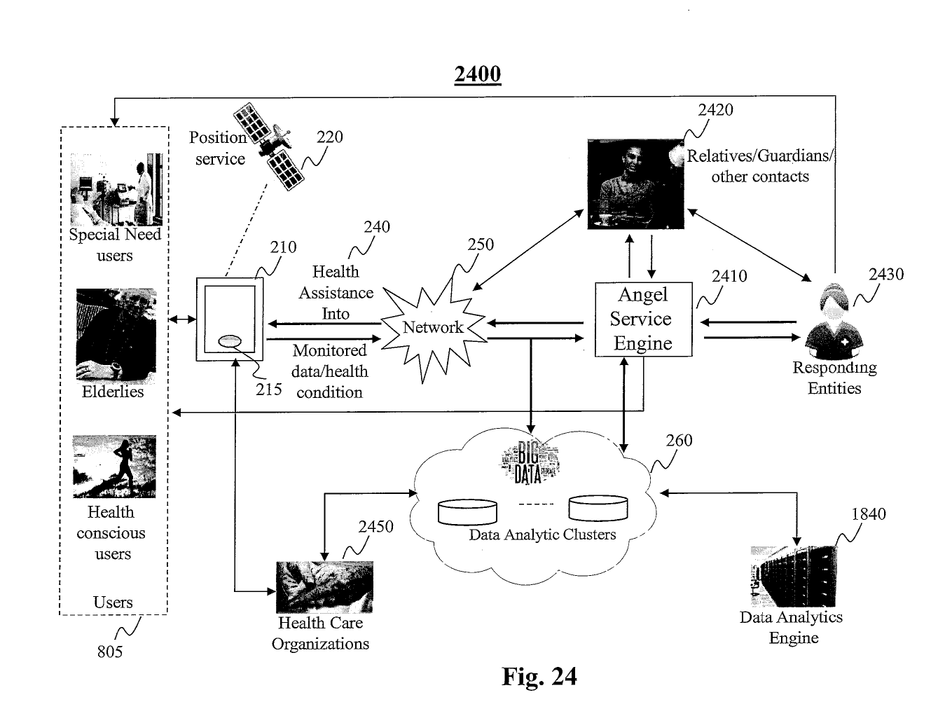

Content recorded in rescuer log 946-a may be subsequently uploaded from the real time health monitor 210 to the cloud 260 or directly to some backend health service provider (discussed with reference to FIGS. 24-35). The reward to rescuers who have been active may be identified by the backend health service provider to determine reward.

As discussed above, the SOS calling may be carried out in several rounds until some rescuer is confirm to arrive. In some situations, it is due to no one in the calling range responded. Another scenario may be that none of the responding rescuers is qualified and selected by the rescuer selector 954. For example, if the emergency situation calls for CPR but none of the responding rescuers is capable of performing CPR. It is also possible that the responding rescuers are too far for the emergency situation in hand. In any of such situations, the rescuer selector 954 may inform the rescuer identifier 948 to initiate the next phase of the SOS calling.

As discussed above, in some embodiments, the SOS calling range in each phase may be limited to certain conditions such as geographical coverage or others. When the SOS calling in the current phase fails to yield any rescuer, the rescuer identifier 948 may be invoked again with the indication that the current SOS calling range did not work so that the rescuer identifier 948 may accordingly relax the condition to include more rescuers to make the SOS callings. In other situations, if the reason for not being able to identify any rescuer is because a certain rescuer pool (e.g., volunteer rescuers) does not have certain required qualification (e.g., handle seizure patient), the next strategy may be to extend the calling range to a different rescuer pool (e.g., professional rescuers). Such relaxed conditions/limits may be stored in the rescuer configuration 946-c which can be retrieved by the rescuer identifier 948 when the next round of calling is necessary. Alternatively, how the limits may be relaxed or modified may also be programmed in the rescuer identifier 948.

Based on the modified conditions or limits, the rescuer identifier 948 may then identify a modified list of rescuers according to the modified conditions/limits and send this list to the SOS calling unit 950 to call for help. In some embodiments, the modified list of rescuers may exclude the rescuers in the initial list of rescuers who either have not yet responded or not selected. In some embodiments, the modified list of rescuers may include some rescuers who were on the initial list but not yet responded in order to give them more time to respond. This process of calling rescuers, modifying limitations, and calling again based on a modified list of rescuers may continue until some conditions are met. Such termination condition may be pre-determined such as a time-out period or dynamically set, e.g., when a rescuer is found.

To prevent the situation that it takes an unreasonable amount of time to locate rescuers, the SOS calling unit 950 may be configured to be triggered by the emergency handling unit 870 at the same time as the rescuer identifier 948 is triggered by the emergency handling unit 870. Upon being triggered by the emergency handling unit 870, the SOS calling unit 950 may immediately send a SOS calling call, via the communication unit 850, to the cloud 260 or directly to a backend health service provider (that may connect to the cloud 260). As the backend health service provider may be connected to a wider range of rescuers, including both volunteer and professional rescuers, sending an SOS call to it may ensure a timely response to the emergency situation. In some embodiments, the backend health service provider may be used as a backup to the SOS calling performed by the real time health monitor 210. Whether the backend health service provider as a backup or not may be determined based on the seriousness of the emergency situation.

If the backend health service provider, upon receiving the SOS call from the SOS calling unit 950, finds an appropriate rescuer or a rescue team, it may respond to the SOS calling and such a response may include the information of the selected rescuer or rescue team (e.g., contact information and location of the rescuer) and a confirmation that the rescuer/rescue team, e.g., already on the way to the emergency scene. Such a response from the backend health service provider may be processed by the SOS response processor 952. In some embodiments, the rescuer selected by the backend health service provider may have a different priority than the rescuers selected by the real time health monitor 210. The rescuers, responded to either the SOS call from the real time health monitor 210 or to the call from the backend health service provider, may be subject to further selection by the rescuer selector 954. In some embodiments, the responding rescuer identified by the backend health service provider may take a high priority given that the responding rescuer is qualified given the emergency situation.

In some embodiments, the backend health service provider may not only assist to make SOS calls but also organize the rescue. When the backend health service provider coordinates a rescue, it responds to the SOS call from the SOS handling unit 880 on the wearable device 210. For example, it may indicate that a rescue team is already sent and is on its way to the person in the emergency situation. In this situation, the response from the backend health service provider may simply include a confirmation indicating that the SOS rescue call has been fulfilled. In this situation, the SOS response processor 952 may, upon receiving such a confirmation, inform the SOS response selector 954 and/or the rescuer identifier 948 to cease the further processing any SOS related tasks.

FIG. 9L is a flowchart of an exemplary high level process of the SOS handling unit 880, according to an embodiment of the present teaching. When the SOS handling unit 880 is invoked, it accesses, at 970, the rescuer archive 946-b and the rescuer configuration 946-c in order to identify, at 972, a list of qualified candidate rescuers that are appropriate for the emergency situation. Based on the identified list, the SOS calling unit 950 acts to call (or broadly send an SOS request), at 974 via the communication unit 850, the rescuers included in the list with relevant information needed for the contacted rescuer to respond, such as the location of the emergency and some general information on the nature of the emergency. An SOS request to each of the rescuers in the list may be sent in a form that is appropriate for that rescuer, e.g., via a voice call, an email, or a text message pushed to the candidate rescuer. Optionally, when the SOS handling unit 880 is invoked by the emergency handling unit 870, the SOS calling unit 950 in the SOS handling unit 880 is also activated, which may send, at 968, an SOS call to the cloud 260 (which may be connected to a backend health service provider) or directly to the backend health service provider.

After the SOS calls have been sent, the SOS handling unit 880 waits to receive a response or a confirmation, at 976, from the called parties (either the identified rescuers or the backend health service provider) and the responses may be recorded, together with the requests sent, or archived. The recording may be directed to the entire rescue process so that there is a record archived for each emergency handling instance. In responding to the received response(s), the SOS handling unit 880 determines, at 978, whether the SOS call has been fulfilled. For instance, if the response is from the backend health service provider indicating that the SOS call has been completed and the rescue team is on its way to the person, the SOS call is fulfilled. If the SOS call has not yet been fulfilled, i.e., although responses are received, no rescuer has been selected, the SOS handling unit 880 determines, at 979, whether an appropriate rescuer has been selected. If not, e.g., the rescuer selector 954 does not select any of the responding rescuers as appropriate rescuer, it is further determined, at 980, whether the SOS calling should continue, e.g., based on some conditions. If the SOS calling is not to continue, the process ends at 988. If the SOS calling is to continue, a modified or alternative SOS calling configuration is adopted, at 982, and the rescuer identifier 948 continues, in the next round, to identify rescuers based on the modified/alternative SOS calling configuration and additional calls to such identified rescuers continue to be made at 974, etc.

When it is determined that certain rescuer(s) has been selected to respond to the emergency situation, determined at 978 or 979, the rescue facilitator 956 proceeds to gather relevant information for the rescue and sends, at 984, such information to the selected rescuer(s). The information related to the selected rescuer(s) is then archived, at 986, in the rescue log 946-a.

FIG. 9M illustrates the real time connections among different parties in handling a rescue situation, according to an embodiment of the present teaching. In FIG. 9M, the user 805 is a person being monitored via a mobile device on which the real time health monitor 210-1 is deployed for that purpose. The guardian 920 is a guardian of the user 805 (e.g., a daughter of the user 805) who monitors the health situation of the user 805 via her mobile device on which another real time health monitor 210-2 is deployed. Another party is a rescuer 960 who also has a mobile device on which another real time health monitor 210-3 is deployed. These three parties are connected via the network 250. There is also a backend health service provider 983 in FIG. 9M, residing behind the cloud 260 and connected to the above mentioned parties via the network 250.

In an emergency situation, the emergency handling unit 870 residing in the real time health monitor 210-1 may contact the guardian 920 via the network 250. In a different embodiment, the emergency call may also be first directed to the backend health service provider 983, which then contact the guardian 920. If rescue is warranted, determined by the emergency handling unit 870 residing in 210-1, the SOS handling unit 880 residing in the real time health monitor 210-1 sends out SOS calls to rescuers 960, either directly or via the backend health service provider 983.

Upon receiving the notification from the 210-1, the real time health monitor 210-2 of the guardian enables the guardian, via various user interfaces such as the ones illustrated in FIGS. 9G-9H and some additional exemplary interfaces described below, to be in communication with different parties, including the user 805, the rescuer 960, the backend health service provider 983, and the facility (not shown) the user 805 resides. Similarly, upon receiving the SOS call by the rescuer 960, the real time health monitor 210-3 deployed on the rescuer's mobile device enables, via interfaces shown in FIG. 9I and below, the rescuer 960 to communicate with the user 805, the rescuer 960, the backend health service provider 983, or others (if the rescuer elects to do so on his/her device). The backend health service provider 983 is connected to all in order to coordinate and facilitate the rescue effort. It may receive in real time the dynamically updated information from the user's device 210-1 and distribute relevant information to appropriate parties (e.g., direct the wondering user's current location information or the medical updated information to the rescuer 960). The backend health service provider 983 continuously monitors the overall situation and reacts accordingly in order to coordinate and facilitate all parties to fulfill the rescue. In some embodiments, a physician may also be simultaneously connected (now shown) in order to provide online assistance to the user to be rescued or to the rescuer instructing what needs to be done when the user is being rescued.

FIG. 9N illustrates exemplary interface in a rescue situation, according to an embodiment of the present teaching. In this exemplary interface, the area 913 is displayed with a map in which both the location of the user 805 being rescued (957) and the location of the rescuer 960 (953) are marked. The route likely to be taken by the rescuer is also marker using dotted curve (959). This map may be dynamically updated with time, including when the rescuer 960 takes an alternative route and/or when the distance between the user 805 and the rescuer 960 are continuously reduced. In some embodiments, accompanying with the map visualization, the SOS handling unit 880 may also receive driving directions (e.g., from the backend health service provider 983) to provide to a rescuer user (not shown). Such driving directions may be delivered in audio form, serving as a GPS to the rescuer. In some embodiments, information about the traffic situation along the pictured route may also be gathered (e.g., from the backend health service provider 983) and provided to a rescuer user to help the rescuer to dynamically select the best route to the emergency site (not shown).

In this illustrated interface, in area 919, certain information may also be presented to help a user (which may be a user to be rescued, a rescuer, or a guardian) to see the current situation. For a user to be rescued, what is displayed may be to inform the user how close the rescuer is and how soon the rescuer is to arrive. If the interface is for a rescuer, different information may be displayed, e.g., the traffic condition of certain route (not shown) so that the rescuer may adaptively determine to change the route to arrive in a shorter time. For a guardian user, the information displayed in area 919 may or may not be the same as what is presented to the user to be rescued. For instance, the alternative route may be suggested to the rescuer in case of high traffic on the current route. The rescuer may elect to take the suggested alternative route via an audio command, for example.

FIG. 9O illustrates another exemplary interface which brings more than two parties together to assist a person to be rescued, according to an embodiment of the present teaching. In this exemplary interface for a person to be rescued, in area 913, there are two video communication channels open at the same time, one with a doctor 937 and the other with a rescue team 939. In area 931, information from both the doctor and the rescuer may be displayed in an interleaved manner. Such information may also be delivered to the user being rescued in, e.g., an interleaved manner. In some embodiments, more parties may also be brought in in the same interface, e.g., also the guardian or some personnel residing in the backend health service provider. In that case, there may be a conference call hub allowing multiple parties to all participate at the same time set up, e.g., by the backend health service provider 983. Such multiple-way communication may be visual or audio only. In case of visual communication, the area 913 may be split into multiple sub-regions (e.g., two sub-regions in FIG. 9O) each of which is a visual communication channel with one party.

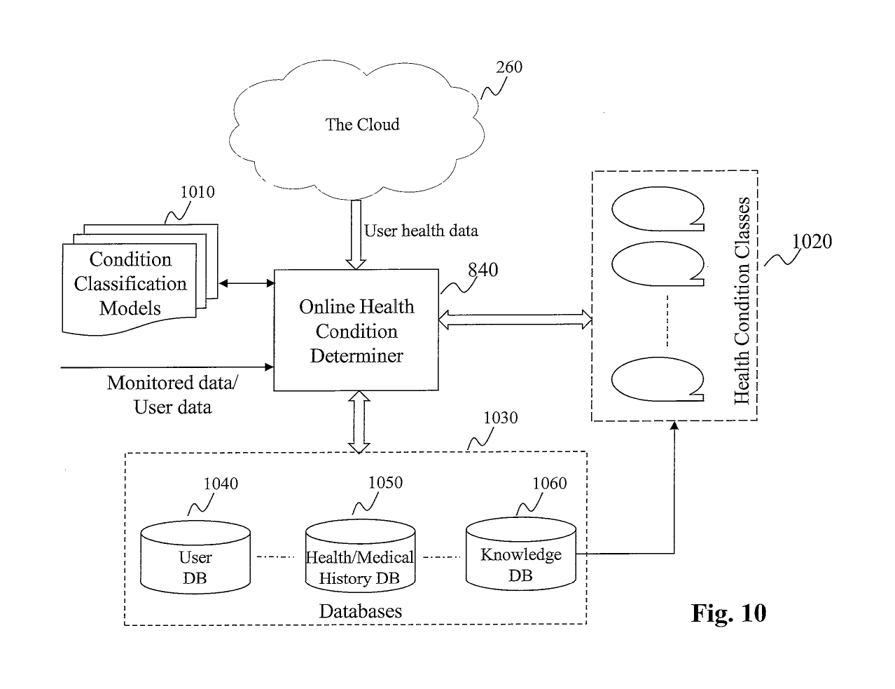

FIG. 10 depicts an exemplary high level system diagram involving the online health condition determiner 840 for model based health condition classification based on continuously monitored/measured user health information, according to an embodiment of the present teaching. As discussed herein, the online health condition determiner 840 may reside in the real time health monitor 210 to perform in situ health condition classification or, alternatively, be part of a backend health service provider (e.g., 983 which is to be discussed in detail below). As shown, the online health condition determiner 840 is connected with data from different sources in order to appropriately classify the health condition of a person based on the received monitored data (including health data and vital signs). The online health condition determiner 840 receives the monitored data/user data either directly available from the real time health monitor 210 (when it resides on the real time health monitor 210) or from the cloud 260 (when it resides in the backend). To facilitate classification, the online health condition determiner 840 also receives different types of information from other sources 1030, such as information from a user database 1040, health/medical history database 1050, . . . , and possibly some general knowledge database 1060. The user information form the user database 104 may differ from the user information stored in the in situ user health log 845. The in situ user health log 845 may be used to store some user specific information, health data/vital signs monitored by the real time health monitor 210, and possibly some estimated health condition classifications. The user database 1040 may include other types of information not present in the in situ user health log 845 but likely relevant to the classification of health conditions. For example, the user database 1040 may include user's demographic data (which sometimes affect health condition classification), occupation related information (e.g., intensive physical labor work, normal work schedule is night shift and sleep during the day), different personal preferences (e.g., foods, drink, etc.), allergies, etc.

Similarly, although the in situ user health log 845 may include health data/vital signs monitored by the real time health monitor 210, the health/vital history database 1050 may contain additional information collected from other sources that will be otherwise also useful in health condition classifications. Examples of such additional information may be gathered from doctors' offices, hospitals, pharmacies, or medical results from, e.g., job related check-ups.

The knowledge database 1060 may be a collection of knowledge related to health which may be distributed in the network. Examples of information of such medically/health related knowledge includes the symptom of different diseases, the criteria used in diagnosing various diseases, the medicine available in the market to treat different diseases and side effect thereof, the correlation between certain types of disease with race of the person, or the hereditary nature of certain health conditions and diagnosis thereof, etc. Such information can be either managed in a centralized manner or can be dynamically gathered when needed.

Different databases in 1030 may be fully or partially stored on the real time health monitor 210 and may be updated when the need arises. They may also be stored in the cloud 260 (not shown) and be accessed by real time health monitor 210 when needed. In another option, such data may be provided by a third party service provider (not shown) that offers its services by gathering relevant information from the Internet and other sources and making such data available to whomever subscribe the services. Another alternative is that information stored in the data center 1030 may also be provided by some backend system such as the backend health service provider 983 with which the real time health monitor 210 is connected.

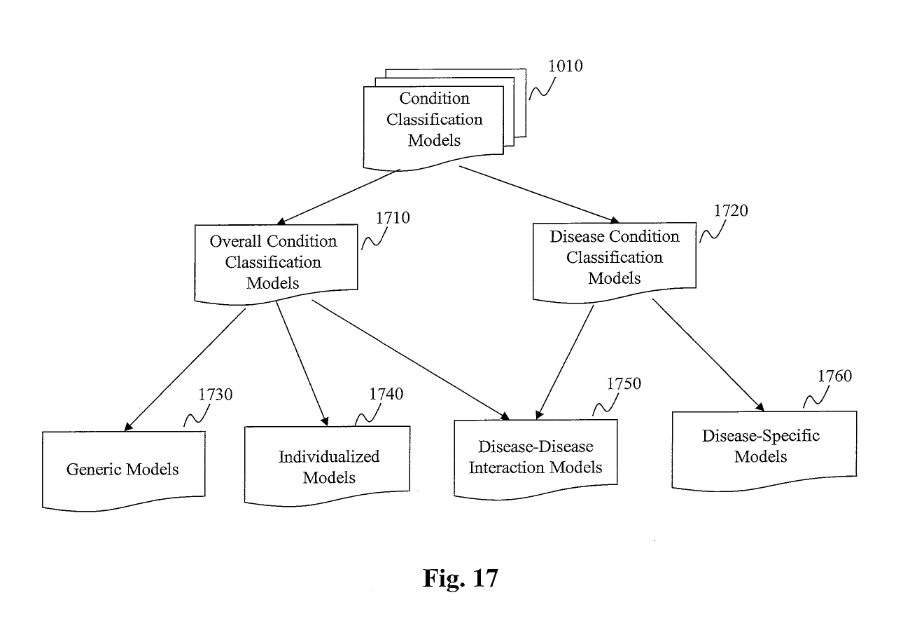

The online health condition determiner 840 classifies a person's health condition based on the health data/vital signs of the person monitored via a real time health monitor 210. To derive more accurate classification of health conditions, the online health condition determiner 840 performs classification based on health condition classification models 1010. For example, the classification may be performed based on both generic models describing relationship between certain health conditions and health data/vital signs. For instance, an emergency related to a heart attack maybe associated with a reduction in heart rate and lowered level of oxygen in the blood stream. The classification of health condition may also take into account of each individual's situation. According to the present teaching, individualized models may be derived for each person based on specific information related to the person. For example, for a person who has diabetes related complications, even small increase in blood pressure may signal a serious problem and calls for emergency and rescue. For another person who is healthy, the same amount of increase in blood pressure may warrant just a caution. So, individualized models for each person may be invoked in order to arrive at more reasonable classification. Details about the classification models 1010 and their usage in classifying health conditions are discussed in reference to FIGS. 17-21. The result of the online health condition determiner 840 is one or more health condition classes 1020. Exemplary types of classifications are discussed with reference to FIG. 5.

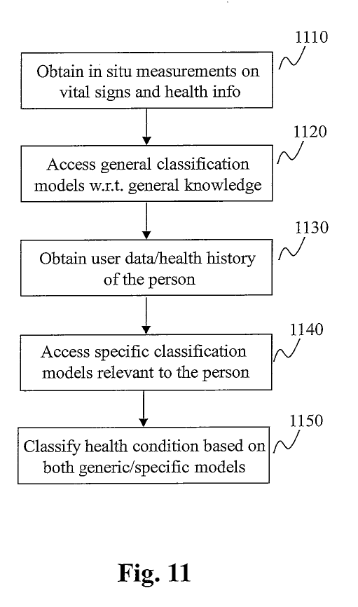

FIG. 11 is a flowchart of an exemplary process in which the online health condition determiner 840 residing inn a real time health monitor 210 classifies health conditions based on continuously monitored/measured vital signs/health information, according to an embodiment of the present teaching. At 1110, the online health condition determiner 840 obtains various monitored measurements of vital signs and person's health data. To classify the person's health condition, the online health condition determiner 840 accesses, at 1120, general classification models that are, e.g., trained based on general medical knowledge. In classifying the person's health condition, the online health condition determiner 840 also takes into account of the person's specific information. To achieve that, the online health condition determiner 840 also retrieves, at 1130, information related to the person such as health history information and some identification information, as well as, at 1140, classification models specific to the person based on the person's identification information. Based on the monitored vital sign/health data, retrieved general/specific models and personal health information, the online health condition determiner 840 classifies, at 1150, the person's health condition into one or more categories as discussed with respect to FIG. 5.

As discussed herein, in some embodiments, the online health condition classification may be carried out at backend, e.g., by a health service provider, using monitored vital sign/health data stored in the cloud 260 (which is based on what was sent from a real time health monitor 210 to the cloud 260). In this case, the online health condition determiner 840 may resides behind the cloud 260, e.g., within a health service engine. In this configuration, the way the online health condition determiner 840 interfaces with data sources differs from that illustrated in FIG. 11 in terms of how the data to be used for classification are obtained.

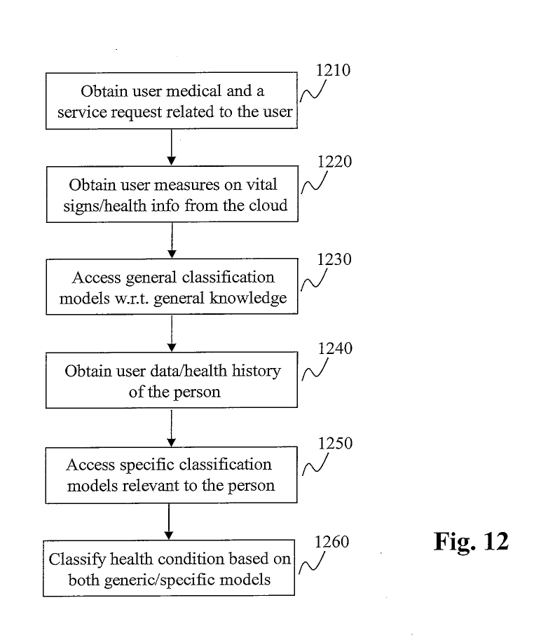

FIG. 12 is a flowchart of an exemplary process of an online health condition determiner 840 residing on a server that classifies a person's health condition based on health information from the cloud that is continuously monitored/measured via a real time health monitor 210, according to an embodiment of the present teaching. In FIG. 12, an identification of a person and a service request for classifying the person's health conditions are received at 1210. The identification of the person may be a medical identification or a unique personal identification such as social security number. Based on the identification, the online health condition determiner 840 retrieves, at 1220, monitored vital sign/health data from the cloud based on the person's identification. From this point on, the remaining steps of the flowchart of the operational process of the online health condition determiner 840 is similar to that when it resides on a real time health monitor 210. Specifically, to classify the person's health condition, the online health condition determiner 840 accesses, at 1230, general classification models that are, e.g., trained based on general medical knowledge. In addition, the online health condition determiner 840 also takes into account of the person's specific information in classifying the person's health condition. Particularly, the online health condition determiner 840 retrieves, at 1240, information related to the person such as health history information and some identification information, as well as, at 1250, classification models specific to the person based on the person's identification information. Based on the monitored vital sign/health data retrieved from the cloud 260, general/specific models, and personal health information, the online health condition determiner 1150 classifies, at 1260, the person's health condition into one or more categories as discussed with respect to FIG. 5.

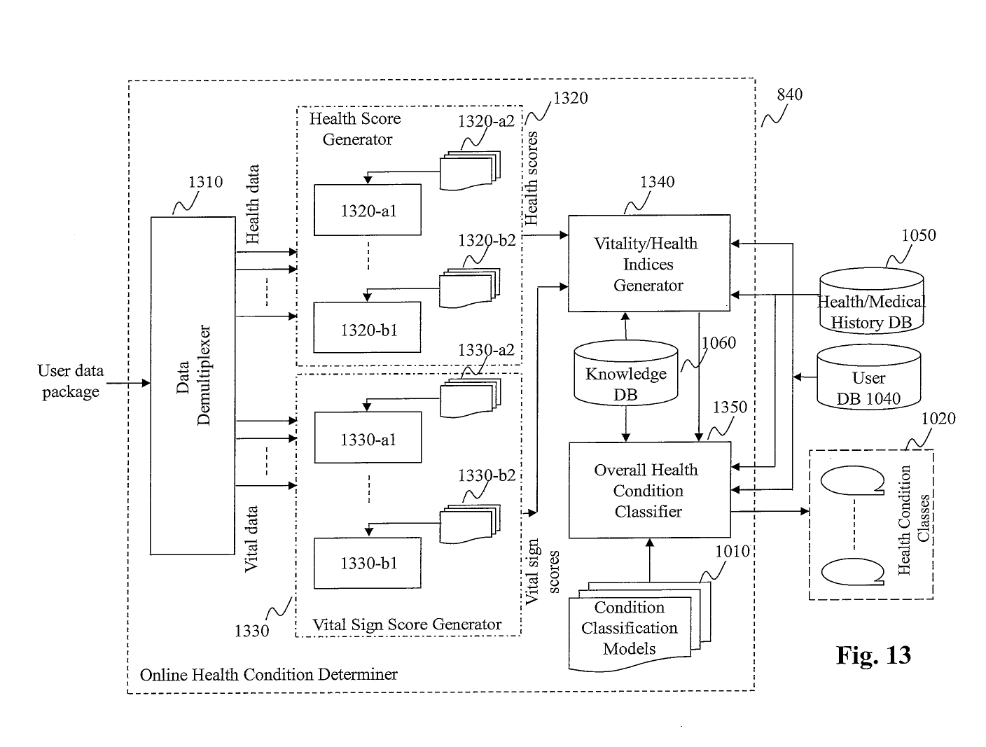

FIG. 13 depicts an exemplary internal system diagram of the online health condition determiner 840, according to an embodiment of the present teaching. In this exemplary embodiment, the online health condition determiner 840 comprises a health score generator 1320, a vital sign score generator 1330, a vitality/health indices generator 1340, and an overall health condition estimator 1350. Optionally, the online health condition determiner 840 may also include a data demulplexer 1310, which functions to take a data package that contains all measurements of vital signs/health data and demultiplex the data package into different types of monitored measurements such as heart rate, sleep, etc. and send each to the appropriate function module. For example, the demultiplexed diet information will be sent to the health score generator 1320 because diet information is related to health data rather than vital signs. Similarly, heart rate information will be sent to the vital sign score generator 1330 as it corresponds to a vital sign. Alternatively, each measured vital sign or health data may be sent directly to its corresponding module without the data demultiplexer 1310.

In operation, the vital sign score generator 1330 takes measurements related to vital signs, monitored by the real time health monitor 210, as input and generates individual vital scores, each of which is with respect to a particular vital sign, e.g., blood pressure, breathing rate, SoP2, heart rate, etc. Accordingly, the vital score generator 1330 includes a plurality of score generators 1330-a1, . . . 1330-b1, each of which may be designed to compute the vital sign score with respect to one type of vital signs. Each of the score generators may compute the corresponding score based on configured models. For instance, score generator 1330-a1 may compute a score based on models stored in 1330-a2, . . . , score generator 1330-b1 may compute a score based on models stored in 1330-b2. Models used for each score generator may be related to the specific configuration used to compute that score and/or may be the calibration parameters to be used to calibrate the measurement of the score with respect to different factors.

In some embodiments, each of the individual vital sign scores may be computed according to a corresponding range of the underlying vital sign. Such ranges may be configured dynamically with respect to various factors such as the person's age, gender, weight, physical condition (such as handicap), and the overall health. That is, different groups of people who are not similarly situated may use different ranges with respect to each vital sign. In addition, such ranges may change over time for each person based on updated status in terms of such factors. Such dynamically adjusted ranges are stored in 1320-a2, 1320-b2 and used by 1320-a1, . . . , 1320-b1 in their computations of the vital sign scores. In some embodiments, each vital sign score is computed by assessing, against an appropriate range, each vital sign score may be computed based on where the measured vital sign lies with respect to its corresponding range. For instance, assume that the normal range of heart rate is 50-110. Given that, in normal situations, if a person's monitored heart rate is within this range, the score for heart rate is zero. If the monitored heart rate is between 110-130, the score for heart rate may be 2. Similar, if the monitored heart rate is between 130-150, the score assigned for heart rate may be 5. However, a score assigned to a measured heart rate range of a specific person may be adjusted based on other personal conditions such as age, gender, health/medical history and physical condition at the moment of the measurement. For example, if the heart rate is measured during or right after the exercise, i.e., the heart rate will be high, then the score assigned to the monitored heart rate range may be adjusted accordingly.

Similarly, the health score generator 1320 takes the health data measured by the real time health monitor 210 as input and generates individual health scores, each of which may correspond to one particular type of health data, e.g., diet, sleep, mode, and activities. The health score generator 1320 includes a plurality of score generators 1320-a1, . . . 1320-b1, each of which may be designed to compute the vital sign score with respect to one type of vital signs. Each of the score generators may compute the corresponding score based on configured models. For instance, score generator 1320-a1 may compute a score based on models stored in 1320-a2, . . . , score generator 1320-b1 may compute a score based on models stored in 1320-b2. Models used for each score generator may be related to the specific configuration used to compute that score and/or may be the calibration parameters to be used to calibrate the measurement of the score with respect to different factors.

Similar to vital sign scores, in some embodiments, each of the individual health scores may be computed according to a corresponding range for the particular health factor. Such ranges may be configured dynamically with respect to various factors such as the person's age, gender, weight, physical conditions (e.g., some people may have a physical condition may not allow the person to do exercise), the overall health (e.g., what disease(s) the person has), and the vitality index. That is, different groups of people who are not similarly situated may use different ranges with respect to each health factor. For example, for health factor “sleep,” normal range of adequate amount of sleep changes with age. Young children are known to need more hours of sleep while elderlies usually need fewer hours of sleep. In terms of exercises, although middle aged people may need more hours of physical activities to remain healthy, people who have physical conditions that prohibit them from physical activities evidently cannot use the same ranges for this health factor in computing their health scores. Such ranges may also change over time for each person based on updated status in age, etc.

Different from vital signs, some health scores may be computed with respect to a time frame in order for them to be meaningful. For instance, a score for health factor “sleep” may be computed based on each 24 hours. A score for health factor “physical activity” may be computed as an average per week. At any point, some health scores may be computed to reflect either an averaged performance over a period of time or the regularity of some anticipated event, e.g., average number of daily hours of sleep in a week or an average pattern/regularity of exercise in a week, etc.).

Both the dynamically adjusted ranges for individual health factors as well as the time frames to be used for computing individual health scores are stored in 1330-a2, . . . , 1330-b2 as configurations/models. In operation, such stored configurations (models) are used by 1330-a1, . . . , 1330-b1 in their corresponding computations of the health scores. In some embodiments, the health scores for a person may be determined against such ranges within the time frames configured for each score.

The vitality/health indices generator 1340 is to use the vitality raw score and the health scores from the health score generator 1320 and the vital sign score generator 1330 and compute the health index and vitality index, which are then sent to the overall health condition classifier 1350.

The overall health condition classifier 1350 is to classify the overall health of a person based on various types of information. The basis for the classification may include both the monitored vital signs and the monitored health data. Taking the vital index and the health index from as input, the overall health condition classifier 1350 classifies the input based on condition classification models 1010, with consideration of, e.g., knowledge stored in the knowledge database 1060. This is driven by the knowledge that both vital signs and health data affect a person's health. In addition, in determining the health condition of a person, it is evident that personal information of the person such as health history or others such as information about the person's occupation or life style also comes into play. So, information stored in the user database 1040 (e.g., occupation and life style of the person) and the person's health history in 1050 are also input to the overall health condition classifier 1350 so that the disease specific assessment of the person's health condition may likely be used in estimating the overall health condition assessment. Details regarding the condition classification models are provided with reference to FIGS. 17-19. The output of the overall health condition classifier 1350 is one or more health condition classes and such result is stored in the health condition classes archived in 1020.

When the online health condition determiner 840 resides on a real time health monitor 210, the health condition classes 1020 output from the overall health condition classifier 1350 correspond to the health information of the person who is monitored by the real time health monitor 210. Such classification of the person may be stored locally on the real time health monitor 210 and/or in the cloud 260. Due to space limit on the real time health monitor 210, the amount of the data stored on the device may be limited to a certain time period but the cloud 260 will archive the person's health information without time limitation or with a much longer time limitation. When the online health condition determiner 840 corresponds to a backend version residing on, e.g., a health service engine, it may process health monitoring information from many people from the cloud 260 and the classification results may be archived in the cloud 260 and at the same time, e.g., the current classification may be sent back to the real time health monitor 210 of each person. The health condition classes 1020 of different people may be indexed according to unique identification of each person and retrieved based on such identification information.

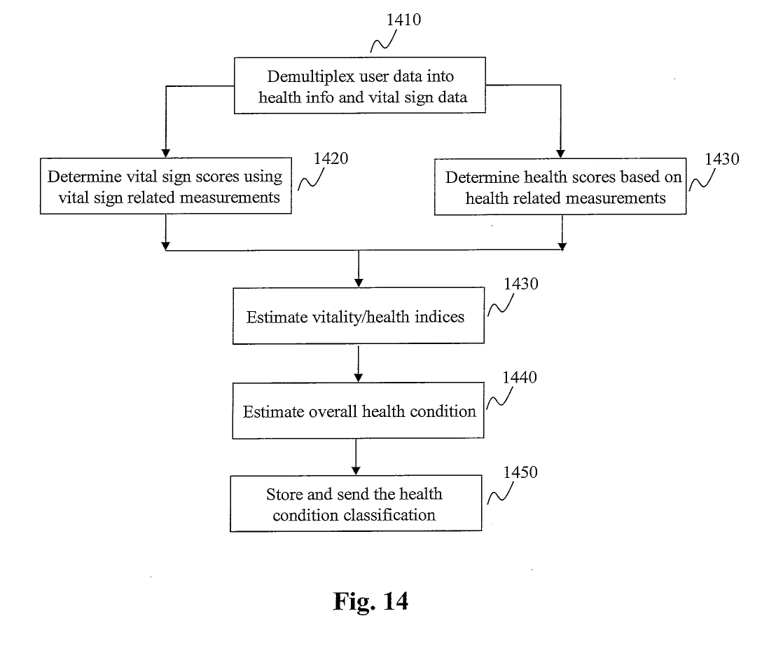

FIG. 14 is a flowchart of an exemplary internal operational process of the online health condition determiner 840, according to an embodiment of the present teaching. First, optionally, the data demultiplexer 1310 may demultiplex, at 1410, a user data package containing monitored vital signs (from the vital sign measurement unit 820 in FIG. 8) and health data (from the health data measurement unit 815 in FIG. 8). The vital sign related user data are multiplexed to the vital sign score generator 1330 and the health data related user data are multiplexed to the health score generator 1320. With received vital sign related information, the vital sign score generator 1330 determines, at 1420, vital sign scores based on the received information. On the other hand, upon receiving the health data, the health score generator 1320 determines, at 1430, health scores based on the received information.

Using the computed vital sign scores and health scores, the vitality/health indices generator 1340 computes, at 1430, corresponding health and vitality indices and send such indices to the overall health condition classifier 1350. At 1440, the overall health condition classifier 1350 estimates the overall health of the person. Once estimated, the overall health condition classifier 1350 stores and sends, at 1450, the classification(s) to the communication unit 850 of the real time health monitor 210 (FIG. 8).

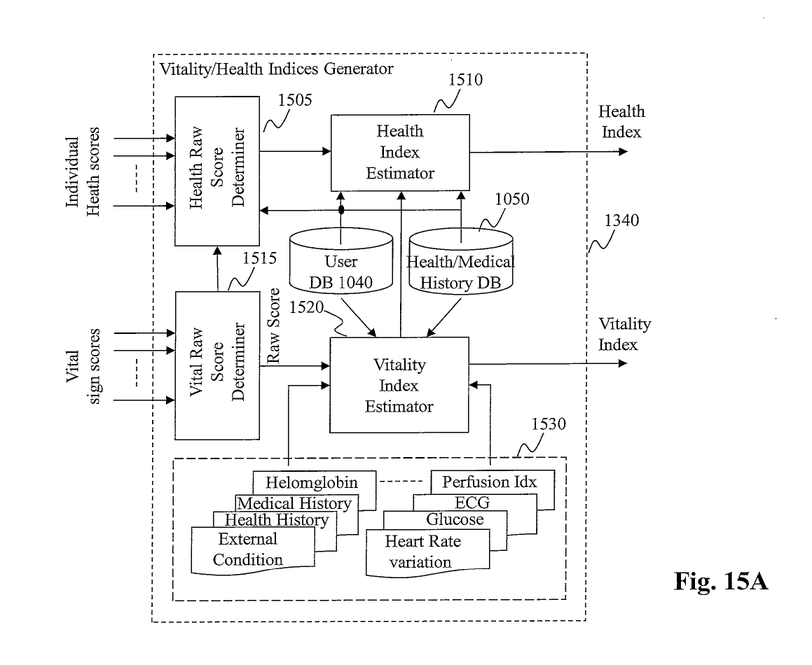

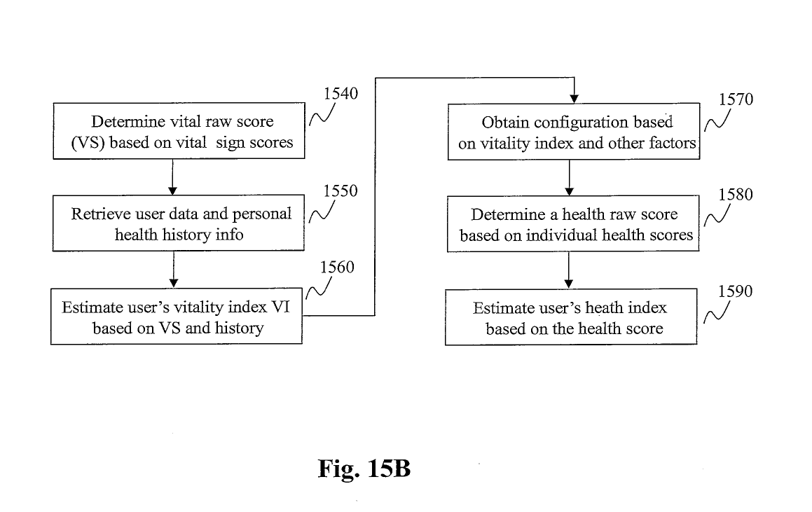

FIG. 15A depicts an exemplary internal system diagram of the vitality/health indices generator 1340, according to an embodiment of the present teaching. The vitality/health indices generator 1340 comprises, a health raw score determiner 1505, a health index estimator 1510, a vital raw score determiner 1515, and a vitality index estimator 1520.

In estimating the health condition based on health data, the health raw score determiner 1505 takes the individual health scores from the health score generator 1320 (FIG. 13) as input and computes the health raw score based on the individual health scores. In some embodiments, the health raw score may be computed as a sum of all individual health scores. In some embodiments, the sum of individual health scores may be a weighted sum with weights applied to different individual health scores. Weights used may be determined general health knowledge or adapted according to certain information of each person. Accordingly, weights applied to the same health factor in connections with different people may differ and determined based on information specifically related to the person, e.g., retrieved from, e.g., the user database 1040 and the health/medical history database 1050. Based on the health raw score (HS), the health index estimator 1510 computes the health index (HI). In some embodiments, HI=1/(1+HS). However, it can also be computed using any other formula.

In estimating the health condition based on vital sign related data, the vital raw score determiner 1515 takes the individual vital sign scores from the vital sign score generator 1330 (FIG. 13) as input and computes the vital raw score (VS) based on the individual vital sign scores. In some embodiments, the vital raw score may be a sum of all vital sign scores. Similarly, the weights applied to different vital sign scores may be different and determined based on information specifically related to the person, e.g., retrieved from, e.g., the user database 1040 and the health/medical history database 1050. Accordingly, weights applied to the same vital sign scores of different people may vary. In computing the vital raw score, the level of risks of the person with high risk diseases may be estimated, as shown in FIG. 15A, with respect to various measures 1530 such as Perfusion Index, Hemoglobin, glucose, ECG, heart rate variation, medical history, existing health conditions, and certain external conditions. The computed VS may be weighed against those estimated high risk diseases, if existing.

The computed VS is then sent to the vitality index estimator 1520, which computes the vitality index (VI), which reflects a person's ability to overcome health related risks. In some embodiments, VI=1/1+VS. Any formulation can also be used. The vitality index thus computed may then be used to classify a person's health into one or more different health condition classes. As discussed with respect to FIG. 5, there are five classes of vital sign based health condition classes, namely normal, caution, caution, warning, and emergency.

FIG. 15B is a flowchart of an exemplary process for the vitality/health indices generator 1340, according to an embodiment of the present teaching. Consistent with the description with respect to the system diagram in FIG. 15A, there are also two different routes in the internal flow for computing different health related indices, one route being related to the estimation of vitality index and the other relating to the estimation of the health index. At 1540, based on input vital sign scores, a vital raw score (VS) is determined. At 1550, to weigh against different potential high risk diseases, information related to the person such as different test results and health history, etc. are retrieved and used, at 1560, to estimate the person's vitality index (VI) given the vital raw score (VS). Once the vitality index (VI) is estimated, it is used, at 1570, to estimate the person's health condition class(es) with respect to the vitality index VI.

Along the route of computing the health index, at 1570, an appropriate configuration set up for computing a health raw score based on the vitality index (and others such as age, gender, weight, physical condition, and existing disease(s)) is obtained. Using the configuration set up based on the vitality index, a health raw score (HS) is determined, at 1580, based on the input individual health scores. The health raw score HS is then used, at 1590, to compute he health index (HI), which will be subsequently used to estimate the person's health condition.

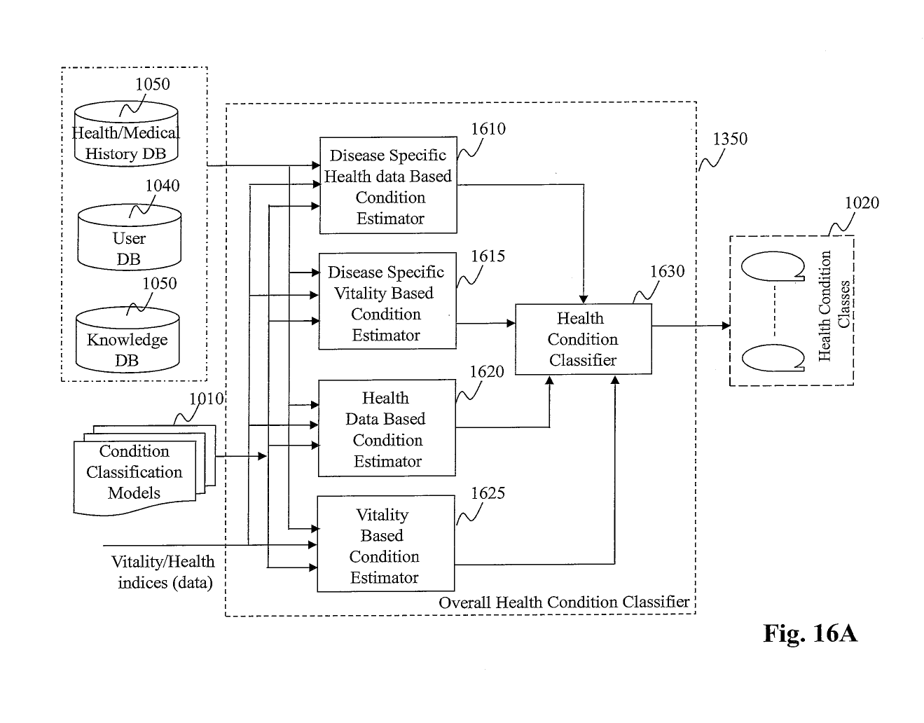

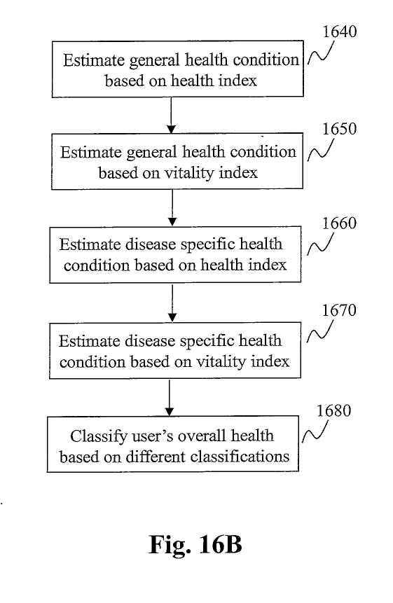

FIG. 16A depicts an exemplary system diagram of the overall health condition classifier 1350, according to an embodiment of the present teaching. The overall health condition classifier 1350 comprises various individual health condition estimators, including the health data based condition estimator 1620 (classify using health data) and the vitality based condition estimator 1625 (classify using vitality data) both of which operate based on classification models, as well as the disease specific health data based condition estimator 1610 (classify using health data) and the disease specific vitality based condition estimator 1615 (classify using vitality data) that operate based instead on specific diseases that the person may suffer from. Based on health condition classifications obtained in different perspectives, the health condition classifier 1630 may then integrate different classification results to derive the overall health condition classification. In some embodiments, only the overall classification from the health condition classifier 1630 is sent to the archive 1020. In some embodiments, the classifications in different perspectives from any of the estimators 1610, 1615, 1620, and 1625, may also be archived in 1020. Details related to these estimators as well as the health condition classifier 1630 are discussed below.

FIG. 16B is a flowchart of an exemplary process of the overall health condition classifier 1350, according to an embodiment of the present teaching. In operation, health condition is estimated, at 1640, using health data (e.g., health index) based on different classification models with respect to different health conditions. From the perspective of the vitality data, the health condition is also estimated, at 1650, based on classification models for different health conditions. As described above, classification models may be set up to reflect, e.g., the knowledge of the health care industry in terms of certain health conditions in relation to measured health data. Such models may be used in non-disease specific health condition classifications.

Health condition estimation assessed with respect to specific diseases may also be obtained. At 1660, health conditions with respect to one or more diseases may be estimated using health data based on, disease specific classification models. In addition, health conditions with respect to one or more diseases may also be estimated, at 1670, using vitality data based on disease specific classification models. The classifications of health conditions from different perspectives may then be archived for future use (not shown). Such classifications from different perspectives may also be combined or integrated to derive, at 1680, an overall health condition classification.

As mentioned above, health condition classification is performed based on models. There can be different types of models. FIG. 17 depicts exemplary types of health classification models 1010 that are used in model based health condition classification described herein, according to an embodiment of the present teaching. As shown, exemplary types of health condition classification models 1010 may include overall health classification models 1710 and disease condition classification models 1720. The overall health condition classification models 1710 may include generic health condition models 1730 and individualized health condition models 1740. The generic health condition models 1730 may be set up to reflect the general knowledge that is commonly known or widely adopted to assess a person's health condition. For example, there may be general standard thresholds in different medical indicators used by physicians to assess a person's health condition. While those standard thresholds are useful and indicative, for each person, due to specific surrounding facts and health history, the health condition of the person needs to be assessed in light of such individualized factors. This is what the individualized health condition classification models 1740 are setup for. Such individualized models maybe designed for taking into account of what a generic model does not cover or sensitive to the specific person's situation. For instance, if although a person is allergic to certain type of foods, a smaller amount of it will not make the person violently sick but will affect the function of major organs, the diet including ingredient of this type of foods may normally be okay according to a generic health condition classification model. In this case, an individualized health condition classification model may incorporate this and classify the health condition in a manner that considers the person's particular sensitivity to certain types of food intake and accordingly may classify this situation as an alert, rather than normal.

On the other hand, the disease condition classification models 1720 may be deployed to assess health condition of a person with respect to each disease that the person may suffer from, which is performed in consideration of possible interactions between or among different diseases. Thus, the disease condition classification models 1720 comprises one or more disease classification models 1760, each of which may be directed to a specific disease, as well as disease-disease interaction models 1750. A disease classification model for a specific disease is provided for classifying the disease specific health condition based on various vital sign related measurements from the real time health monitor 210. For example, if a person suffers from high blood pressure disease, then a disease model for high blood pressure disease is used to classify the person's health condition based on the blood pressure measurement from the person at the moment. The disease-disease interaction model 1750 is used to assess a person's health condition when there are multiple diseases at play and they may interfere with each other to make the condition worse. For example, for the person who suffers from high blood pressure disease, if the person also has heart disease, a slightly elevated blood pressure than normal may have a more significant impact on the person than to a person who does not have other diseases. The disease-disease interaction model 1750 may also be used as a part of the overall health condition classification models. In some situations, even though a person does not suffer from multiple diseases, e.g., having only high blood pressure, but a spontaneous occurrence of very high heart rate, detected by the real time health monitor 210, may have a significant impact on the person's health condition assessment at that moment.

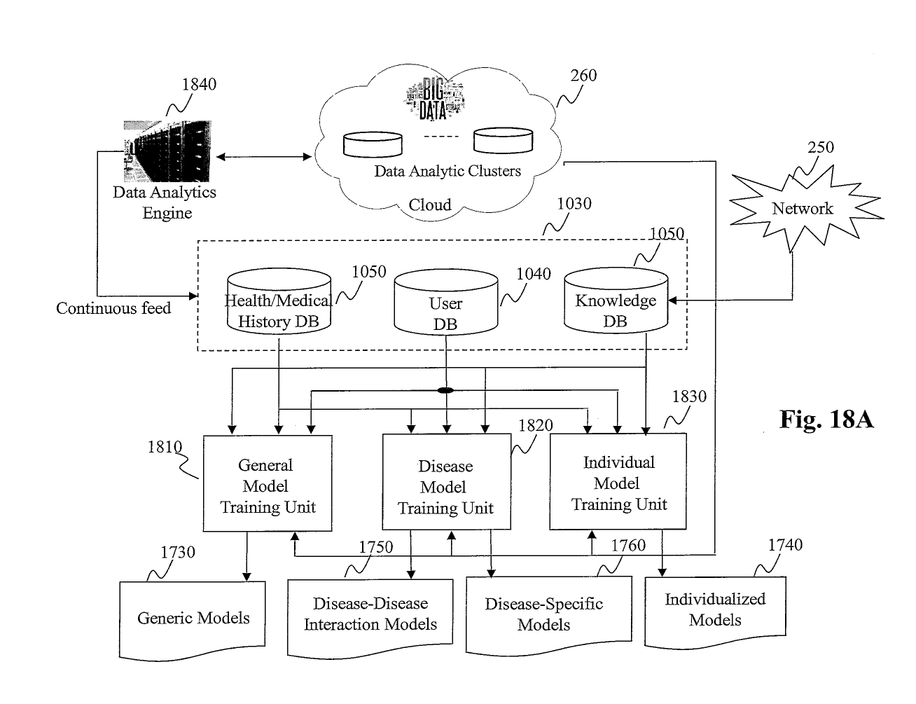

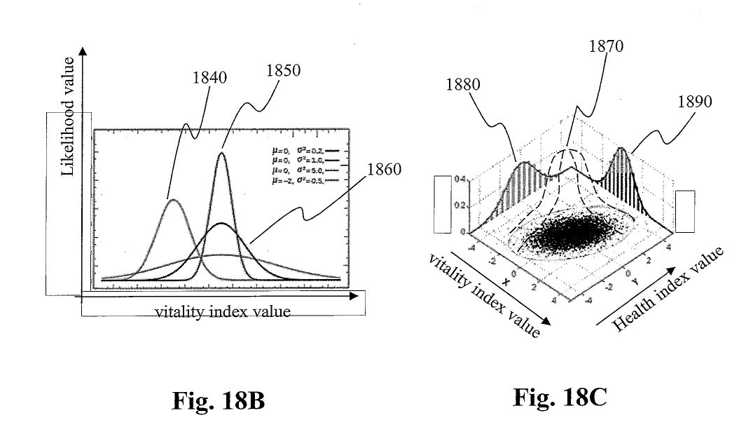

Different classification models may be initially set up based on, e.g., general knowledge, data from the cloud 260 characterizing the health information of a population, or personal medical history. The classification models may be dynamically updated or continually trained when any new information is made available. FIG. 18A depicts the exemplary system diagram of a mechanism for generating various classification models to be used for health condition classification, according to an embodiment of the present teaching. In some embodiments, there are various training units 1810, 1820, and 1830, each of which is responsible for generating certain models based on training data from different sources. The training may also be adjusted for some selected model types configured in the system and the training is for deriving the corresponding parameters for the selected model types.

Configured model types may include models used for classification based on different index values such as the vitality index VI or health index HI. In this case, the training is to use some large set of training data (e.g., from the cloud 260 or user's own health history information) to capture the relationship between different health conditions and the index used. For instance, as depicted in FIGS. 4B and 4C, different ranges of the vitality index values and health index values may correspond to different health conditions. The training performed by different training units in FIG. 18 is to learn from the actual data, e.g., where the points A, B, C, D in FIGS. 4B and E, F, and G in FIG. 4C. The data in the cloud 260 are from many people, they can be used in training in an anonymous way to avoid invasion of privacy.

FIG. 18B shows examples of models for classifying different health conditions, according to an embodiment of the present teaching. In this example, classification may be via a Gaussian function and each of the curves in this figure represents a classification model associated with a particular health condition with respect to, e.g., vitality index. For example, curve 1840 may be a classification model based on a Gaussian function (with its parameters centroid and variance) for, e.g., health condition “caution” and curve 1850 may be a classification model based on another Gaussian function (with different model parameters centroid and variance) representing the classification model for, e.g., health condition “attention.”

As can be seen, each model may be set up for classifying a particular health condition and each of the health conditions may have its own model. Model type for different health condition may be set the same or different, depending in application needs. When a particular model type, e.g., Gaussian model type, is used for different health conditions, the model for each health condition will have different model parameters to distinguish one from the other. For instance, as can be seen from FIG. 18B, a Gaussian model for health condition “attention” has a different centroid and variance than that of a model for health condition “caution,” where the centroid represents the average vitality index value for people who are in “attention” health condition and the variance of each Gaussian function represents how the vitality index values among people with this health condition vary. Such parameters for a model for a particular health condition are derived by training the parameters (e.g., the centroid and variance) of the model using appropriate data sets from different sources representing the population in the particular health condition.

In some embodiments as disclosed herein, for each individual, an individualized model for the person for each health condition may also be established to capture the unique difference between the person and the general population. In classifying a person health condition, such individualized personal health tendency usually may also need to be considered. In FIG. 18B, the Gaussian function 1860 may represent a person's classification function for health condition “attention” and it has the same centroid as that for the general population (i.e., the same centroid as curve 1850) but has a different spread of the curve, indicating that the range of vitality index values for health condition “attention” is wider with respect to this person.

Using the vitality index and/or health index for classification may be efficient in terms of both training and classification due to the low dimensionality. In some embodiments, classification models may be designed to use other types of monitored measurements from the real time health monitor 210. For instance, vital signs/health data (as opposed to vitality index or health index) may be used directly for classifying health conditions. This may be achieved by deploying models that operate in a higher dimensional space. For example, a Gaussian model in a high dimensional space may be used for classification, where each dimension corresponding to, e.g., one of the health data/vital signs. Such a model may also be characterized with corresponding parameters. For instance, in case of a Gaussian model, it can be characterized by parameters centroid and variance in different dimensions. FIG. 18C shows an example of a multi-dimensional Gaussian model that may be used for classifying health conditions, according to an embodiment of the present teaching. What is illustrated is a 2-dimensional Gaussian model where the X axis and Y axis represents two different monitored measurements, e.g., vitality index and health index, from the real time health monitor 210. Assuming that the model is for health condition “attention,” the two dimensional distribution 1870 represents the likelihood of the person's health is in the “attention” health condition. The curves 1880 and the curve 1890 represent, respectively, the distribution of the model 1870 projected with respect to vitality index axis and health index axis,

As discussed above, each health condition may have a separate model for its classification. Thus, generic models 1730 include models for “normal,” “attention,” “caution,” warning,” “emergency,” “healthy,” “sub-healthy,” and “not-healthy.” Each model captures the relationship between the underlying health condition and various health related information For example, for health condition “normal,” the model may exhibit a distribution over the health information space corresponding to “normal.” Similarly, individualized models for each wearable device's user may also include a set of models, each of which is for one of the health conditions. In addition, each model may be established with respect to particular type(s) of input data and is to be used for classification based on that particular type(s) of data. For instance, a set of models for classifying health conditions based on vitality index values differ from a set of models for classifying health conditions based on health index values.

For each health condition, with a selected model type (e.g., a model using vitality index and/or health index, or a Gaussian model), the general model training unit 1810 is configured to derive a model of the selected type via training using, e.g., a range of data from the cloud 260 and information from the knowledge database 1050, and obtain the parameters of the model. The training data from the cloud may comprise data that are relevant to the specific health condition. The training establishes a pattern via parameters over the population in order to capture the relationship between the training data and the specific health condition. In some embodiments, the general model training unit 1810 may also optionally utilize information from the user database 1040 and the health history database 1050 in training each of the generic models 1730. Such trained model parameters are then saved in the generic models 1730 as the trained model for that specific health condition.

For each health conditions, a different subset of the data from the cloud 260 may be used for training. For example, in training the parameters of a model for health condition “normal,” a sub-set of data (e.g., vitality index values and/or health index values) from the cloud 260 from those in the population who are considered normal may be used to train the parameters for the model for health condition “normal.” Similarly, to train parameters for a model for health condition “warning,” data from the cloud 260 related to those to whom warning were previously issued correctly are used for training. Such derived models are expected to reside in different parts of the feature space. For example, in FIG. 4B, a model for health condition “warning” may characterize the relationship between the vitality index value and the likelihood that the person is in the health condition “warning.” If a probabilistic model is used, when the vitality index value is approaching a value corresponding to point D, the probability of health condition “warning” will be very high. On the other hand, if the vitality index value is slightly below a point corresponding to C, the probability of health condition “warning” may be rather low but the probability of health condition “caution” likely will be very high according to a different model health condition “caution.”

Similarly, if a model in a multiple dimensional space is employed for a specific health condition, e.g., classifying based directly on vital signs or health data, the model characterizes the relationship between the multiple dimensional input (vital signs and health data) and the specific health condition. To train such a model, the vital signs/health data associated with those who had that specific health condition previously are used for training to derive the parameters of the multi-dimensional model. Once trained, when additional health input data (e.g., the vital signs/health data from a person) are plugged in the model and a classification with respect to that specific health condition, may be computed, e.g., a probability that this person, given the vital signs/health data, is in the specific health condition.

The individual model training unit 1830 in FIG. 18 may operate in a similar fashion but be responsible for training individualized models 1740 based on, e.g., data related to that individual person, including data related to the person archived in the cloud 260, information from the user database 1040, and the health history of the person in health database 1050. In some embodiments, the individual model training unit 1830 may also optionally use information from the knowledge database 1050. As discussed above, such training data related to the person is used to estimate the parameters of each selected model for a corresponding health condition. The derived models capture the relationship between the health information of the person and the likelihood/probability that the person is in each of the health conditions. As compared with the generic models, individualized models for each person may be similar to the generic models if the person's health situation falls within the profile of the general population. When the person's health situation deviates from the general population, e.g., sensitive to high blood pressure (i.e., slightly higher blood pressure can cause seizure), the individualized models for the person may have different parameters for certain health conditions. For instance, the centroid of the generic model for health condition “warning” may deviate from that of an individualized model for the same health condition, e.g., with respect to the dimension for “blood pressure.” It is when deviation exists between a generic model and an individualized model, the classification of health condition as disclosed herein will take into account of the individualized situation captured by an individualized model and adjusted the classification accordingly, rather than blindly relies on a generic model.

The disease model training unit 1820 operates in a similar manner but responsible for training models related to diseases, including disease-specific models 1760 and disease-disease interaction models 1750. The disease-specific models may include different models, each for a specific type of disease. As discussed herein, parameters of each model will be trained using an appropriate sub-set of the data from the cloud 260 and possible suitable data from other sources such as the knowledge database 1050. Similarly, to train the disease-disease interaction models 1750, there may be a model for each possible disease-disease interaction scenarios. For each such disease-disease possibility, the data used to train the parameters of the model corresponds to an appropriate sub-set of data from the cloud as well as information from the knowledge database 1050.

Models derived via training are then saved for future use. In some embodiments, when new data become available, whether in the cloud 260, in the knowledge database 1060, in the users' health history database 1050, the models may be dynamically updated, either via delta training (e.g., readjust the models based on only new data) or via re-training. In FIG. 18, it is also shown that the data in the cloud 260 may also be analyzed by a data analytics engine 1840, that can either be a part of the system disclosed herein or a third party service engine. The data analytics engine 1840 may perform big data analysis, mining the high volume data to identify relationships among different aspects of the data and characterizing such relationships either qualitatively or quantitatively. Results from the data analytics engine 1840 may be continuously fed to any of the databases, including the knowledge database 1060, the user database 1040, the health history database 1050, or even the cloud 260.

In some embodiments, the training of the classification models may be performed in the backend, which may then transmit the trained models to each real time health monitor 210. Some of the model training may be localized on each wearable device. For example, for individualized classification models, as the training may rely on data of the person who uses the wearable device so that it can be performed on the wearable device without involving the networked data.

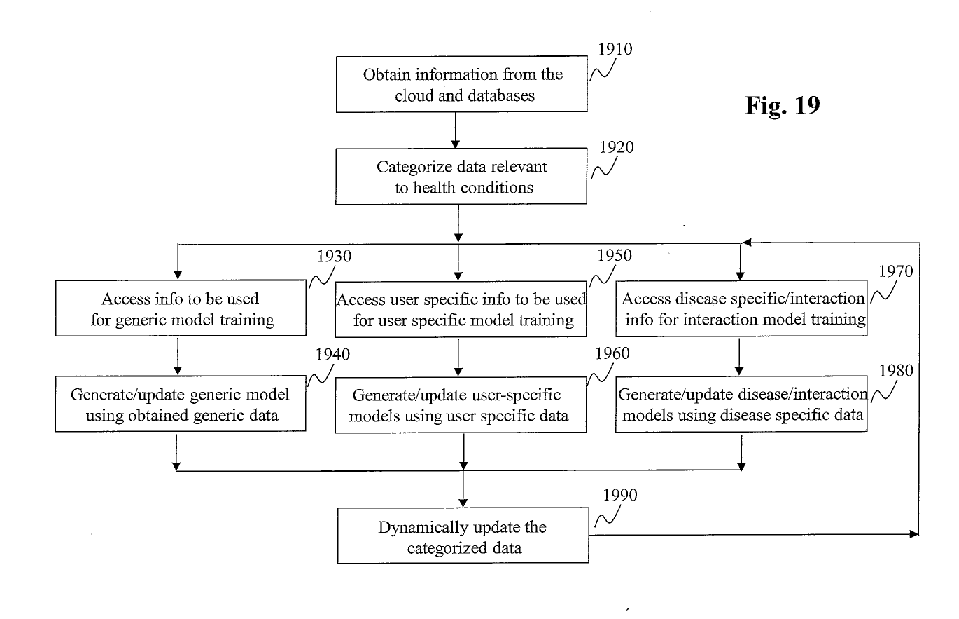

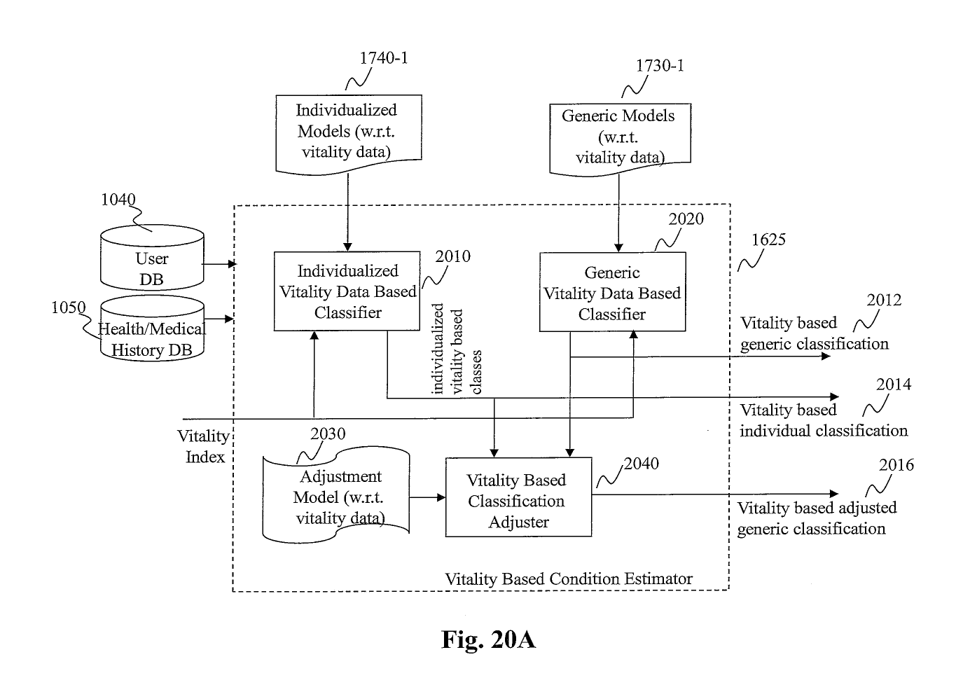

FIG. 19 is a flowchart of an exemplary process for obtaining different health condition classification models, according to an embodiment of the present teaching. Information from different sources (e.g., the cloud 260 and various databases) are obtained at 1910. The obtained data are categorized, at 1920, into different sub-sets, each of which may be used to train one or more specific health condition classification models. As discussed above, e.g., to train a classification model for health condition “warning,” a sub-set of data related to a classification of “warning” may include health information of those who have been classified to have a “warning” health condition.

At 1930, sub-sets of data appropriate for training generic models with respect to different health conditions are accessed and used for training parameters of generic classification models with respect to different health conditions, which generates, at 1940, new or updated generic classification models for various health conditions. Similarly, at 1950, sub-sets of data appropriate for training parameters of individualized classification models are accessed and used for training the parameters of such individualized classification models with respect to different individuals to generate, at 1960, new or updated individual classification models for different health conditions. With respect to disease related classification models, including both disease-specific and disease-disease interaction models, sub-sets of data associated with different diseases are accessed, at 1970, and used to train parameters of disease-specific classification models with respect to different health conditions, which yields disease related classification models.

The data may dynamically grow and when they grow, the classification models need to be re-trained and updated. At 1990, with the change of data from different sources, categorized sub-sets of data are updated according to the dynamics of the data gathered. Once the sub-sets of data are updated, the processing continues to steps 1930, 1950, and 1970 that use such updated sub-sets of data to re-train or delta-train the corresponding classification models with respect to different health conditions. Such dynamically adapted classification models can be then used in health condition estimation/classification.

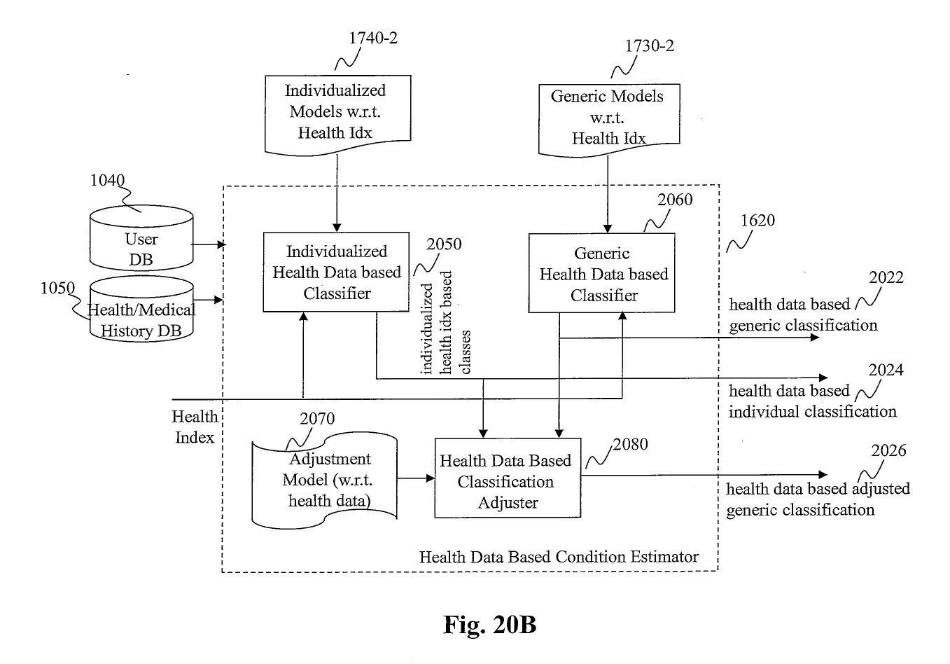

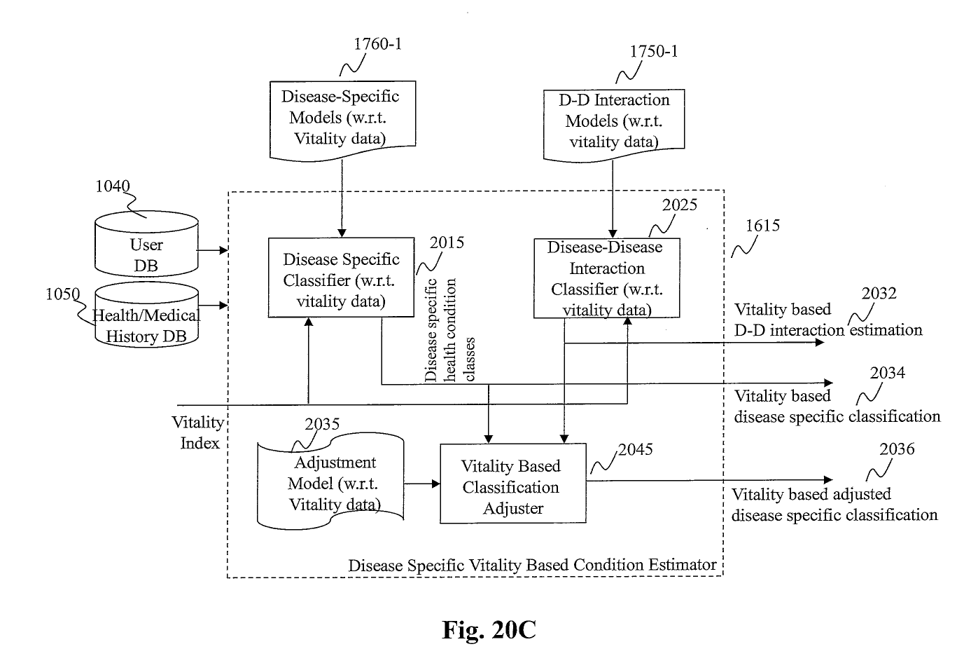

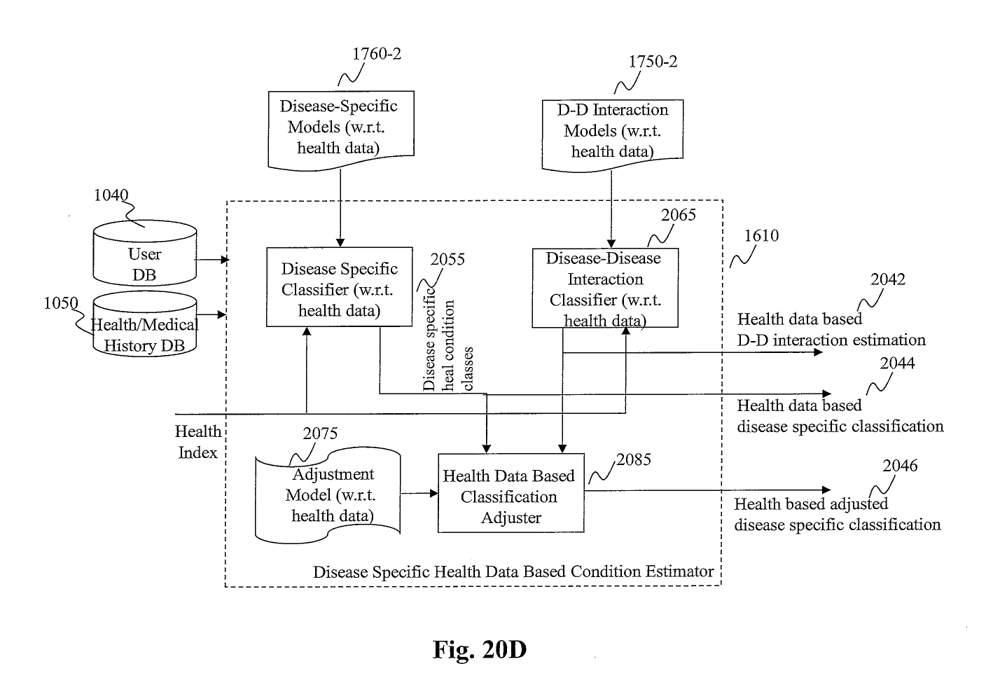

FIG. 20A depicts an exemplary system diagram of the vitality index based condition estimator 1625 that uses a model based approach to classify health conditions based on vitality data, according to an embodiment of the present teaching. The vitality based condition estimator 1625 comprises a generic vitality index based classifier 2020, an individualized vitality index based classifier 2010, and a vitality based classification adjuster 2040. In operation, the generic vitality index based classifier 2020 takes vitality index as an input and classifies health conditions of a person based on the generic models 1730-1 (that are trained with respect to general population) to generate vitality based generic classifications 2012. In some embodiments, such generic models which may be derived with respect to the data of the general population. In this regard, such models may reflect the average scenario of the general population.

To take into account individualized health situations, the individualized vitality index based classifiers 2010 takes also vitality index as an input and classifies health conditions of the same person based on the individualized models 1740-1, established with respect the person's own health information/history. This yields vitality based individualized classifications 2014.

Both generic and individualized vitality based classes (2012 and 2014) may be sent to the health condition classifier 1630 (FIG. 16A) for be further used (e.g., either further processed or reported as such) separately. They may also be sent to the vitality based classification adjuster 2040, which derives vitality based adjusted classification 2016 by considering both the generic and individualized classification (2012 and 2014) of a person's health condition, obtained based on his/her vitality data. The vitality based classification adjuster 2040 is configured to obtain an adjusted health condition classification 2016 based on the classifications obtained from the general population and from the individualized perspectives (2012 and 2014). The adjustment may be done based on some pre-determined adjustment model 2030, that is, e.g., specific to vitality based classification results and the adjusted classification is then sent to the health condition classifier 1630 for further processing.

With respect to the adjustment to a classification, different models may be deployed that are appropriate for the application. For example, an average weighted sum may be the pre-determined model that allows taking into account both generic and individualized classification results via weights assigned to the respective results. Other models may also be used, e.g., choosing one of the generic and individualized classifications in a conservative way. That is, the integrated classification may be the more serious classification to ensure safety of the person. A statistical model may also be used in which each of the generic and individualized classifications may be associated with a confidence score or a probability of being in that health condition given the vitality index. Then the adjuster 2040 may take the two probabilities and generate a joint probability to be applied to the more conservative classification. For example, if using the generic model 1730-1, the generic classification is “attention” with a probability of 0.73. But using the individualized model 1740-1, the individualized classification is “caution” with a probability of 0.69. In this case, the adjuster may compute a joint probability based on 0.69 and 0.73 (say, 0.723) and apply that to the more conservative classification of “caution.”

FIG. 20B depicts an exemplary system diagram of the health index based condition estimator 1620 that uses a model based approach to classify health condition based on health data, according to an embodiment of the present teaching. Using the health index data (e.g., HI), the health data based condition estimator 1620 classifies the person health condition into one of a plurality classes. In some embodiments, there are three health condition classes, namely healthy, sub-healthy, and not-healthy, as described in FIG. 5. Estimated health data based classes are then sent to the health condition classifier 1630 for integration in order to estimate the overall health condition.

In some embodiments, the health index based condition estimator 1620 structures similarly as that of the vitality based condition estimator 1625 and comprises a generic health index based classifier 2060, an individualized heath index based classifier 2050, and a health index based classification adjuster 2080. In operation, the health based condition estimator 1620 may also function in a similar fashion as that of the vitality based condition estimator 1625 except that the input data (health index in this case) and the classification models used in classification (generic models with respect to health index 1730-2 and individualized models with respect to health index) are different (these models are trained and thus tuned with respect to health index values). Based on the health data (index) input, the generic health index based classifier 2060 obtains a health data based classification in accordance with the generic models 1730-2 and yields health data based generic classification 2022. The individualized health index based classifier 2050 generates, based on the individualized models 1740-2, the health data based health condition classification 2024. The generic and individualized health index based classifications may then be sent either to the health condition classifier 1630 directly for further consideration (report or further processing) or to the health index based classification adjuster 2080 to generate an adjusted classification 2026 in consideration of both health data based generic and individualized health condition classifications 2022 and 2024. The adjustment may be made in accordance with the adjustment models 2070 configured with respect to health index. The adjusted classification is then sent to the health condition classifier 1630 for further processing.

FIG. 20C depicts an exemplary system diagram of the disease specific vitality based condition estimator 1615, according to an embodiment of the present teaching. The disease specific classifiers are for estimating the health condition of a person with respect to each disease based on specific classification models trained particularly for that disease as well as the estimation of health condition in considering the possible interactions among different diseases. As illustrated, the disease specific vitality based condition estimator 1615 comprises a disease specific classifier 2015, a disease-disease interaction classifier 2025, and a vitality based classification adjuster 2045. The disease specific vitality based condition classifier 2015 is for estimating the health condition with respect to each disease and generates vitality based disease specific classification 2034. For example, if a person suffers from type II diabetes, based on monitored vitality measurements, e.g., vitality index, the health condition with respect to the person's diabetes may be estimated in accordance with a model for type II diabetes trained specifically using vitality data. The estimated condition with respect to each of the diseases that a person suffers from is sent either to the health condition classifier 1630 for further consideration (report or further processing) or to the vitality based classification adjuster 2045 for adjusting the classification based on potential disease-disease interactions.

Often different diseases may interfere with each other so that isolated classification based on only vitality measures related to a disease may lead to under estimated health condition assessment. For example, if a person suffers from both type II diabetes and high blood pressure, in some situations, although the vitality data, when examined in isolation against each disease, may not cause an alarm, the interplay of multiple underlying diseases may increase the seriousness of the health condition a person may be under. The disease-disease interaction estimator 2025 estimates, based on the disease-disease interaction models 1750-1 (trained using vitality data) and information about the person (e.g., health history with current diagnosis) from databases (e.g., 1040 and/or 1050), potential disease to disease interactions 2032 between or among different diseases. The estimated disease to disease interactions 2032 may be sent either directly to the health condition classifier 1630 (e.g., for reporting purposes or for further processing) or to the vitality based classification adjuster 2045 to adjust the health condition classification for each disease.

The vitality based classification adjuster 2045 takes into account both estimated disease-specific health condition classification 2034 (from 2015) and the potential interactions between/among different diseases 2032 (from 2025) and adjusts, based on some pre-configured adjustment models from 2035, the estimated health condition for each disease to generate an adjusted disease specific vitality data based classification 2036, which is sent to the health condition classifier 1630 for further processing.

FIG. 20D depicts an exemplary system diagram of the disease specific health data based condition estimator 1610, according to an embodiment of the present teaching. In this embodiment, the disease specific health data based condition estimator 1610 is configured to operate in a similar manner as that for the disease specific vitality based condition estimator 1615, except that the input used for the classification is health data (e.g., health index HI) rather than vitality data and the models invoked are trained specifically using health data (rather than vitality data). In operation, the disease specific health data based classifier 2055 is for estimating the health condition, in accordance with disease specific models 1760-2 (trained using health data) with respect to each disease based on monitored health data and generates health data based disease specific classification 2044, which is then sent either to the health condition classifier 1630 directly for further consideration (report or further processing) or to the vitality based classification adjuster 2085 for adjusting the classification based on potential disease-disease interactions.

The disease-disease interaction estimator 2065 estimates, based on the disease-disease interaction models 1750-2 (trained using health data) and information about the person (e.g., health history with current diagnosis) from databases (e.g., 1040 and/or 1050), potential disease to disease interactions 2042 between or among different diseases. The estimated disease to disease interactions 2042 may be sent either directly to the health condition classifier 1630 (e.g., for reporting purposes or for further processing) or to the vitality based classification adjuster 2085 to adjust the health condition classification for each disease.

The health data based classification adjuster 2085 takes into account both estimated disease-specific health condition classification based on health data 2044 (from 2055) and the potential interactions between/among different diseases 2042 (from 2025) and adjusts, based on some pre-configured adjustment models from 2075, the estimated health condition for each disease to generate an adjusted disease specific vitality data based classification 2046, which is sent to the health condition classifier 1630 for further processing.

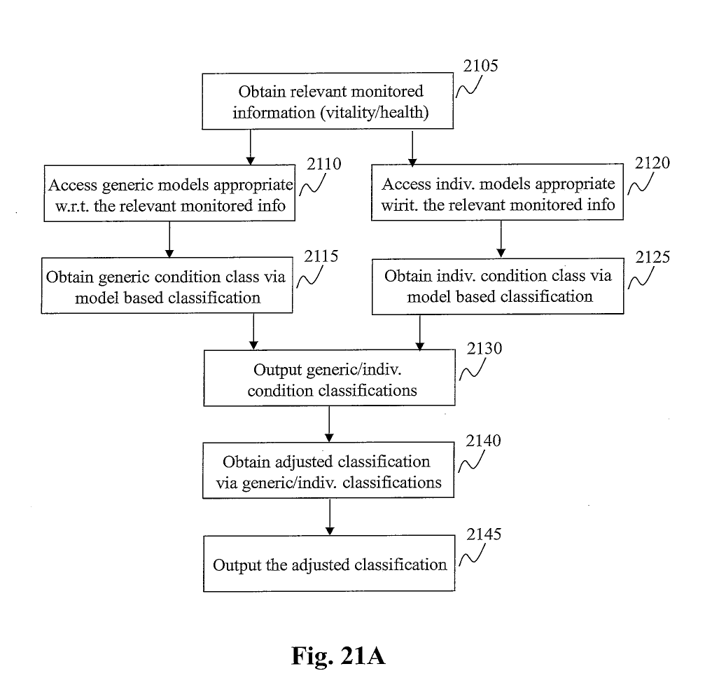

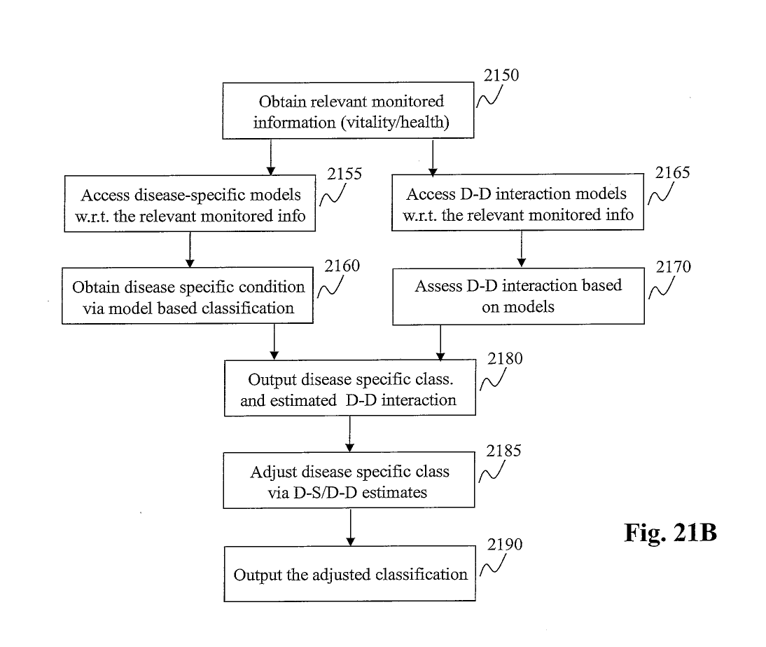

FIG. 21A is a flowchart of an exemplary process for the health data/vitality based condition estimators 1620 and 1625, according to an exemplary embodiment of the present teaching. The flows for these two estimators are similar except the input data and the corresponding classification models (trained based on the data that is to be classified) used. At 2105, relevant input is first obtained. For the health data based condition estimator 1620, what is obtained is the health data such as health index which will be the basis for the health condition classification. For the vitality based condition estimator 1625, what is obtained as the basis for classification is vitality data such vitality index. Based on the retrieved relevant data, the processing is along two parallel tracks. The first track is to estimate based on generic health condition classification models. The second track is for estimation based on individualized health condition classification models.

Along the first track, generic models trained using the relevant data (vitality data for vitality based condition estimator 1625 and health data for health data based condition estimator 1620) are accessed at 2110. Such accessed generic models are used to obtain, at 2115, the generic health condition classification via model based approach. Along the second track, individualized models trained using the relevant data (vitality data for vitality based condition estimator 1625 and health data for health data based condition estimator 1620) are accessed at 2120. Such accessed individualized models are used to obtain, at 2125, the individualized health condition classification via model based approach.

The estimated generic and individualized health condition classes are output at 2130, to the health condition classifier 1630 for further processing and to the classification adjuster (the vitality based classification adjuster 2040 for vitality based condition estimator 1625 or health data based classification adjuster 2080 for health data based condition estimator 1620). When the adjuster (2040 or 2080) receives the generic and individualized health condition classifications, it obtains, at 2135, the adjusted health condition classification by taking into account both generic situation (baseline) and individualized situation. The adjusted health classification is then sent, at 2140, to the health condition classifier 1630.

FIG. 21B is a flowchart for an exemplary process for the disease specific health data/vitality based condition estimators 1610 and 1615, according to an exemplary embodiment of the present teaching. Similar to the above discussion, the flows for these two estimators are similar except the input data and the corresponding classification models (trained based on the data that is to be classified) used. At 2150, relevant input is first obtained. For the disease specific health data based condition estimator 1610, what is obtained is the health data such as health index that is to be used as the basis for the health condition classification. For the disease specific vitality based condition estimator 1615, what is obtained as the basis for classification is vitality data such vitality index. Based on the retrieved relevant data, the processing is along two parallel tracks. The first track is to estimate based on disease specific condition classification models. The second track is for estimation of disease-disease interactions based on disease-disease interaction models.

Along the first track, disease specific classification models trained using the relevant data (vitality data for disease specific vitality based condition estimator 1615 and health data for disease specific health data based condition estimator 1610) are accessed at 2155. Such accessed disease related models are used to obtain, at 2160, the disease specific health condition classification. Along the second track, disease-disease interaction models trained using the relevant data (vitality data for disease specific vitality based condition estimator 1615 and health data for disease specific health data based condition estimator 1610) are accessed at 2165. The accessed models are for interactions involving the disease that the person suffers from, which may characterize with which other diseases this particular disease may interact with and in what manner. Such accessed disease-disease interaction models are used to obtain, at 2170, the disease-disease interactions are estimated.

The estimated disease specific health classification(s) as well as the estimated disease-disease interactions are output at 2180, to the health condition classifier 1630 for further processing and to the classification adjuster (the vitality based classification adjuster 2045 for vitality based condition estimator 1615 or health data based classification adjuster 2085 for health data based condition estimator 1610). When the adjuster (2045 or 2085) receives the disease specific health condition classification and estimated disease-disease interactions, it obtains, at 2185, the adjusted disease specific health condition classification by taking into account the estimated disease-disease interactions. The adjusted health classification is then sent, at 2190, to the health condition classifier 1630.

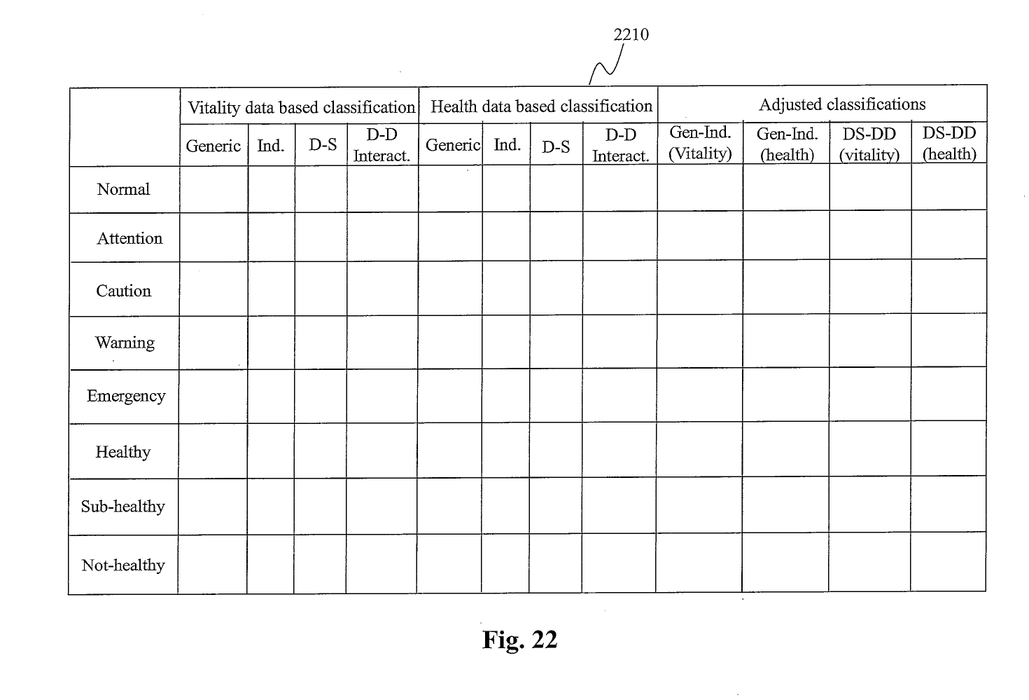

FIG. 22 illustrates exemplary types of data that are input to the health condition classifier 1630 as the basis for the classification, according to an embodiment of the present teaching. As can be seen, the estimators 1610, 1615, 1620, and 1625 in FIG. 16A generate such input data 2210 with respect to (1) general health condition assessment, both against the baseline model derived from the general population and against the individualized models, classified based on vitality data and the health data, as well as (2) disease specific health condition classification with respect to each disease that the person monitored by the real time health monitor 210 may suffer from, whether considering disease-disease interaction or not.

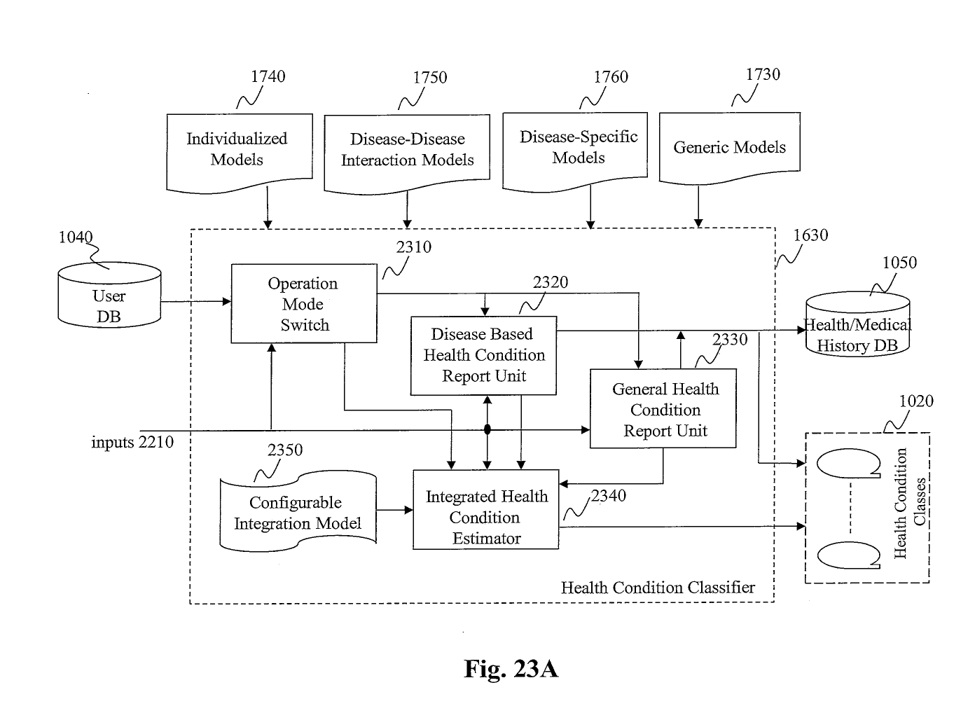

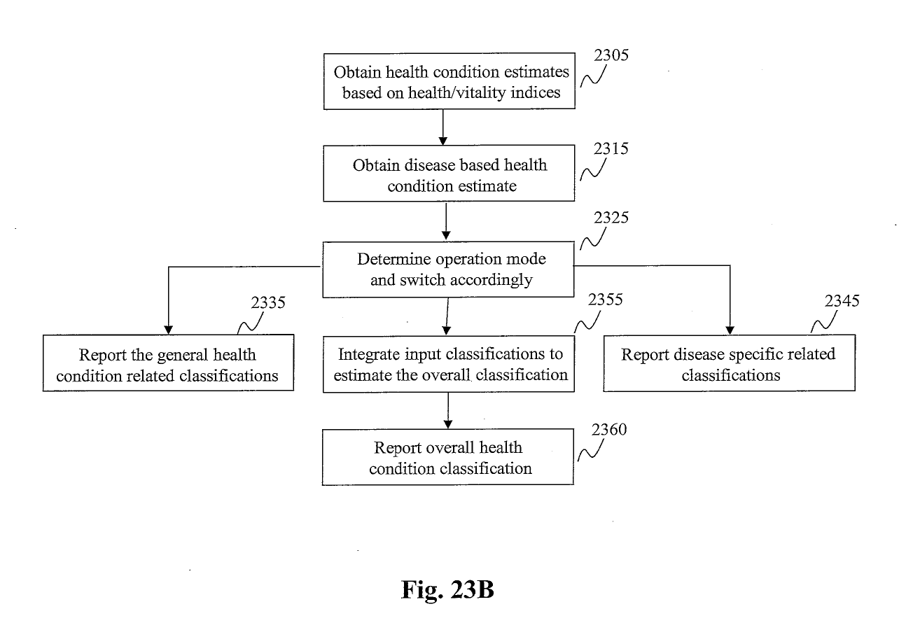

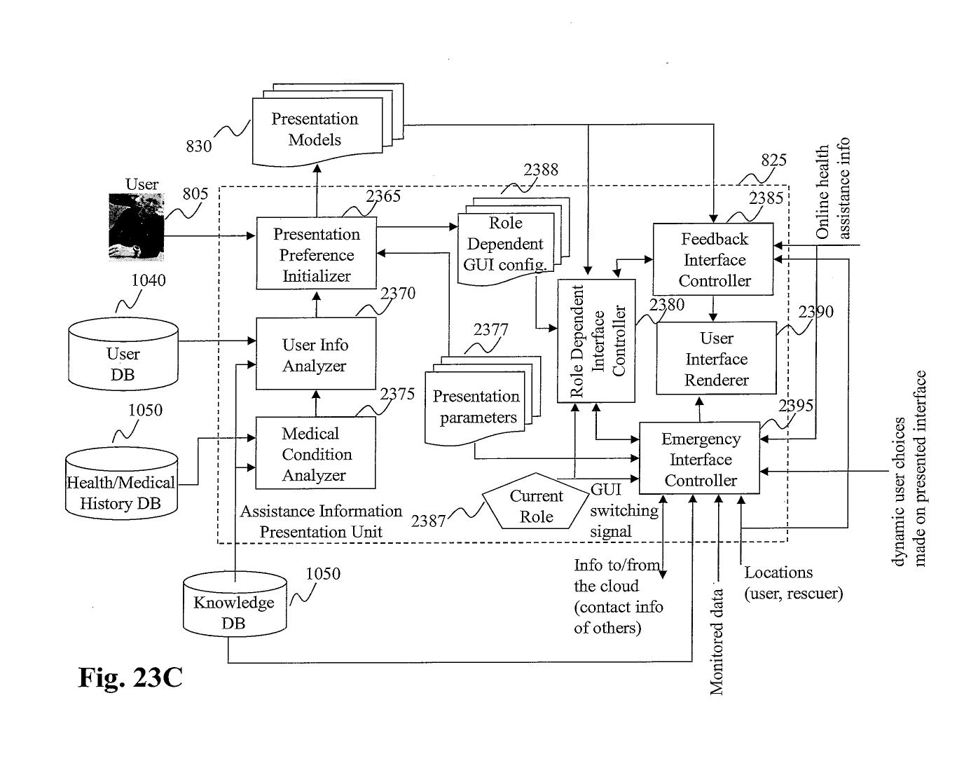

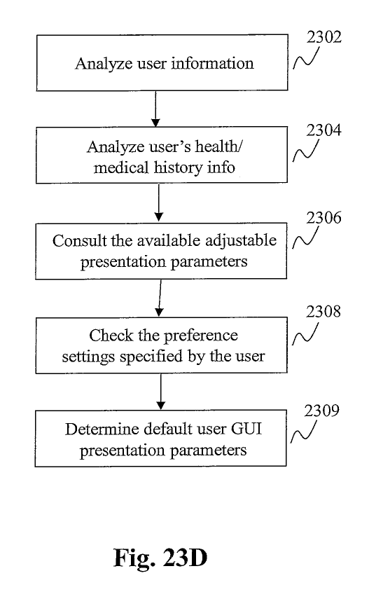

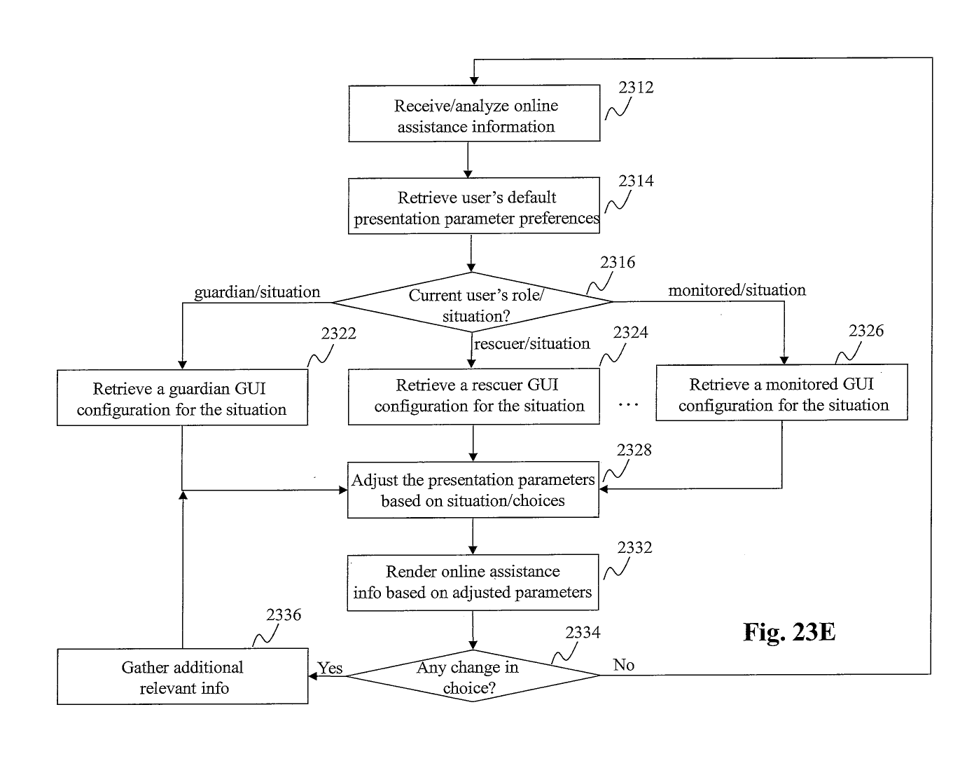

FIG. 23A depicts an exemplary system diagram of the health condition classifier 1630, according to an embodiment of the present teaching. The health condition classifier 1630 comprises an operation mode switch 2310, a disease specific health condition report unit 2320, a generic health condition report unit 2330, and an integrated health condition estimator 2340. The operation mode switch 2310 is to control the operational mode of the health condition classifier 1630 based on different types of information. The disease specific health condition report unit 2320 is to transmit disease specific health condition classifications (including disease-disease interactions as estimated), according to a mode of operation determined by the operation model switch 2310, to the cloud 260, to any other third party, or simply stored on the real time health monitor 210. Similarly, the generalized health condition report unit 2330 is to transmit general health condition classifications (including assessed using individualized models), according to a mode of operation determined by the operation model switch 2310, to the cloud 260, to any other third party, or simply stored on the real time health monitor 210. The integrated health condition estimator 2340 is to combine all data contained in input 2210 to come up with an overall assessment of the health condition of the person. Such an overall assessed health condition is also transmitted according to a mode of operation determined by the operation model switch 2310, to the cloud 260, to any other third party, or simply stored on the real time health monitor 210.

The health condition classifier 1630 takes 2210 (estimated health classifications in different scenarios as shown in FIG. 22) as input and proceed with the processing based, at least in part, on the configuration determined by the operation model switch 2310. The configuration may be static, pre-determined, or adaptively determined based on the current health condition the person is under according to the estimation. In some embodiments, the operation mode switch 2310 may switch to different operation modes based on a pre-determined configuration. For example, in the user database 1040, there may be some pre-set configurations, with respect to the person being monitored by the real time health monitor 210, as to how to process each type of data. The configuration may be specified by the person being monitored by the real time health monitor 210 or by a service engine to which the person signs up for receiving health related services. For instance, the person or service may set for the real time health monitor 210 to transmit certain types of classifications to the cloud 260 and store the remaining ones on the real time health monitor 210. In some embodiments, a pre-determined configuration may require that all data from the real time health monitor 210 be transmitted to the cloud 260, etc.

The configuration may indicate certain classifications are to be output to the cloud 260 and others may be stored on the real time health monitor 210. For instance, the configuration may be set to report all health condition classifications, whether estimated using different models, adjusted as disclosed above, or integrated as disclosed below. The configuration may also indicate, in an alternative, to report separate health condition classifications obtained using different models as well as adjusted health condition classifications (adjusted according to both generic v. individualized and disease specific classification v. disease specific classification in consideration of disease-disease interactions), or report only the adjusted and the integrated health condition classifications.

In some embodiments, the operation mode switch 2310 may adaptively determine a configuration based on the health condition classification received in input 2210. For example, the operation mode switch may analyze the input 2210 and if there is any estimated health condition present in input 2210 that is more serious than certain condition, the operation mode switch 2310 may be configured to require that all data in the input 2210 be transmitted to the cloud 260 or some health related service (described below). In some embodiments, e.g., when a person is detected in an emergent situation, e.g., any of the health classifications being linked to an emergency situation, the operation mode switch 2310 may adaptively set to require reporting all the health condition estimations so that the details related to this emergent situation can be archived properly. On the other hand, if the person is in a rather good health condition, the configuration may be adapted to require a recording of the classifications each time on the wearable device but to the cloud 260 only once each month or vice versa.

The integrated health condition estimator 2340 is to estimate the overall health condition of the person based on input data 2210 as illustrated in FIG. 22. Such estimation may be performed based on some models in 2350 or other means. For example, the various health condition classifications in input 2210 may be combined in a weighted form to reach an overall estimate. Alternatively, the health condition classifications of input 2210 may be achieved via a probabilistic approach using a model from 2350. In this case, various health conditions represented by input 2210 may be treated as a health feature vector with attributes therein corresponding to classifications from different perspectives, representing a point in a high dimensional space. A model in the same high dimensional space may be obtained by training parameters of the model using training features vectors corresponding to the general population. Such trained model in 2350 can then be used to classify the input 2210 into one of multiple health conditions. The estimated overall health condition is sent transmitted out from the real time health monitor 210 to wherever instructed by the operation mode switch 2310.

FIG. 23B is a flowchart of an exemplary process for the health condition classifier 1630, according to an embodiment of the present teaching. At 2305, health condition classifications based on vitality/health data are obtained. This includes both the estimated health condition classifications as well as their corresponding adjusted classifications based on individualized model based estimates. At 2315, disease specific health condition classifications and disease-disease interaction estimations are obtained. This includes both disease specific health condition classifications/interactions and the adjusted disease specific classification considering the disease-disease interactions. At 2325, the operation mode switch 2310 determines the operation mode based on the configuration, either pre-determined or adaptively and dynamically determined based on the person's health condition classifications and activate different connected modules accordingly with instructions on how to proceed.

The general condition report unit 2330 reports, at 2335, all classifications related to the general estimation, including the generic/individualized health classifications and the adjusted general classification by incorporating the individualized classifications. The disease specific classification report unit 2320 reports, at 2345, all classifications related to disease specific health conditions, including the disease specific classifications and disease-disease interactions as well as adjusted disease specific health condition classification according to the estimated disease-disease interactions.

The integrated health condition estimator 2340, upon being activated, integrates all input classifications, at 2355, to obtain an overall health condition classification, which is then reported to the cloud 260 at 2360.

FIG. 23C depicts an exemplary system diagram of the assistance information presentation unit 825 of the real time health monitor 210, according to an embodiment of the present teaching. As discussed above, the real time health monitor 210 may have different types of users such as a user whose health is to be monitored, a user who is a guardian of a user being monitored, a rescuer who plays a role to rescue another user whose health is in an emergency situation, a physician or other health care professionals who may be connected to a user via the real time health monitor to provide health related consultations, etc. On the other hand, each user of the real time health monitor 210 may play any of these role, each may be at a different time. For example, a user who uses the real time health monitor 210 to monitor his/her health may also be a guardian, a rescuer, or a physician. At each moment, a user mostly likely is associated with a specific role. In some situations, a user may simultaneously play more than one role, e.g., being a guardian and a physician.

As discussed herein, depending on the role of a user, the real time health monitor 210 may present different user interface in order to deliver assistance information suitable for the role of the user. The assistance information presentation unit 825 (see FIG. 8A) is configured to achieve that. In some embodiments, each user may be associated with a default role. For example, users who deploy the real time health monitor 210 may be considered, as a default, to be one whose health is to be monitored. If a user also volunteers to be a rescuer, then the user may potentially have a different role to play. The interface to be used for each user not only depends on the role the user is playing at the moment but also the particular situation the user is in.

In determining the default setting to present the health assistance information, the assistance information presentation unit 825 may be configured to individualize the presentation style based on specific conditions or information of the user. For example, if a user is an elderly, the font size employed to present information may be set sufficiently large. If a user is blind, the presentation style may be set to be audio only. Such style setting may persist in different situations but may also be modified when the situations call for such. For example, if a default setting of presentation style for a user is certain font size, when the person is in an emergent situation, in order to more effectively deliver the physician's instruction to the user (e.g., to take some emergency medication), the assistance information may be presented in audio form to avoid the situation that the person cannot read in the particular situation.

In the exemplary embodiment presented in FIG. 23C, the assistance information presentation unit 825 comprises a user information analyzer 2370, a medical condition analyzer 2375, a presentation preference initializer 2365, a feedback interface controller 2385, an emergency interface controller 2395, a role dependent interface controller 2380, and a user interface renderer 2390. In order to automatically derive a default presentation style, the user information and the user's medical related information are analyzed by the user information analyzer 2370 and the medical information analyzer 2375, respectively. Such analyzed results are sent to the presentation preference initializer 2365 and used as the basis for automatically set the default presentation style based on the personal (age) or medical (blind or poor eye sight) situation of the user. The setting for the presentation style may be based on a plurality of presentation parameters, stored in 2377, that can be modified as needed. The presentation preference initializer 2365 may also receive from the user, as shown in FIG. 23C, the presentation preference parameters. The user specified preference may take higher priority. Such generated default presentation preferences may then be stored in the presentation models 830 and will be used in controlling the presentation to the user.

The presentation models 830 may also include different interface configurations to be used in different situations. For instance, the interface settings in emergency or rescue situations for different roles may be stored therein and can be invoked at the time of the presentation based on the actually situation encountered. Such stored presentation models, including the interface configurations and the presentation parameter preferences, may be retrieved by various components at the time of presenting online health assistance information to the user. For instance, in normal situations, when the real time health monitor 210 receives the online health assistance information 240 from the cloud 260, it accesses the configured presentation model and presentation parameter preferences from 830 and uses the individualized setting in presenting the information to the user by sending such default setting parameters to the user interface renderer 2390.

The assistance information presentation unit 825 also includes a current role switch 2387. Depending on, e.g., the actions of the user taken in the context of the real time health monitor 210, the current role switch 2387 may be automatically set. For example, if the user presses the emergency button 215, the user is in a role of a person being monitored. If the user responds to an SOS call, the user is in a role as a rescuer. If the user is called by another user when the other user elects to call a physician, the role of the user is a physician. Such dynamically set role of the user may be used to select a presentation interface from the presentation models 830. In rendering an interface, the selected role dependent interface is combined with the presentation parameter preferences, also retrieved from the presentation models 830, to present assistance information to the user.

The feedback interface controller 2385 may be configured to present health assistance information in normal health situations. For example, in normal situations, a user may receive information related to his/her role in connection with the real time health monitor 210. For example, for a user whose health is being monitored using the real time health monitor 210, when the user is in a healthy condition, routine health information may be delivered to the user on, e.g., how to live a healthy life style in terms of, e.g., diet, exercise, food knowledge, etc. Such assistance information may be presented to the user by using the individualized default presentation parameter preference retrieved from the presentation models 830. When the real time health monitor 210 receives health assistance information in response to a detected “caution” health condition, which may include a recommended visit to a medical specialist with the contact information of the specialist, the feedback interface controller 2385 may retrieve information from the presentation models 830 about an interface configuration or template directed to assistance information in case of a “caution” health condition and then invokes the user interface renderer 2390 to present the received health assistance information in accordance with the retrieved template using the default presentation parameter preferences (also retrieved from the presentation models 830).

When a user's role is not a person whose health is being monitored, e.g., a user signs up with the real time health monitor 210 as a rescuer, the feedback information that the user may receive may include, but not limited to, a call for rescue with information related to the emergency such as location of the emergency, requirements for the rescuer, a map to the rescue site, etc. Such information is provided to the user to enable the user to decide whether he/she should respond to the call for help. As discussed above, the role of each user may differ and different users in different roles may be presented with different information in different presentation configurations. For example, in the normal role, the user may be a person whose health is to be monitored but sometimes, the role of the user may be a rescuer. To appropriately present the received health assistance information, the feedback interface controller 2385 accesses the information stored in the “current role” archive 2387, which specifies the current role of the user and use that to determine the current presentation style.

In addition, a presentation configuration may also differ with the situation the user is in. For instance, a rescuer user may receive different types of health assistance information in different situations, e.g., one situation may be related to a rescue call and a different situation may be related to the rescue itself. In the former situation, the interface deployed is for channeling an incoming rescue call to the user with certain information related to the person to be rescued and providing the means on the interface for the rescuer user to respond. In the latter situation, the interface deployed is for connecting different parties involved in the rescue and providing information to enable the rescuer user to quickly get to the site and rescue effectively. Because the purposes of such different interfaces differ, their configurations will be different as well, which includes, but not limited to, how the interfaces are structured and each part of the interfaces should have what types of information being presented to the user.

To use appropriate interfaces for different type of user and in different situations, the feedback interface controller 2385 may analyze the received health assistance information to ascertain the situation, e.g., the information received is related to an incoming call for rescue, to obtain the situation related parameter in determining an appropriate interface configuration. To ascertain the role of the user in this situation, the feedback interface controller 2385 may invoke the role dependent interface controller 2380 with the situation parameter indicating, e.g., the received helth assistance information is related to an incoming call for rescue. Based on the parameter related to the situation, the role dependent interface controller 2380 may set the information stored in the 2387 as related to the role of the user as a rescuer, based on which the role dependent interface controller 2380 also retrieves, from a role dependent GUI configuration 2388, a role dependent GUI configuration that is appropriate for both the current role of the user as well as for the specific current situation.

The retrieved role dependent GUI configuration for the situation may include an interface template and a specification as to how the template is structured and each part of the structure is to be filled with what type of information. For example, if the situation is related to an incoming rescue call, the interface may comprise an area indicating the source of the call (the person who needs to be rescued), location, and a brief indication of the requirements to the rescuer. There may be another area on this interface that will allow the user to respond to the call (either accept or decline). If the situation is related to the process to get to the rescue scene after accepting the call for rescue, the interface may be structured differently, e.g., an interface with an area to display a map with marked the positions of the person to be rescued and the rescuer and the route suggested to get to the person to be rescued. If the situation is related to the inter-communications among different parties during the rescue, the interface again may differ with enabling means to allow the rescuer user to monitor the health status of the person to be rescued as well as online guidance on traffic situation along the route, and the easy means to call different parties (e.g., see FIG. 9N).

Upon receiving role dependent interface configuration information and the default presentation parameter preferences, the feedback interface controller 2385 invokes the user interface renderer 2390 to present the received feedback information in accordance with the role dependent interface configuration and the default presentation parameter preferences. In some situations, e.g., in an emergency situation, the presentation preferences used in presenting the health assistance information may need to be dynamically adjusted, sometimes overriding the default presentation preferences. Such a determination may be made based on various considerations. For example, if the person to be rescued is so incapacitated, it renders unnecessary to display any text or even audio to the person.

The emergency interface controller 2395 may function partially in a similar way as the feedback interface controller 2385, i.e., determine the role of the user and the specific situation at the moment, access appropriate role dependent GUI configurations and user's default presentation preferences, etc., as discussed above with respect to the feedback interface controller 2385. As there may be more dynamic factors during an emergency situation that also affect the presentation of information, the emergency interface controller 2395 may also be configured to adapt the presentation style in accordance with the dynamics of each emergency situation. For instance, if a user being rescued is in a state that displaying text message is not appropriate even though the default preference specified so, the information presented to the user may be adjusted in this situation as via audio only. Such a determination may be made based on the monitored data of the user as well as the information from the knowledge database 1050.

The emergency interface controller 2395 may also be connected to, e.g., the cloud 260 or the backend health service provider 983 (not shown) to facilitate the information flow required based on the development of the situation. For example, when an emergency interface display default persons that a user being rescued can call, the emergency interface controller 2395 may connect with the cloud 260 or the backend helth service provider 983 to obtain the contact information of such persons. In addition, if during the course of the emergency, the user being rescued selects a non-default person to communicate with, e.g., his/her dietician who is not on the default list (e.g., the user can use actionable item 921 to select a person that he/she desires to call), the emergency interface controller 2395 may request the contact information of the selected person from the backend to facilitate the user to call a selected person.

As discussed above with respect to FIGS. 9C-9O, different users involved in an emergency/rescue situation (whether the person in the emergency situation, a guardian, a rescuer, a physician, etc.) may receive different types of information on their interfaces and may react on their respective interfaces to elect to alter the choice of desired information (e.g., to choose different person for communication). The emergency interface controller 2395 receives the dynamic user choices made on the presented interfaces and reacts accordingly. For instance, based on the selected person to contact, the emergency interface controller 2395 proceeds to communicate with the backend server 983 or the cloud 260 to gather the contact information of the selected person in order to facilitate the user via the interface. In some situations, modification of an already presented interface may be needed based on a dynamic user choice. For example, a user may elect to terminate the video communication and start audio only communication. In that case, the display of the video needs to be terminated in the initial presentation and a panel related to audio (e.g., with buttons to raise the volume, etc.) may be alternatively displayed.

To render an interface with information received, the emergency interface controller 2395 may send the populated role dependent GUI configuration with modification (if any) to the user interface renderer 2390.

FIG. 23D is a flowchart of an exemplary process for determining default presentation parameter preferences, according to an embodiment of the present teaching. At 2302, user related information is analyzed to identify information related to the user that may require certain presentation parameters to make the presentation easier to read or perceive for the user. The user/s health and medical history may also be analyzed, at 2304, for the same purpose. It is checked, at 2306, what types of preference parameters that can be adjusted. Further, it is checked, at 2308, whether the user specified any preferences in terms of presentation style. Combining the findings from 2302-2308, the presentation preference initializer 2365 determines, at 2309, the default user GUI presentation parameter preferences and stores the default setting in the presentation models 830.

FIG. 23E is a flowchart of an exemplary process of the assistance information presentation unit 825 in rendering received assistance information using dynamically determined individualized presentation style, according to an embodiment of the present teaching. The online health assistance information is received and analyzed at 2312. Default presentation parameter preferences are retrieved, at 2314, from the presentation models 830. The current role of the user and the current situation are determined, at 2316, in order to facilitate role dependent presentation of relevant information. Based on such determinations, the assistance information presentation unit 825 may proceed to retrieve, at any of 2322, 2324, . . . , 2326, an interface configuration that is appropriate for both the current role of the user and the current situation that the user is in.

Once an interface configuration appropriate for the current/situation of the user is retrieved, the default presentation parameter preferences are adjusted, at 2328, based on the given current role/situation of the user. The interface and the presentation of the received health assistance information are then rendered, at 2332, based on the adjusted presentation parameter preferences. If there is any change caused by an action taken by the user with respect to the rendered interface with assistance information delivered to the user, determined at 2334, the assistance information presentation unit 825 gathers, at 2336, additional relevant information and proceeds to the step of adjusting the presentation parameter preferences based on the changes detected at 2328. If no change is detected from the user that require adjustment to the rendered interface, the assistance information presentation unit 825 returns to 2312 to receive the next piece of online health assistance information.

FIG. 24 depicts an exemplary health service framework 2400 for providing online health service which incorporating interconnected wearable devices 210, cloud based data center 260, a health service engine (or angle service engine) 2410 driving service entities 2430 responding in accordance with continuously classified health conditions, according to an embodiment of the present teaching. The angle service engine 2410 and the connected responding entities 2430 form a backend health service provider such as the backend health service provider 983 depicted in FIG. 9M as disclosed herein. The illustrated framework comprises users 805 of the real time health monitors 210, a positioning service 220, an angel service engine 2410 connected real time health monitors 210 via network 205, the cloud 260, and various parties connected to the angel service engine 2410. This health service framework is inter-connected, via the network 250, with hundreds of thousands of mobile devices having their respective real time health monitors deployed thereon and backed up by the cloud 260, to providing 24/7 health related services, that range from emergency handling to routine health related counseling/service to people who are healthy but desire to maintain a healthy life style.

Users of different types are connected to the angle service engine 2410 in this framework, via their respective real time health monitors 210. The population that can be served by such a framework may include a wide range of people (as shown in FIG. 24), including not only those who need to be monitored such as elderly or people in special needs, but also those who are although healthy yet health conscious and desire to live a healthy life style.

Each real time health monitor 210 in this framework monitors the physical location, health data, and vital data of a person being monitored by it on a continuous basis. It may also quantitatively classify, in situ, the monitored health/vital data into different health condition classes. The monitored health/vital/location data, together with the health condition classifications are transmitted from each real time health monitor 210, with some predetermined, individualized time intervals or in real time (if the situation calls for it), to the cloud 260 (or the angle service engine 2410) via the network 250.

As discussed herein with respect to FIG. 2, the network 250 may be a single network or a combination of different networks. For example, a network may be a local area network (LAN), a wide area network (WAN), a public network, a private network, a proprietary network, a Public Telephone Switched Network (PSTN), the Internet, a wireless network, a cellular network, a Bluethtooth network, a virtual network, or any combination thereof. A network may also include various network access points, e.g., wired or wireless access points such as base stations or Internet exchange points, through which a real time health monitor 210 may be connect to the network 250 in order to transmit monitored health related information and location information to the angel service engine 2410 and receives health assistance information therefrom.

The frequency of sending monitored health information to the cloud 260 may vary depending on different considerations. For instance, if there is an emergency situation detected in association with a user, the monitored data may be immediately transmitted to the cloud 260 or even directly to the angle service engine 2410 in order to receive immediately response such as rescue. In other situations, the frequency may also be determined based on different considerations such as the health condition of a person or the subscription a person signs up with the service. For instance, for an elderly person who is in a poor health situation, the frequency may be every 15 minutes, while for an elderly person who is in a relatively healthy condition, the frequency may be lower. For a healthy younger person who is health conscious who desires to receive health assistance information on a continuous basis to help him/her to, e.g., get into a healthy life style in terms of diet, exercise, mood control, etc., the person may still subscribe for a more frequent communication between his/her real time health monitor 210 and the angel service engine 2410. For instance, the user may desire to transmit e.g., monitored information on diet or activities every 2 hours to monitor the person's life style related health information so that online health assistance information 240 may be delivered to the user on time to guide the user to live a healthy life style. The timing may also be adjusted to some meaningful time frame of each day, e.g., at mealtime or exercise time. The monitored information may be sent via the network 250, together with the monitored location of the user, in such adaptively adjusted intervals. In some embodiments, while usually the monitored data are sent to the cloud 260, in certain situations such as emergency situation, the monitored data as well as health condition classifications performed in situ on the real time health monitor 210, may be sent to the angel service engine 2410 directly for immediately attention.

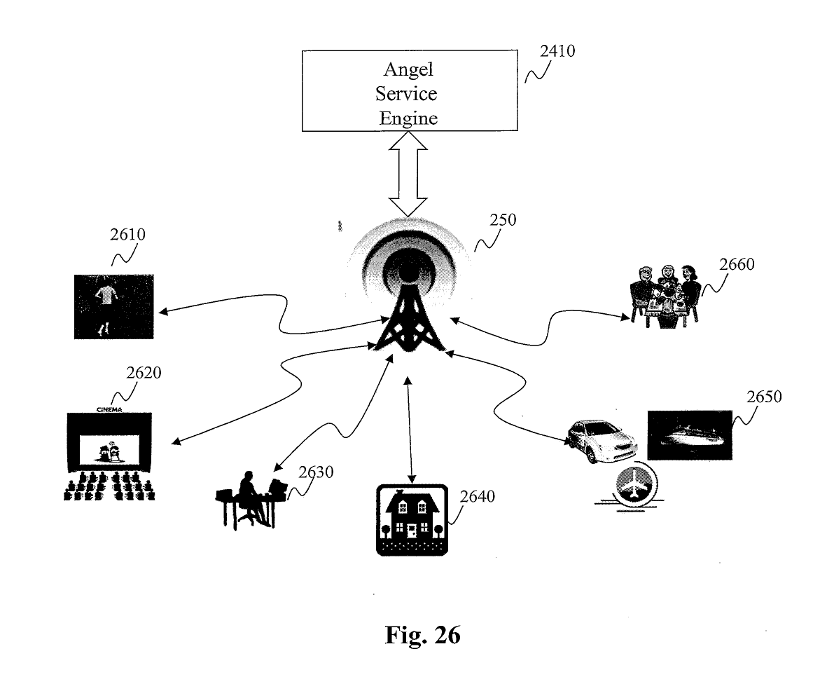

FIG. 26 illustrates the nature of anyone, anytime and anywhere of the health service framework 2400, according to the present teaching. A user of a real time health monitor 210 may be monitored no matter where the user is, what the user is doing, or at what hours. The user can be exercising (2610), at a theater to watch a performance (2620), at work (2630), in the house (2640), on travel (2650), or at a restaurant (2660), etc. That is, anywhere the user may be, the monitoring is on-going with respect to vital signs and health data related to general life style of the user. Due to the ubiquitous connectivity in today's society, the health related services via such a framework can be made continuous around the clock. This makes it possible that a user can receive online consultations or emergency care determined based on the dynamically and quantitatively measured health related information. For relatively healthy people, such services are proactive and suggestive, instead of waiting until the health problem already caused symptoms.

The angel service engine 2410 corresponds to a backend system, backed up by the cloud 260 and acting on data either stored in the cloud 260 or otherwise received directly from a real time health monitor via other channels. The angle service engine 2410 is to provide continuous (24/7) health related services to users through the real time health monitor 210 activated by the users. The angle service engine 2410 responds to the health related information monitored (either vital signs or health data) as well as health condition classifications obtained by each wearable device, generates online health assistance information 240 appropriate to the health conditions at that moment and/or the services subscribed, and sends such responsive online health assistance information 240 to the user at an appropriate time (e.g., real time if the situation calls for it or at some particular time intervals in normal situations).

The angel service engine 2410 is connected with various parties, including people associated with some users 2420 (e.g., provided by the users when they sign up for the services), including family members/relatives, guardians, or other contacts of the users. In case of emergency related to a user, the angle service engine may be configured (depending on the subscribed services) to automatically inform people designated as the emergency contacts. For instance, the user may have provided a list of contacts in case of certain health conditions, which may include spouse, physicians, parents, relatives, or friends as well as their contact information to the angel service engine 2410. When the certain health condition is detected, it may trigger the response of contacting designated people related to the user.

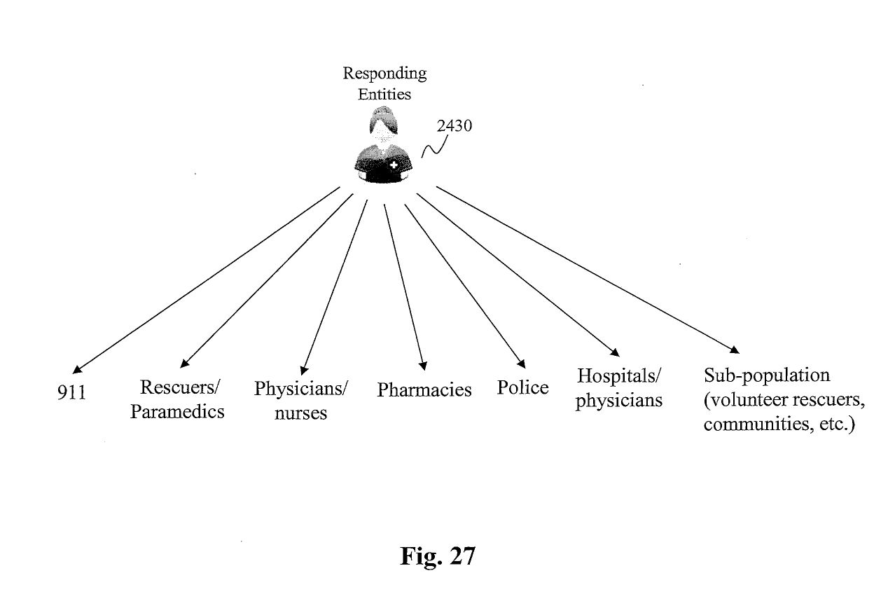

In addition, the angel service engine 2410 is also connected with various responding entities 2430, which can be called upon whenever there is an emergency situation for, e.g., rescue effort. FIG. 27 illustrates exemplary types of responding entities 2430 in the health care service framework 2400, according to an embodiment of the present teaching. In FIG. 27, the responding entities 2430 may include 911 handler, rescue paramedics, physicians/nurses, pharmacies, police, hospitals, physicians, some other groups such as volunteer rescuer organizations, communities, etc. Each of these connected parties may be called upon based on different needs by the angle service engine 2410. For instance, when there is an emergency situation of a user, the angle service engine 2410 may connect with 911 handler or rescue paramedics. At the same time, the angle service engine may also place a call to relevant physician of the user if the emergency is likely related to a particular disease for which the physician has been treating the user. At a remote location where no 911 is available, the angle service engine 2410 may connect with volunteer rescue organizations and hospital to orchestrate the rescue effort.

The cloud 260 may be networked system with multiple servers distributed in different regions and together hosting big data to form data analytic clusters. Each server in the cloud 260 may be located in a region with laws governing how users' data may be received, stored, retrieved, and used and such a server is designed to operate to comply with laws of each region. For example, the US laws require HIPAA compliant data centers so that the servers located in the U.S.A. will be HIPAA compliant. Similarly, servers located in, e.g., European countries, will be compliant with the laws in each individual European countries. The compliance is observed not only within each server but also in data transfers between/among servers in the cloud 260.

The cloud 260 may serve as a backbone of the angel service engine 2410. The data from different real time health monitors stored in cloud 260 may be retrieved by the angel service engine 2410 for analysis against, e.g., the subscribed services of each user in order to provide responsive online health assistance information 240. In addition to the angel service engine 2410, the cloud 260 may also connect to other parties as well. For instance, in some embodiments, the cloud 260 is connected to one or more data analytics engines 1840, which may be configured to perform, e.g., different tasks such as data mining. The analytical results may be stored back to the cloud 260 so that the angel service engine 2410 (and other organizations) may use or benefit from. For instance, some of the data analytics engines 1840 may be configured to analyze the data stored in the cloud 260 to discover disease-disease interactions and mark the data that may be related to such interaction instances so that such marked data may be used by the angle service engine 2410 for training disease-disease interaction models.

Some of the data analytics engines 1840 may also be part of the angel service engine network which may be designed to provide backend analysis of the received data from wearable devices to provide additional services. For instance, a data analytics engine may be configured to perform certain subscribed services for users or their guardians on, e.g., hereditary nature of some conditions that those families may be related to. The data analytics may also be performed for institutional customers on tasks for pharmaceutical companies, insurance companies, public health management organizations, etc. Such analytic studies leverage the big data collected from a large number of wearable devices which will be otherwise difficult to obtain. For instance, for any person who is injured in a work place and suffers from certain condition due to exposure of, e.g., certain chemicals at the work place, a wearable device that the person wears can report to the cloud on their health related information based on which, the insurance company can assess the situation and make appropriate adjustment on the claims.

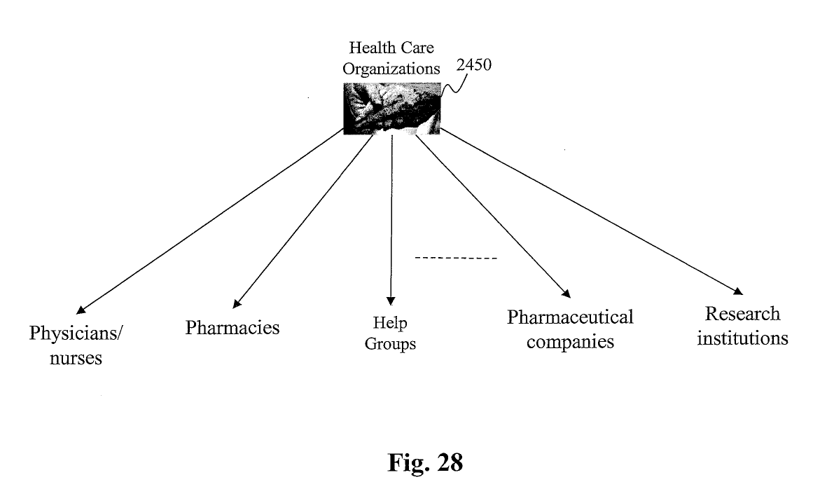

In some embodiments, the cloud 260 may also be connected to different health care organizations 2450. FIG. 28 illustrates some exemplary types of health care organizations 2450 that may connect to the cloud 260 to utilize big data and the analytics stored therein, according to an embodiment of the present teaching. This includes physicians/nurses, pharmacies, help groups, pharmaceutical companies, . . . , research institutions. For example, physicians may be connected to the cloud 260 and have permission (from the users who are the patients of the physicians) to access their patients' health information. In some embodiments, physicians/nurses may observe the in health information (vital signs and/or health data) of their patients from the cloud 260 to assess whether the treatments have taken effect. Pharmaceutical companies may access data in the cloud 260 to gather some statistics on how many people are using certain new medicine (the cloud also stores users' health history information) and how their health conditions have changes as an indication of the effect of the new medicine. Insurance companies (not shown) may also access data in the cloud 260 to see whether certain life style recommendations (e.g., certain diet with respect to certain health condition such as type II diabetes) they provided to their insured (e.g., via separate channels of via the angle service engine 2410 as part of the online health assistance information 240) has led to any relief or improvement on the general condition. Research institutes may utilize data stored in the cloud 260 to study whether certain model control techniques may have a positive impact on the general health. Furthermore, certain help groups may be given permission from users of angle services to access their data to allow such help groups to reach out to them for assistance. For instance, for people who have issue with mood control, they may provide specific permission to the angle service to allow certain help groups to access their data (maybe anonymously) and offer help via the angle services. These health organizations may also be part of the angle services by providing online health assistance information to the angle service when requested. In some embodiments, such health organizations may also provide health assistance information directly to the users.

As can be seen, the networked framework as shown in FIG. 24 connects different parties to enable comprehensive health related services. In some situations, the health service is delivered via delivering the health assistance information 240 to the connected users via their respective real time health monitors. In some situations such as emergency which require rescue, the angle service engine 2410 may act directly to organize the rescue at the site of the person (as shown via the direct line between the angle service engine 2410 and the users 805). Different components in the system in FIG. 24 act in concert to enable 24/7 health related services to anyone, including people in a wide spectrum including the sick, the healthy, and anyone in-between. The services are both general and individualized. Updated health information can be delivered to each user in an appropriate manner, context, and at desired/required frequency.

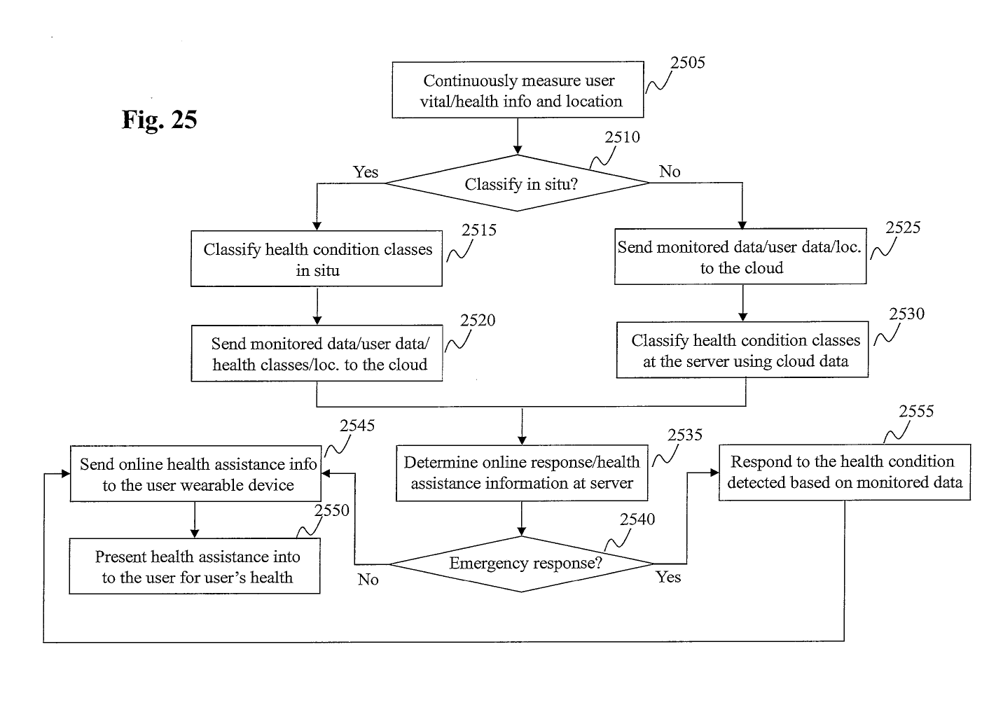

FIG. 25 is a high level flowchart of an exemplary process of a health service framework 2400 incorporating interconnected mobile devices having real time health monitors 210 deployed thereon, cloud based data center 260, a health care service engine 2410 driving service entities 2430 responding in accordance with continuous classified health conditions, according to an embodiment of the present teaching, This process is from the sensing instruments/devices/real time health monitors that continuously monitor the health related information of a person to receiving by the person appropriate health assistance as called for by the health condition the person is in. The health assistance may range from emergency rescue to regular health condition update and assist the person to live a healthy way. Each real time health monitor 210 continuously, based on a schedule determined for each individual person, measures, at 2505, various health related information (vital signs and life style related health data) of the person being monitored as well as the physical location of the person. When the device is configured to classify the health condition of the person in situ on the device, determined at 2510, the real time health monitor 210 performs quantitative classification of the health condition at 2515. Such classification is performed in accordance with the present teaching in a model based adaptive classification approach. The continuously measured health related metrics/indicators monitored automatically by the real time health monitor 210, the physical location of the person, as well as the health condition classifications are then sent, at 2520, to the cloud 260 (or the angel service engine 2410 if the classified health condition calls for such).

If the real time health monitor 210 for the person is configured not to perform the health condition classification in situ (e.g., by the specification of the person), determined at 2510, the real time health monitor 210 sends, at 2525, the automatically measured health information with the physical location of the person to the cloud 260 (or angle service engine 2410). Upon receiving the monitored health related measurements from the real time health monitor 210 at the angle service engine 2410 (either stored in the cloud 260 or directly from the real time health monitor 210), it classifies, at 2530, the person's health condition. Similarly, the health condition classification is performed in accordance with the present teaching disclosed herein on model based adaptive classification approach.

Based on the health condition classifications associated with the person, either received from the real time health monitor 210 or derived by the angle service engine 2410, the angle service engine 2410 determines, at 2535, appropriate health assistance information 240 in response to the classified health condition class(es). If the classified health condition does not signal an emergency situation, determined at 2540, the angle service engine 2410 may generate health assistance information 240 appropriate for the classified health condition for the person and send, at 2545, such responsive health assistance information 240 to the real time health monitor 210. Upon receiving the responsive online health assistance information 240 at the real time health monitor 210, it presents, at 2550, the online health assistance information 240 to the user.

If the health condition corresponds to an emergency which calls for immediate attention (e.g., rescue), determined at 2540, the angle service engine 2410 may first respond, at 2555, to the emergency situation by, e.g., activating a rescue team. After the emergency response is put in place, the angle service engine 2410 then generates appropriate online health assistance information, e.g., confirming that the paramedics is under way and instructing the user in the emergency situation to first take some medication before the paramedics arrives, and sends, at 2545, to the real time health monitor 210. Upon receiving the responsive online health assistance information 240 at the real time health monitor 210, it presents, at 2550, the online health assistance information 240 to the user.

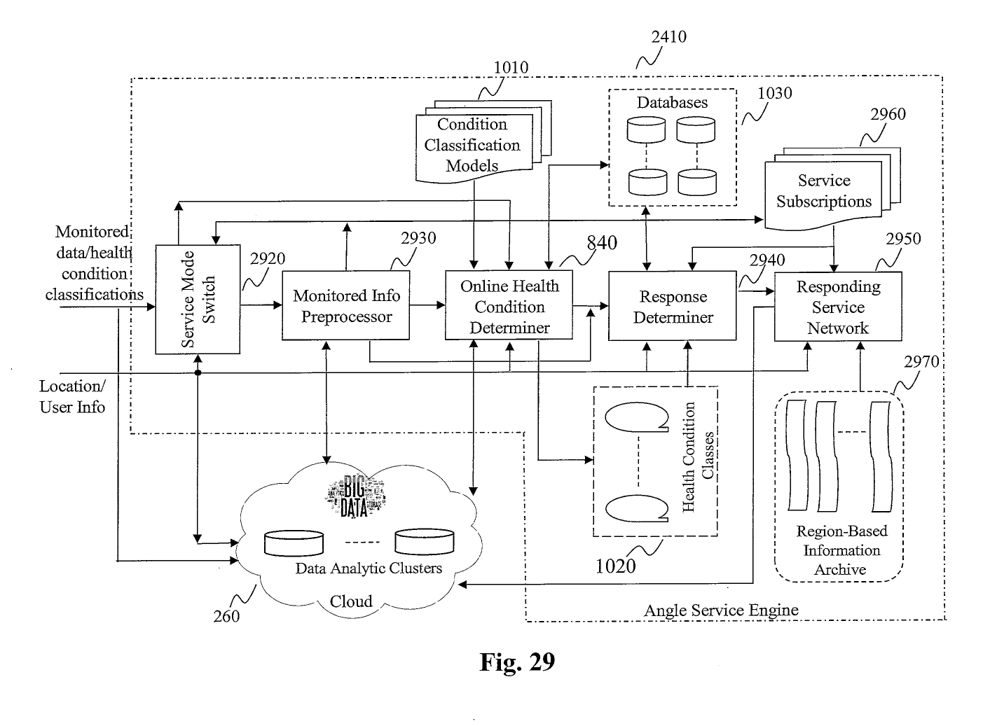

FIG. 29 depicts an exemplary internal system diagram of the angel service engine 2410, according to an embodiment of the present teaching. As discussed above, the input to the angle service engine 2410 is either from the cloud 260 or directly from a mobile device having a real time health monitor 210 deployed thereon. Such input includes monitored health information measurements and optionally health condition classifications. In addition, the input also includes the location and information about the user of the real time health monitor 210.

The angel service engine 2410 comprises a service mode switch 2920 which operates based on, e.g., user service subscriptions 2960, a monitored information preprocessor 2930, an online health condition determiner 840 (which may be structured and functions in the same way as the same module disclosed in FIGS. 13-23 except it is now located in the angel service engine), a response determiner 2940, and a response execution network 2950.

In operation, the work flow of the angel service engine 2410 for each user may depend on whether the angel service engine 2410 is to classify health condition of a user based on measurements monitored by the real time health monitor 210. In some embodiments, this may be determined based on a configuration with respect to each user. Such a configuration may be applied to all users, a group of users, or individual users. For example, the angel service engine 2410 may be configured to perform classification for those users who requested such or for those whose physicians recommended having the angel service engine 2410 to perform the classification (e.g., based on more comprehensive data than that of what the real time health monitors can access). This may be so when such users have more serious or complex health issues. Such requests may be incorporated in the service subscriptions 2960 related to such users. The configuration may also be set for each individual user based on, e.g., user specification. For instance, some user may prefer the classification being done at the backend based on more widely accessible data to improve the accuracy. Such specification may be stored in the service subscription 2960 for the user.

In some embodiments, the service mode as to where to obtain the health condition classification may be determined based on the data received from the real time health monitor 210 or a combination of input and a configuration of each user. If the input from the real time health monitor 210 includes health condition classes, the angel service engine 2410 may decide (e.g., based on some configuration or the service subscriptions 2960) not to perform the classification even though the server side classification may yield different results. In some situations, the angel service engine 2410 may still proceed with the classification even if the input includes the health condition classifications, based on, e.g., the user's request stored in the service subscriptions 2960.

Upon receiving the input from a real time health monitor 210, the service mode switch 2920 may analyze the input data and retrieve the service subscriptions 2960 associated with the user in order to determine how to proceed. If the health condition classification is to be performed on angle service engine 2410, the service mode switch 2920 activates the monitored information preprocessor 2930 and the online condition determiner 840 to carry out the classification. The processed monitored information and the classifications may then be stored back to the cloud 260.

If health condition classification is not to be performed by the angle service engine 2410, the monitored information (including both vital/health measurements and the health condition classifications) may be processed by the preprocessor 2930 and stored back to the cloud 260. Such preprocessing may include, e.g., normalization of certain measurements against some data associated with some sub-population or correlating the monitored data with some pre-determined specialized cases such as special hereditary conditions for research purposes. When no classification is needed, the process may then proceed directly to the response determiner 2940 to devise appropriate responses given the monitored health related information. In some embodiments, preprocessing of the monitored information received from the real time health monitor 210 (or via the cloud 260) may not be needed and in this case, the service mode switch 2920 may control the process to start from the response determiner 2940 directly (not shown).

In some embodiments, the online health condition determiner 840 may be structured and function the same way as what is discussed with respect to the in situ classification performed on the real time health monitor 210. In some embodiments, the classification performed on angle service engine 2410 may be more elaborate by utilizing information in a more extended manner (e.g., the health condition classification performed on the angel service engine 840 can use various most recent research results or big data analytics stored in the cloud 260) and the classification models may be better updated or trained using a higher volume of data so that the models are more accurate as compared with the models residing on individual wearable devices.

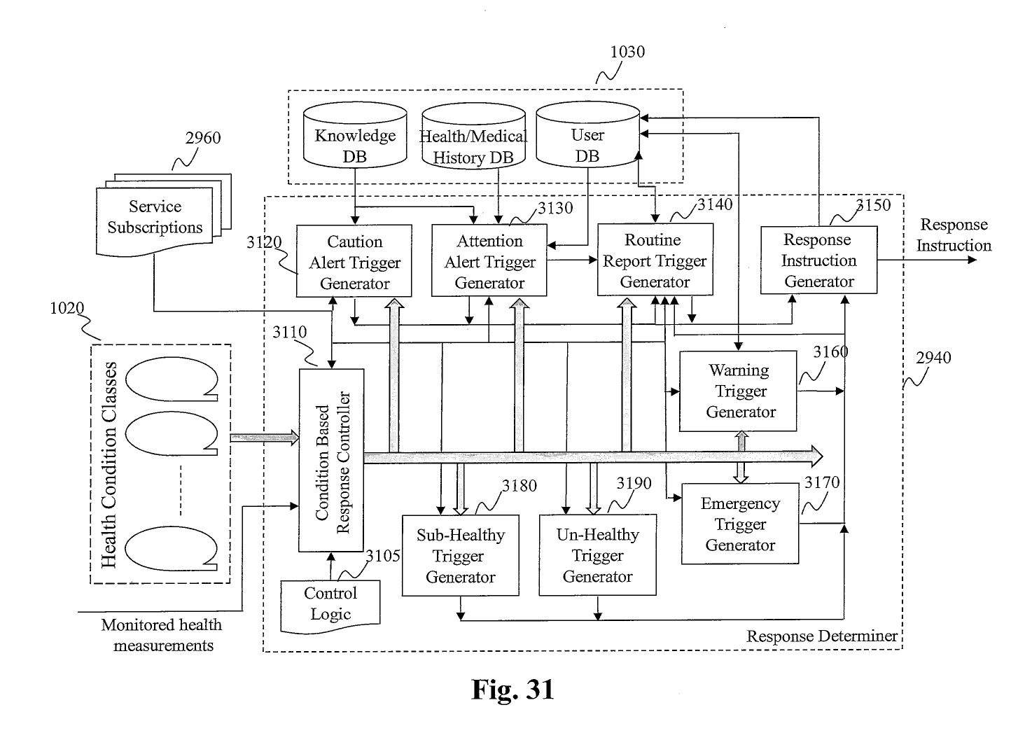

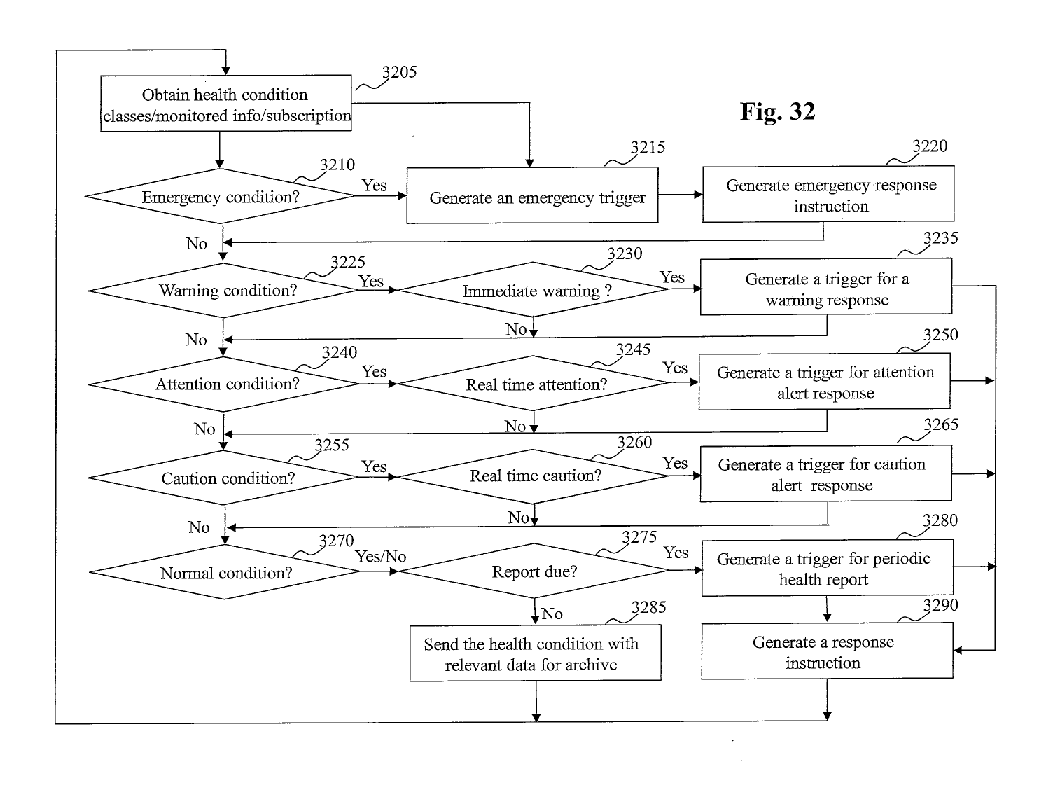

The response determiner 2940 is responsible for, given the monitored health related measurements and the health condition classifications of a user associated with a wearable device, determining the responsive online health assistance information to be provided to the user via the real time monitor. As shown, appropriate responses may also depend on the information from various databases in 1030 as well as the service subscription associated with the user. For example, the user's health history in the database 1030 may be used to guide how to respond to the user's current health condition. In addition, the service subscription of the user with the angel service engine may also dictate how to generate health assistance information. For instance, if an elderly user's subscription is only for emergency monitoring and corresponding responses such as rescue, then when the health condition of the elderly user is currently stable without emergency, there may be no response to be generated for the moment. If a young healthy user signs up for the service for health enhancement type of services, e.g., provide online assistance information based on user's diet habit and sleep patterns to guide the user how to live a healthy life style, then the subscription may not include emergency response services. Responses determined based on the user's current health condition and the monitored health related measurements are then sent to the response execution network 2950 to carry out the responses. Details regarding the response determiner 2940 are provided with respect to FIGS. 31-32.

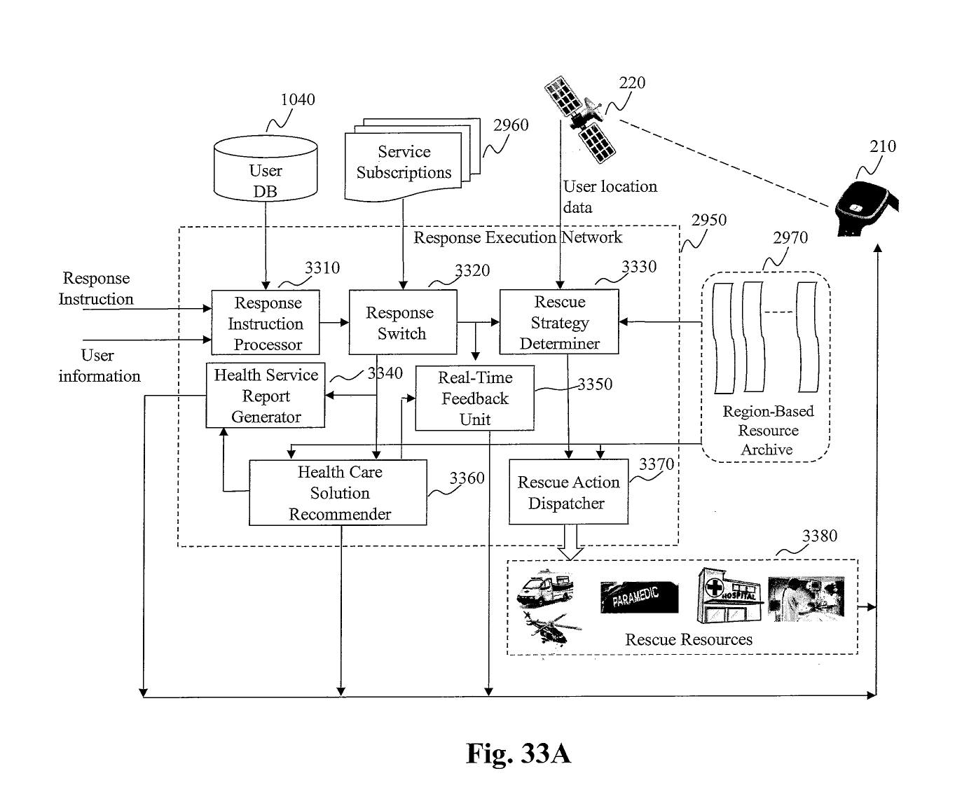

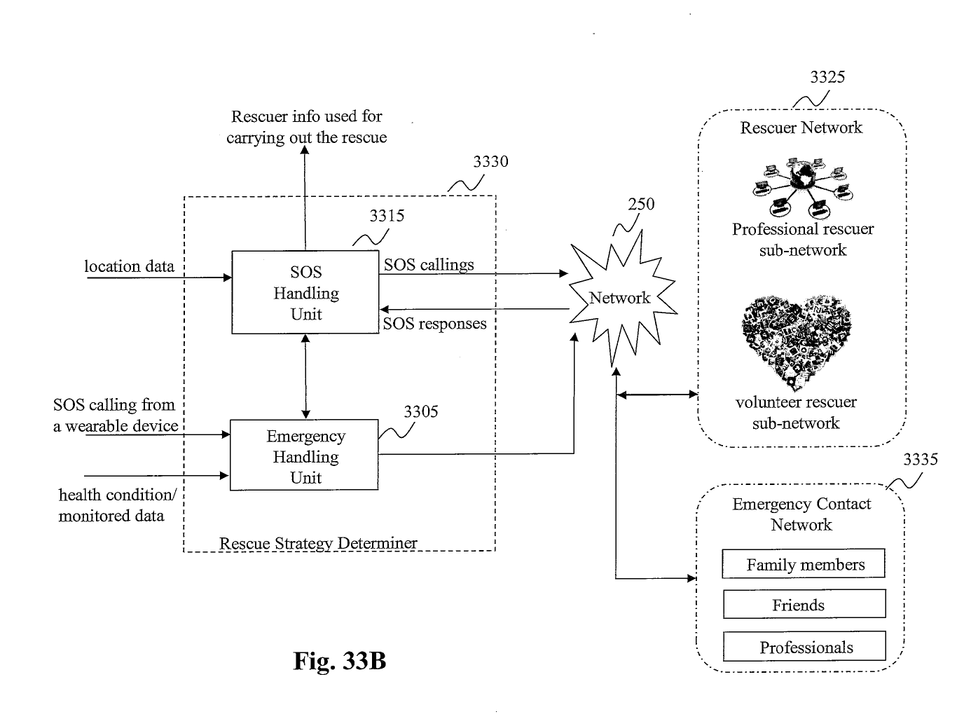

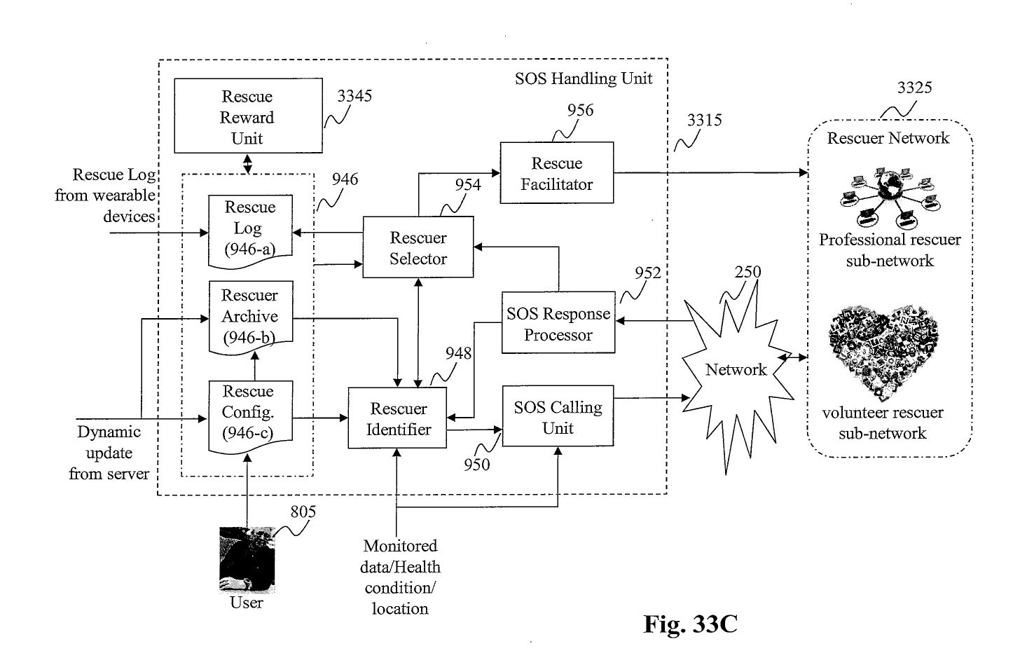

The response execution network 2950, upon receiving the responses to be delivered to the user given the monitored health information, schedules different mechanisms to carry out the responses, whether it is for emergency handling or for general health related online assistance. The response execution network 2950 may consider the user's location from the input and determine the available resources near the physical location of the user, if the responses call for such resources, based on, e.g., region based information archive 2970. Details related to the response execution network 2950 are provided with respect to FIGS. 33-35.

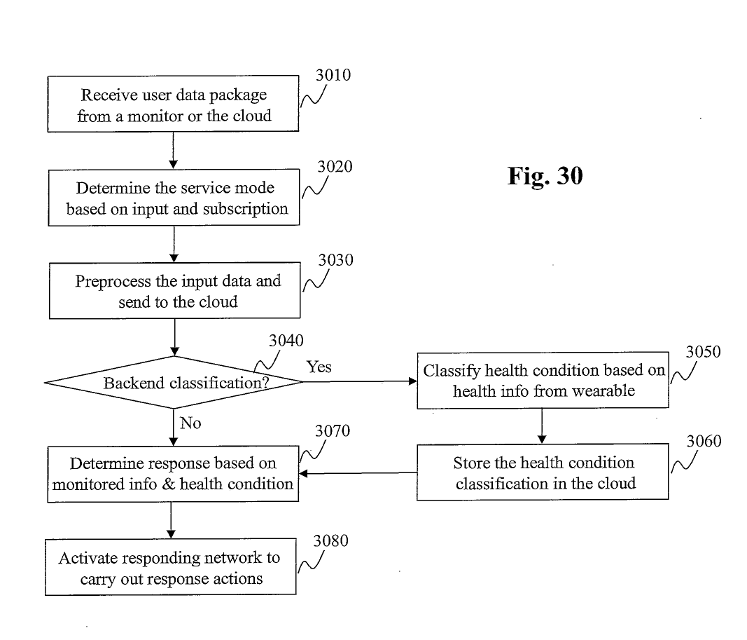

FIG. 30 is a high level flowchart of an exemplary process of an angel service engine 2410 based on interconnected mobile devices having real time health monitors deployed thereon, according to an embodiment of the present teaching. The user data package (input) is received, at 3010, from either device real time health monitor 210 directly or from the cloud 260. A service mode with respect to the received input is determined, at 3020, by the service mode switch based on information from different sources, e.g., the input data, the subscription associated with the user, or a configuration at the angel service engine 2410. The received input data are processed at 3030 by the monitored info preprocessor 2930 and stored in the cloud 260 or other databases (e.g., 1030).

In a service mode which requires backend health condition classification, determined at 3040, the online health condition determiner 840 residing on the angel service engine 2410 classifies, at 3050, the user's health condition based on the monitored health information monitored by the real time health monitor 210. Such classified health condition classes are then stored, at 3060, in the cloud 260 associated with the user. Based on the health classifications as well as the monitored health related information, the response determiner 2940 determines, at 3070, an appropriate response to the health condition/information of the user based on, e.g., subscription of the user as well as the condition of the user. With such determined responses, the response execution network 2950 activates, at 3080, components of the response execution network to carry out the responses.

FIG. 31 depicts an exemplary internal system diagram of a response determiner 2940 responding to continuous classified health conditions, according to an embodiment of the present teaching. In this exemplary embodiment, the response determiner 2940 acts on the health condition classes 1020 (classified either by the real time health monitor 210 or by the angel service engine 2410), to generate appropriate responses in accordance with information from different sources, e.g., the service subscription of the underlying user 2960, the information in 1030 about the user, his/her health history, as well as the general knowledge in health industry.

The exemplary system diagram of the response determiner 2940 comprises a condition response controller 3110 that activates, based on the health condition classes, different modules responsible for generating different response triggers, including a caution alert trigger generator 3120, an attention alert trigger generator 3130, a routine report trigger generator 3140, a warning trigger generator 3160, an emergency trigger generator 3170, a sub-healthy trigger generator 3180, and a Un-Healthy Trigger Generator 3190. The response determiner 2940 also includes a response instruction generator 3150 that is to combine the applicable triggers received from the different modules and generate a response instruction to be sent to the responding service network 2950 to generate the actual responses and delivery of the responses to the real time health monitor 210 or to other relevant parties.

As discussed herein, the exemplary types of health condition classes include normal, attention, caution, warning, emergency, healthy, sub-healthy, and not-healthy, as illustrated in FIG. 5. The health condition classes as stored in 1020 in FIG. 31 is used to control the operation of the response determiner 2940. In addition, the monitored health measurements received from a real time health monitor 210 may also be used by the condition based response controller 3110 in determining one or more appropriate responses. The condition based response controller 3110 may be configured to activate, according to the control logic 3105, one or more of the modules 3120, 3130, 3140, 3160, 3170, 3180, and 3190 to generate triggers corresponding to each of the health condition classes. For example, for a particular user, the health condition classes detected may be caution and sub-healthy. In this case, such health condition classes will enable the condition based response controller 3110 to activate the caution alert trigger generator 3120 and the sub-healthy trigger generator 3180. If an emergency situation is detected, the corresponding classification will enable the condition based response controller 3110 to activate both the emergency trigger generator 3170 and possibly the warning trigger generator 3160 depending on, whether the user is still able to take measures to avoid any harm. For example, if the person is detected in the process of developing a heart attack but may not yet in an unconscious situation, the warning may serve to remind the user to immediately do something such as lying down without exert any effort, to prevent acceleration of the heart attack.

In some situations, multiple health conditions, e.g., “normal,” “healthy,” “attention,” “caution,” “warning,” “emergency,” “sub-healthy,” or “not-healthy,” may cause the condition based response controller 3110 to activate the same trigger generator. For instance, the condition based response controller 3110 may activate the routine report trigger generator 3140 under those health conditions so that the activated module 3140 may generate a trigger to generate a routine health report to the user that includes details of each of these applicable health conditions within a period of time. On the other hand, the condition based response controller 3180 may also activate the corresponding modules for each of these health conditions (3120, 3130, 3160, 3170, 3180, and 3190) so that each of the health conditions may also be individually responded to in a way that is specific to that health condition.

The control may also be based on the control logic 3105, which may be set up based on, e.g., general knowledge in medicine, personal health history of the user, or the specific monitored health related measurements from the real time health monitor 210 (connection now shown in FIG. 31). For instance, if it is generally known (general medical knowledge) that if a person suffering from type II diabetes (personal history of the user) has a blood pressure lower than a certain point, the person may be experiencing a dangerous episode of low blood sugar which can be quite dangerous. In this case, the person may be in a state that requires rescue but at the same time may still be well enough (monitored health measurements) to find something sweet to drink to prevent a catastrophic situation. The control logic in this case may be configured to dictate that, in this case, both the emergency trigger (start to calling for rescue) and the warning trigger (to generate a warning to the user to find something sweet to drink) should be generated. Accordingly, the condition based response controller 3110 may, in this case, act in accordance with the control logic 3105 to activate both emergency trigger generator 3170 and the warning trigger generator 3160.

Each of the trigger generators may be configured to generate a trigger for the corresponding health condition class with the information that is consistent with the nature of the condition and needed in order to generate an actual response appropriate for the situation. For instance, the trigger for a caution health condition may include information about the reason that leads to the classification, e.g., an elevated blood pressure level with a poor sleep pattern, so that such information may be used by the response execution network 2950 to generate the actual response, e.g., recommending the user to visit a specialist to address the elevated blood pressure and suggesting the user to use a certain approach to improve his/her sleeps. Similarly, if a person is in a health condition class “attention,” information related to what causes this classification, e.g., the blood pressure level has persistently been near the threshold of being high blood pressure. With such information, the response execution network 2950, when receiving a trigger related to the “attention” condition, can generate a response that addresses the specific cause of the health condition and recommend, as a response, e.g., certain diet and/or exercise that will help to reduce the blood pressure. In the “emergency” health condition, it may be even more important for the trigger, generated by the emergency trigger generator 3170, to include the information that describes what led to the emergency situation so that the rescue effort can be appropriately organized with proper rescue resources such as medical staff and medications.

The routine report trigger generator 3140 is to generate a trigger for, e.g., a routine health report to the user reporting each of the applicable health conditions that user experiences in a particular period of time. In this case, information led to the conclusion of each health condition may be provided so that the trigger can provide such information to the responding service network to appropriately create the health report. A trigger generated by any of the different generators (3120, 3130, 3140, 3160, 3170, 3180, and 3190) is sent to the response trigger generator 3150, which then generates a response instruction to be sent to the response execution network 2950.

The condition based response controller 3110 may operate in a priority based manner as well, based on, e.g., urgency of each health condition in order to respond to each condition in a manner that is timewise appropriate for each condition. When there is one user, this may not yield much difference in terms of speed of response. However, the angel service engine 2410 may connect to millions of real time health monitors and handle millions of situations at every moment. In this situation, prioritizing the processing of different health conditions may make a significant difference.

FIG. 32 is a flowchart of an exemplary process for the response determiner 2940 that responds to continuous classified health conditions, according to an embodiment of the present teaching. In this exemplary process, the health conditions may be processed in an order of the urgency of each condition to ensure timely response. However, the present teaching is not limited to this exemplary flow. In some embodiments, the order of processing may differ, depending on the needs of the application. In some implementations, the processing of different health conditions may be performed in parallel, each of which may correspond to one or more similarly situated health conditions and may be configured in a manner appropriate for the health conditions implicated.

In FIG. 32, the health conditions as well as the monitored health related measurements associated with a user are obtained, at 3205, together with the subscription information of the user. It is determined, at 3210, whether any of the health condition classes corresponds to an emergency situation. If it does, an emergency trigger is generated at 3215, with the relevant information incorporate therein, such as health related measurements monitored by the real time health monitor associated with the user as well as the physical location of the user. The generated trigger is then used, at 3220, to the response instruction generator 3150 to generate a corresponding emergency response instruction with the relevant information to be sent to the response execution network 2950 and possibly some high priority indicator to ensure immediate response action.

Independent of generating a real time response to react to an emergency situation (by the emergency trigger generator 3170 and the response instruction generator 3150), the emergency trigger generator 3170 may also send the trigger information for the emergency situation to the routine report trigger generator 3140, where the issued response triggers may be archived with relevant information (health conditions and related monitored data from the real time health monitor 210) in order for them to be used in a health report to the user. Such a report may be scheduled routinely with a regular time interval and provide summaries of all what occur on health related services over each of such regular time interval.

The process may then move to generate a response for other non-emergency health conditions. At 3225, it is determined whether any of the health conditions is “warning.” If there is no health condition “warning,” the processing proceeds to handle other health conditions. If it does have a “warning” health condition, it is checked, at 3230, to see if a warning is to be issued to the user in a timely manner. The immediateness regarding issuing a warning may be determined based on, e.g., the seriousness associated with the “warning” classification, e.g., a probability or confidence score associated with the classification. It may also be determined based on a combination of the warning health classification and the trend of the vital signs measured from the user on a continuing basis. For instance, the warning classification of a potential heart attack may be accompanied with continuously monitored short of breath which may warrant an immediate warning. In some embodiments (not shown in the figures), one health classification such as “warning” may be automatically elevated to a modified health condition classification such as “emergency” when the continuously monitored health related measurements keep deteriorating. In some embodiments, whether issuing immediately a warning may also be decided based on the service subscription of the user, possibly in combination with the health classification and continuously monitored health related measurements.

If it is decided to issue a warning immediately, the condition based response controller 3110 activates the warning trigger generator 3160 to generate, at 3235, a trigger for the warning response and sends such a trigger, together with relevant information, e.g., location and monitored health information, to the response instruction generator 3150 to create, at 3290, a response instruction.

Similarly, independent of generating a real time response to react to a “warning” health condition (by the warning trigger generator 3160 and the response instruction generator 3150), the warning trigger generator 3160 may also send the trigger information for the “warning” situation to the routine report trigger generator 3140, where the corresponding response trigger issued may be archived with relevant information (e.g., health conditions and related monitored data from the real time health monitor 210) in order for them to be used in a health report to the user. This report may be scheduled routinely over a regular interval time frame and provide summaries of what occurred in terms of health related services over each of such internal time frame, including any “warning” related responses.

If there is no health condition corresponding to “warning,” determined at 3225, no immediate warning, determined at 3230, or after a trigger for “warning” health condition has been generated in case of an immediate alert of a “warning” health condition at 3235, other health conditions are processed. For instance, it is examined, at 3240, whether any of the health conditions corresponds to “attention.” If it does not, the response determiner 2940 moves forward to process other remaining health conditions.

If there is “attention” health condition associated with a user, it is further checked, at 3245, whether the health condition “attention” needs to be communicated, e.g., as an alert, in real time. Such a check is performed by the condition based response controller 3110 in order to determine which module is to be activated. In some embodiments, the check may be based on the service subscription for the user, e.g., the subscription specifies that any non-emergency situation is to be reported bi-weekly without real time reporting. In some embodiments, the determination of whether to report “attention” health condition in real time may also be determined based on the actual situation based on, e.g., the monitored vital signs of the user. For instance, if the health condition classification is “attention” because of recently detected elevated blood pressure but the continuously monitored health related measurements indicate that the blood pressure is rapidly increasing with an upper trend, then the condition based response controller 3110 may make a decision, according to the control logic 3105, to do a real time reporting of the “attention” health condition together with the increasing levels of monitored blood pressure.

If it is determined, at 3245, to report health condition “attention” in real time, the condition based response controller 3110 may then activate, e.g., the attention alert trigger generator 3130, to generate, at 3250, a trigger for this corresponding heath condition. Such a trigger is then sent to the response instruction generator 3150 so that an “attention” alert may be incorporated in the response instruction generated at 3290.

Similarly, independent of generating a real time response to react to a “attention” health condition (by the attention alert trigger generator 3130 and the response instruction generator 3150), the attention alert trigger generator 3130 may also send the trigger information for the “attention” situation to the routine report trigger generator 3140, where the corresponding response trigger issued may be archived with relevant information (health conditions and related monitored data from the real time health monitor 210) in order for them to be used in a health report to the user. This report may be scheduled routinely over a regular interval time frame and provide summaries of all what occur on health related services over each of such internal time frame, including any “attention” related responses.

If there is no “attention” health condition, determined at 3240, no real time alert for the “attention” condition, determined at 3230, or after a trigger for “attention” health condition has been generated for a real time alerting alert of the “attention” health condition at 3235, other health conditions are processed. For instance, it is examined, at 3255, whether any of the health conditions corresponds to “caution.” If it does not, the response determiner 2940 moves forward to process other remaining health conditions.

When there is “caution” health condition associated with a user, it is further checked, at 3260 by, e.g., the condition based response controller 3110, whether the health condition “caution” needs to be communicated, e.g., as an alert, in real time. In some embodiments, the check may be based on the service subscription for the user, e.g., specifying whether a non-emergency situation is to be reported in real time. In some embodiments, the determination of whether to report “caution” health condition in real time may also be determined based on the actual health situation of the user at that moment based on, e.g., the vital signs of the user at that point.

If it is determined, at 3245, to report health condition “caution” in real time, the condition based response controller 3110 may then activate, e.g., the caution alert trigger generator 3120, to generate, at 3265, a trigger for this corresponding heath condition. Such a trigger is then sent to the response instruction generator 3150 so that a “caution” alert may be incorporated in the response instruction generated at 3290.

In addition to generating a real time response to react to a “caution” health condition (by the caution alert trigger generator 3120 and the response instruction generator 3150), the caution alert trigger generator 3120 may also send the trigger information for the “caution” situation to the routine report trigger generator 3140, where the corresponding response trigger issued may be archived with relevant information (health conditions and related monitored data from the real time health monitor 210). Such archived information may be used in a health report to the user, which summarizes all what occur on health related services over each of such internal time frame, including any “caution” related responses.

If there is no “caution” health condition, determined at 3255, no real time alert for the “caution” condition, determined at 3260, or after a trigger for “caution” health condition has been generated for a real time alert of the “caution” health condition at 3265, it is examined, at 3270, whether any of the health conditions corresponds to “normal.” If there is no corresponding health condition “normal” for the user at the moment, the condition based response controller 3110 checks, at 3275, whether the routine health report is due for the user based on the subscribed reporting interval for the current user. If the routine report is not yet due for the user, the condition based response controller 3110 proceeds to determine the response for the next user or next batch of data at 3205.

When the user's health condition includes the “normal” health condition, the condition based response controller 3110 may activate the routine report trigger generator 3140, where it is also further checked, at 3275, whether the user's subscription specifies a mode of reporting and if so, whether the report is currently due. As the routine report trigger generator 3140 may also be used to archive other health conditions within a reporting period, as disclosed herein in the exemplary embodiments, it may serve as the unit where report of all different types of health conditions encountered over the present reporting period and their corresponding detailed supporting monitored health related information that give rise to the classifications.

The reporting interval may differ from user to user depending on, e.g., the subscriptions or general health condition of each user. For instance, a relatively healthy user's subscription may indicate that the angel service engine 2410 is to report with a monthly interval to the user with health conditions of the user over a month period with specific health condition classifications on different dates in the month as well as detailed monitored data for each of the health condition encountered over the same interval. In some embodiments, the intervals used to report health conditions may be determined adaptively based on, e.g., health assessment of each user. For example, there may be a sliding scale on the frequency of routine report. For healthy users, it may be once per month. For sub-healthy people, the interval may be shorter. For users who are healthy conscious, the interval may also be shorter. For the same user, the interval may change dynamically according to the change in health conditions.

If the determination at 3275 is that the report is not yet due, the “normal” health condition with relevant information may be sent, at 3285, to the routine report trigger generator 3140 for archive so that when the report is due, the accumulated health conditions and relevant information over the current reporting cycle can be used to generate a trigger for response of providing a routine health report, summarizing all health conditions encountered in this current reporting cycle.

If it is determined, at 3275, that the routine health report is now due, the routine report trigger generator 3140 may then generate a trigger for the periodic health report at 3280, which may include the accumulated unreported health conditions encountered in this report cycle and the corresponding monitored health related data received from the real time health monitor 210. Such a trigger, which includes what needs to be reported in the current reporting cycle, is then sent to the response instruction generator 3150 to generate, at 3290, a response instruction, which may corresponding to the instructions to generate a routine health report.

FIG. 33A depicts an exemplary system diagram for the response execution network 2950 in connection with other relevant components of the angel service engine 2410, according to an embodiment of the present teaching. As discussed herein, the response execution network 2950 takes the response instruction from the response determiner 2940 as input and then carries out the determined responses. The response execution network 2950 comprises a response instruction processor 3310, a response switch 3320, a rescue strategy determiner 3330, a rescue action dispatcher 3370, a real-time feedback unit 3350, a health care solution recommender 3360, and a health service report generator 3340.

In operation, upon receiving the response instruction from the response determiner 2940, the response instruction is processed. As discussed herein, each response instruction relates to a particular user and its associated real time health monitor 210 at a particular moment. Each response instruction may include one or more responses determined by the response determiner 2940. For example, for a particular user at a particular moment, a corresponding response instruction may include two responses; one is for a real time alert for “caution” health condition classification and the other for a bi-weekly health service report. In some situations, the health condition classification of a user at a particular moment may yield separate responses at different times and, hence, multiple response instructions. For instance, if a user suffered a heart attack, on the day of the heart attack, there was an emergency response, which was immediately executed by the response execution network 2950 and the user was saved. At the same time, if the user also subscribes a bi-weekly health report as part of the service, the emergency health condition classification and response thereof may also be accumulated as a delayed response until a bi-weekly report is due. At that time, another response will be generated by the response determiner 2940 and to be executed by the response execution network 2950.

Each received response instruction may include sub-instructions, each of which may be directed to one or more responses corresponding to some health condition class(es). The received response instruction is processed by the response instruction processor 3310 to, e.g., parse into different sub-instructions corresponding to responses for different health condition classes. The parsed responses and their sub-instructions are then sent to the response switch 3320, which may then switch on different response execution units to execute the responses in accordance with the sub-instructions. The switch may be performed based on service subscriptions of each user.

The response instruction for an emergency response directed to a detected emergency health condition may cause the response switch 3320 to activate the rescue strategy determiner 3330. The activated rescue strategy determiner 3330 may, based on the specific health emergency at hand (e.g., heart attack, seizure, etc.), adaptively detail a rescue strategy/plan, including selecting a rescue team in a specific geographical region where the emergency occurred, identifying a hospital where the user can be sent to for urgent care as well as specialist needed (e.g., cardiologist) for the care, etc. The rescue strategy determiner 3330 may generate the rescue plan based on the region-based resource archive 2970 in connection with the user's current physical location. The derived rescue plan may then be sent to the rescue action dispatcher 3370 where the rescue plan is to be executed by organizing the rescue resources, e.g., dispatching the rescue vehicle (ambulance or helicopter) with the selected paramedics team to the user/s physical location, informing the identified hospital so that the rescue team there is ready to receive the rescued user, ordering the supplies needed at the hospital for the urgent care, informing specialist(s)/physicians needed to attend the user once arriving the hospital, etc.

In some situations, for each sub-instruction for a response directed to a certain health condition classification, more than one component in the response execution network may be activated. For instance, if the response instruction includes a sub-instruction for, e.g., a real time alert (response) for an “attention” health condition, the response switch 33320 may activate both the real time feedback unit 3350 (for provide a real time feedback directly to the wearable device of the user) and the health care solution recommender 3360 (for recommending some specialist or other remedy for the health condition).

Some components in the response execution network 2950 may carry out the execution in real time, including the rescue related executions (by the rescue strategy determiner 3330 and rescue action dispatcher 3370) and real time based executions (by real time feedback unit 3350). The execution results from some components may be consolidated. For instance, the health care solution recommender 3360 may be executed in order to provide some recommendations to the user, e.g., specialist in diabetes if the user is detected to have the need or dietician for a more healthy diet. On the other hand, the health service report generator 3340 may be switched on when a health report for the user is due. The health service report generator 3340 in this case will generate a report based on accumulated health condition assessment in this cycle and report the same. In this case, the recommendations generated by the health care solution recommender 3360 may be consolidated with the health report. The recommendations generated by the health care solution recommenders 3360 may be sent to the health service report generator 3340 so that a consolidated report incorporating the execution results by both can be generated. Thus, the response execution network 2950 executes the responses as dictated by the response instruction from the response determiner 2940 and delivers the responses to the user of the real time health monitor 210, as shown in FIG. 33.

Some types of the responses may correspond to certain types of health conditions, e.g., rescue related responses may be applied only to emergency health condition classes. Some types of responses may be invoked across different types of health conditions. For instance, for all health condition types, the response of generating a health service report may always be applied. A response to generate health care solution recommendations, provided by the health care solution recommender 3360, may be invoked in different health conditions, e.g., “attention,” “caution,” “warning,” “sub-healthy,” “not-healthy,” or even “healthy.” The same can be said about a real time feedback as a response, provided by the real-time feedback unit 3350.

FIG. 33B depicts an exemplary system diagram of the rescue strategy determiner 3330, according to an embodiment of the present teaching. In this exemplary embodiment, the rescue strategy determiner 3330 comprises an emergency handling unit 3305 and an SOS handling unit 3315. The emergency handling unit 3305 operates to identify emergency contacts from the emergency contact network 3335 related to a person who is reportedly in an emergency situation and automatically notify such identified emergency contacts via the network 250. As discussed herein with reference to FIG. 2 and FIG. 24, the network 250 is broadly defined and encompasses different types of networks (wired or wireless) and any combination thereof. The emergency contacts related to a person in emergency need may be specified or registered with the angle service, which may include family members, friends, guardians, or professional health care personnel such as physicians/specialists. Each emergency contact may be associated with a specified manner by which an emergency notification is to be delivered. For example, an emergency message may be delivered to an emergency contact via voice or text message pushed to the contact.

The emergency handling unit 3305 also operates to determine, given the information received (e.g., a classified emergency health condition or the activation of the emergency button 215 with specific monitored health information, etc.), how the rescue is to be carried out by the SOS handling unit 3315. The emergency handling unit 3315 invokes the SOS handling unit 3315 so that SOS calling may be carried out.

The emergency handling unit 3305 residing in the angle service engine 2410 may perform functionalities similar to that of the emergency handling unit 870 residing in the real time health monitor 210 (see FIG. 8A). In some embodiments, the emergency handling unit 3305 residing on the angle service engine 2410 may have similar system configuration and operational flow as that of the emergency handling unit 870 residing on a real time health monitor 210, as shown in FIG. 9C-9I, respectively.

In some embodiments, the angel service engine 2410 is connected with a rescuer network 3325, which may comprise multiple sub-networks of rescuers, such as a professional rescuer sub-network and a volunteer rescuer sub-network as illustrated in FIG. 33B. In some embodiments, depending on the specific situation of each emergency, the SOS handling unit 3315 may determine which rescuer sub-network to be used for the rescue. In some embodiments, the user may provide specified preference as to which sub-network of rescuers to use in case of emergency.

FIG. 33C depicts the exemplary system diagram of the SOS handling unit 3315 residing in the angel service engine 2410, according to an embodiment of the present teaching. In some embodiments, most of the functionalities of the SOS handling unit 3315 in the angel service engine are similar to that of the SOS handling unit 880 residing in a real time health monitor 210. In this case, most of the components in the SOS handling unit 3315 are similar to that in the SOS handling unit 880, respectively. For example, the SOS handling unit 3315 may include a rescuer identifier (same as 948 in FIG. 9D), an SOS calling unit (same as 905 in FIG. 9D), an SOS response processor (same as 952 in FIG. 9D), a rescuer selector (same as 954 in FIG. 9D), and a rescue facilitator (same as 956 in FIG. 9D). The functionalities of those similar components have been described in reference to FIGS. 9D-9F. The SOS handling unit 3315 may reach out to candidate rescuers in chosen sub-networks via the network 250, which is defined broadly herein, including wired and wireless, networks such as the Internet, wired PSTN network, cellular network, Bluetooth network, and any combination thereof. In addition, each candidate rescuer may similarly be associated with a specified manner by which an SOS call is to be made. For example, an SOS call may be delivered to rescuer via voice or text message pushed to the rescuer.

In addition, the SOS handling unit 3315 in the angle service engine 2410 may also archive various information to be used in determining how to handle the rescue situation. Although each of such archives in the angle service engine 2410 may serve the same function as what a correspond archive on a wearable device does (but may have a different version), the archive on the angle service engine may represent a more comprehensive version as compared with the corresponding archive stored on in a real time health monitor 210. In addition, the angle service engine operates at a larger scale, and serves as a facilitator, an organizer, a quality controller, and an archiver that records the entire rescue process for future references. The archives in the SOS handling unit 3315 may provide comprehensive records as compared to similar archives residing in the real time health monitors, each of which may have content of a smaller scale that may correspond to individualized content with respect to the user of each real time health monitor.

Some of the components in the SOS handling unit 3315 may operate differently as well. For example, the SOS response processor 952 residing in a real time health monitor may be configured to handle a response from the angle service engine 2410, while the SOS response processor residing in the angle service engine 2410 does not need to provide that function. In addition, the SOS handling unit residing in the angle service engine 2410 may have some additional components such as, e.g., a rescue reward unit 3345. In some embodiments, the health service network 2400 offers reward to certain participants such as rescuers, either to professional or volunteer rescuers. The SOS handling unit 3315 residing in the angle service engine 2410 may include the rescue reward unit 3345 to carry out the functionality related to the reward to rescuers. In this regard, the rescuer log in the angle service engine may not only record rescuers identified by the angle service engine 2410 but also receive such rescuer log information related to rescuers identified by the real time health monitors. This is depicted in FIG. 33C where the rescuer log can also be populated based on the rescuer logs received from connected wearable devices.

The operational flow of the SOS handling unit 3315 is thus similar to that of the SOS handling unit 880 residing on a real time health monitor 210, which is described in detail with reference to FIG. 9F. Because the SOS handling unit 3315 residing on the angle service engine 2410 does not handle a response from a backend health service provider (which the angle service engine is one), in determining whether the SOS calling is fulfilled at 979, does not include the determination whether the SOS calling has been fulfilled by a backend health service provider.

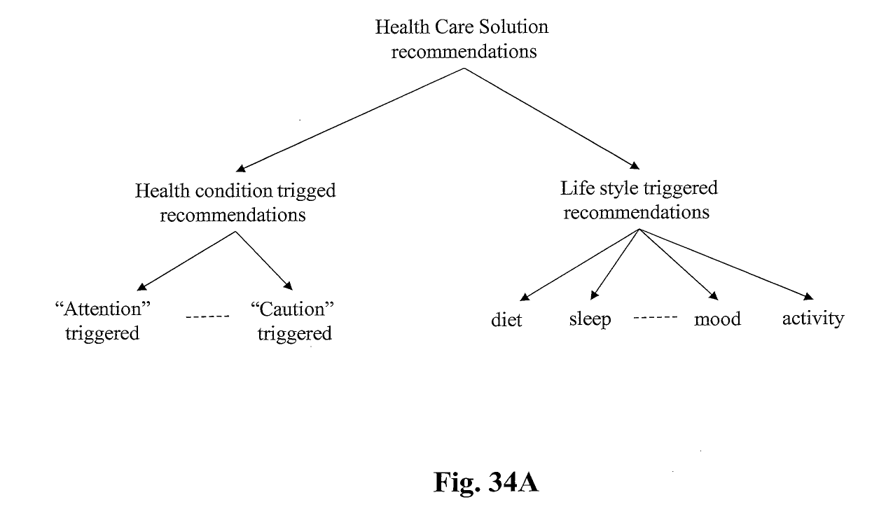

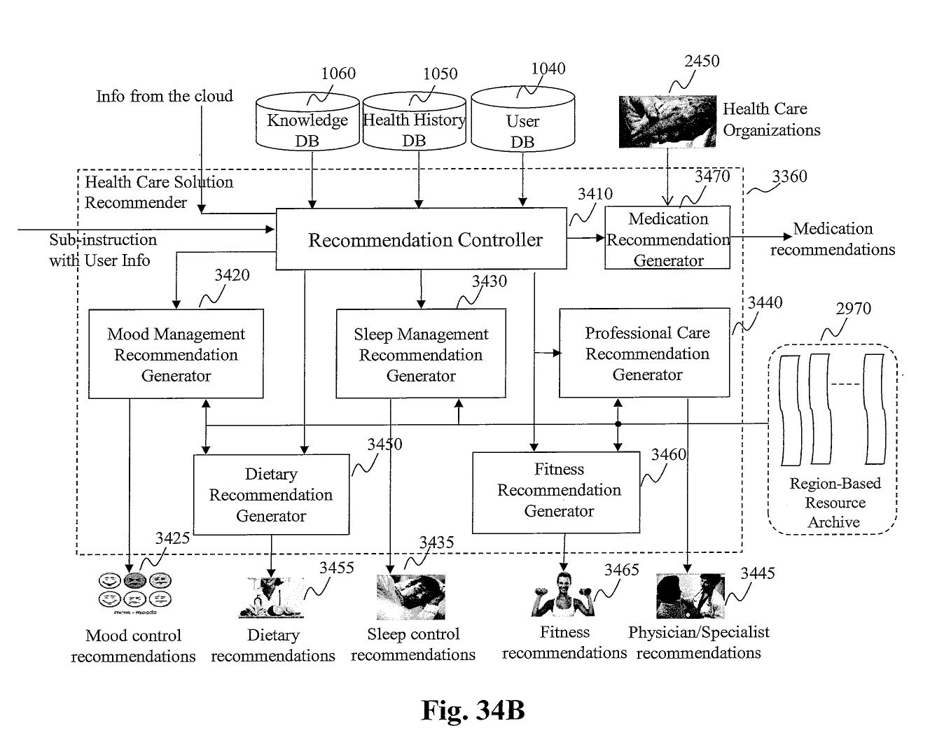

FIG. 34A illustrates exemplary types of triggering events for generating health care solution recommendations, according to an embodiment of the present teaching. As shown, health care solution recommendations may be triggered by certain health conditions, including “attention,” . . . , “caution.” It is possible that even “healthy” or “normal” health conditions may trigger the system to generate recommendations. For example, for a person who sets the goal of losing 10 pounds in the next 30 days, such personal information may be stored in user database 1040, which is subsequently used by the angel service engine 2410 to accordingly decide whether diet/exercise related recommendations should be provided to assist the person to achieve its goal.

The health care solution recommendations may also be triggered by certain life style related reasons, as shown in FIG. 34A. For example, if a person is detected to be living a life style, e.g., frequently sleep little each day or without eating on time, that ultimately may lead to sub-health or sickness, the angel service engine 2410 may preventatively trigger a response to the person with recommendations related to a more healthy life style. Such recommendations may relate to diet, sleep, mood control, or level of physical activities.

FIG. 34B depicts an exemplary system diagram for the health care recommendation generator 3360 with illustrated exemplary types of health care solution recommendations, according to an embodiment of the present teaching. This exemplary embodiment shows different types of information to be considered in recommending some health related solutions to improve a person's health. This exemplary embodiment may be provided to make recommendations to respond to certain health condition classes. In some embodiments, health conditions such as “attention,” “caution,” or even “warning” may cause some concern over a person's health so that a change in life style may help the person to either improve such health conditions or maintain the current status without getting worse. In some situations, even when a person's health is “normal,” certain life styles related adjustments may still be recommended to the user to maintain the good health via good life style. In some embodiments, recommendations for a “warning” health condition may also be provided such as a recommendation of taking some medicine immediately to relief the situation.

In this exemplary embodiment, the health care solution recommender 3360 comprises a recommendation controller 3410, a mood management recommendation generator 3420, a sleep management recommendation generator 3430, a professional care recommendation generation 3440, a dietary recommendation generator 3450, a fitness recommendation generator 3460, and a medication recommendation generator 3470. In operation, a sub-instruction related to a response for a health condition that calls for certain type(s) of recommendations is input to the recommendation controller 3410. Based on the health condition the person is in, the recommendation controller 3410 invokes appropriate generator(s) in order to generate the recommendations called for.

The recommendation controller 3410 may control the generation of different recommendations in an intelligent and personalized manner by detecting relevant personal information that needs to be considered in recommendation generation and providing appropriate relevant personal information to each invoked recommendation generator so that the recommendations generated are suitable to each person in each situation. To do so, the recommendation controller 3410 accesses information from different sources, including personal information stored in different databases (1040, 1050), relevant knowledge in the knowledge database 1060, and various data from the cloud 260 and identifies information that may affect recommendation generation. It is also assessed which piece of the identified information affects which recommendation generator so that it ensures that relevant information is provided to individual invoked components. For example, a person may be allergic to certain foods. In this case, if the dietary recommendation is needed to assist a user to improve his/her dietary habit, such food allergy information needs to be provided to the dietary recommendation generator 3450 so that the recommendation generated will not be in conflict with the health condition of the person in a negative way. Similarly, if a person's health history indicates that the person has a back problem, this information needs to be passed to the fitness recommendation generator 3460 so that any recommended fitness program to the person should not cause any adverse effect on the existing back problem.

The invocation of different recommendation generators may depend on different factors. For instance, if a person is in an emergency case, the immediately response may be to conduct the rescue, instead of recommend life style related recommendations. When a person is in a “warning” condition, the recommendation controller 3410 may invoke the medication recommendation generator 3470, if it is detected by the real time health monitor 210 that the person is still conscious and can act to take emergency medicine to help to maintain the condition until the rescue arrives. If the person is detected already in an unconscious state, the recommendation controller 3410 may not invoke any recommendation generator because of that.

Each recommendation generator, once invoked, may also operate in an intelligent manner. For instance, for a person who is having an asthma attack (e.g., “emergency” or “warning” health condition, depending on the specific measurements on breath rate detected by the real time health monitor 210), the recommendation controller 3410 may invoke medication recommendation generator 3470 to suggest certain medicine to take to stabilize the situation. The medication recommendation generator 3470 may either consult with online care organizations 2450 (including the person's physician or nurse) for recommended medicine or recommend directly to the person to immediately apply Epipens when the personal health history indicates that the person has been prescribed Epipens.

In some embodiments, the mood management recommendation generator 3420 may be invoked when the real time health monitor 210 detects that the person wearing the device often has mood swings and that correlate with the fluctuation in his/her blood pressure. In this situation, the person's health condition may be classified as “attention” and based on the monitored health information from the real time health monitor 210 supporting such a classification, the response determiner 2940 may have generated a response to address this situation that is to recommend mood management to improve the fluctuation of blood pressure. In this case, a response instruction may have been generated by the response determiner 2940 that instructs the response execution network 2950 to generate health care solution recommendations (by the health care solution recommender 3360) of certain mood management professional services or measures.

The recommendation generators, as illustrated in FIG. 34B, make recommendations based on the person's personal information as well as recommend places where the person can go to receive or carry out the recommendations. For instance, to make recommendations related to fitness to improve a person's health condition, the fitness recommendation generator 3460 may receive relevant personal information that may impact the fitness suggestions from the recommendation controller 3410 in order to suggest certain types of exercises that fit the person in consideration of, e.g., age, gender, current health condition, etc. In recommending fitness programs, the fitness recommendation generator 3460 may also access the region-based resource archive 2970 to identify appropriate local resources 3465, e.g., fitness centers, club, or coaches that can be recommended to the person. This is to match the personal needs with what is available at where the person is currently located.

Similarly, the mood management recommendation generator 3420, sleep management recommendation 3430, and professional care recommendation generator 3440 may also generate their corresponding recommendations in a personalized manner with the consideration of local available resources identified from the region-based resource archive 2970. For example, if a person starts to have elevated blood pressure, the professional care recommendation generator 3440 may be invoked to recommend one or more local physicians whom the person can visit to have a check. In this case, the professional care recommendation generator 3440 may recommend certain doctor's office in the area where the person lives (identified based on the information stored in the region-based resource archive 2970) and, possibly with the name of the recommended physician 3445 (e.g., identified based on the information in the knowledge database 1060). In some embodiments, in the recommendations provided to the person, there may include means to allow the person to act on the recommendations. For instance, in recommending a specific physician to a user, the recommendation may also include an actionable item via which the person, once receiving the recommendation on his/her real time health monitor 210, may act on the actionable item to, e.g., be connected to the physician's office's appointment page to make an appointment directly. Similarly, the recommendations 3425, 3435, 3465, and 3455 from the mood management recommendation generator 3420, the sleep management recommendation generator 3430, the fitness recommendation generator 3460 and the dietary recommendation generator 3450, respectively, may all provide respective recommendations in a manner that includes instructions to render actionable means when presenting the recommendation to the person that allows the person, upon receiving the recommendation, to act directly on the recommendation, on their real time health monitor 210, to move to the stage to act on the recommendation.

In FIG. 33A, the real time feedback unit 3350 is to generate real time feedbacks to the real time health monitor 210 to respond to the monitored health related information. Similar to the responsive recommendations, the angel service engine 2410 may trigger real time feedbacks under different types of health conditions. For instance, certain types of health condition classes triggered by monitored vital signs may require real time feedbacks to be sent to the real time health monitor 210. As discussed herein, when the health condition is classified as “caution,” “attention,” “warning,” or sometimes even “emergency,” real time feedbacks may be generated and sent to the real time health monitor 210. In those situations, the real time feedback may be in the form of alert to inform the person via the real time health monitor 210 that what kind of situation the person is currently in. In some situations, the real time feedback may also include some recommendations identified according to the health condition and provided with the alert together as part of the real time feedback. This is shown by the link between the health care solution recommender 3360 and the real time feedback unit 3350 in FIG. 33A.

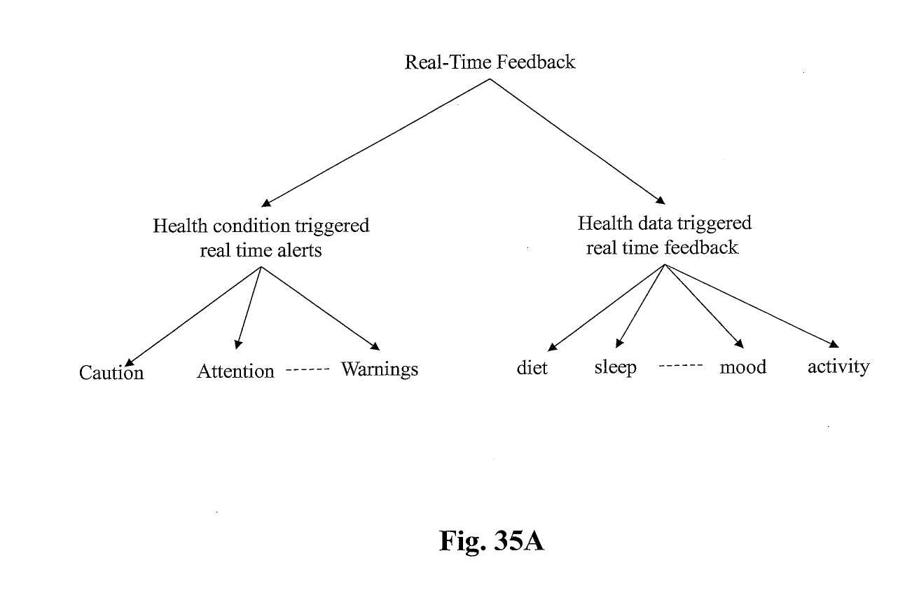

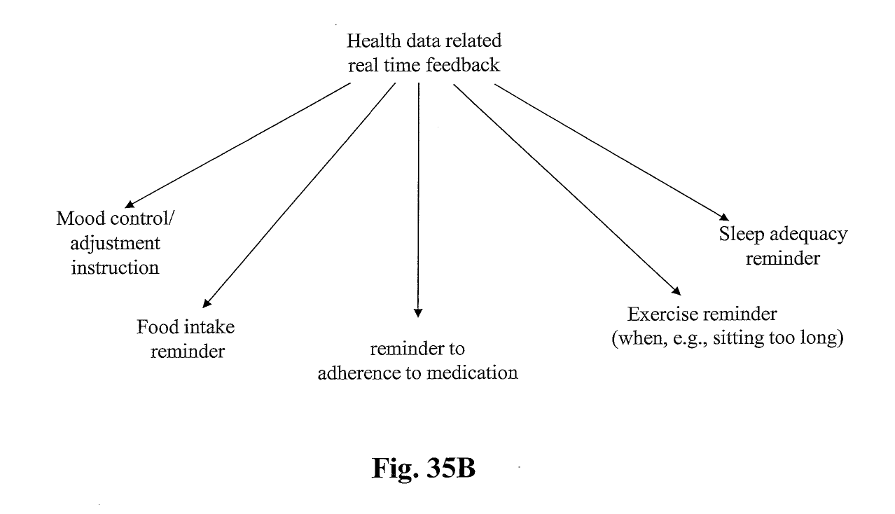

In addition, real-time feedbacks may also be invoked when the monitored health data suggest that some regularity desired for maintain a healthy life style is not observed. FIG. 35A illustrates exemplary categories of situations for which real time feedbacks may be adaptively provided based on different health condition classifications, according to an embodiment of the present teaching. As shown in FIG. 35A, such regularity may be related to, e.g., diet, sleep, . . . physical activities. The health data monitored by the real time health monitor 210 with respect to such life style related considerations may reveal a lack of event at some regular time frame. For instance, if a person skips lunch, the real time health monitor 210 may report as such so that the angel service engine 2410, upon receiving such information, may trigger the response execution network to generate a real time reminder, which is then sent to the real time health monitor 210 to remind the person to have lunch. Similarly, when a lack of physical activities or lack of sleep is detected by the real time health monitor 210, some real time feedbacks may be generated and sent, by the angel service engine 2410, to the real time health monitor 210 to remind the person to stick with a more healthy life style.

FIG. 35B illustrates exemplary types of real time feedback related to life style factors adaptively generated based on monitored/measured health data, according to an embodiment of the present teaching.

As discussed herein, the ability of the real time health monitor 210, as disclosed, to continuously monitor the health related information (vital signs as well as other health data) of the person wearing the device enables the person to continuously receive needed health assistance, organized by the angel service engine 2410, and/or online health assistance information generated by the angel service engine 2410, all according to the present health state or life style of the person.

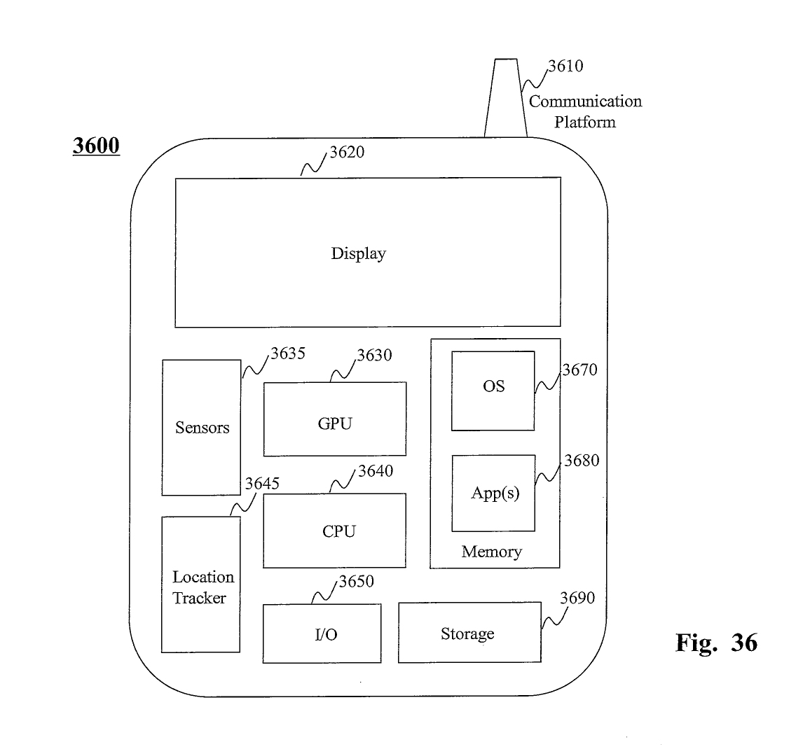

FIG. 36 depicts the architecture of a mobile device which can be used to realize a specialized system capable of deploying the real time health monitor 210. In this example, the mobile device 3600 on which various aspects of the present teaching (sensing health data, making measurements, and classification) can be implemented corresponds to a wearable computing device (such as 210) that can be worn on any parts of a human body so long as the needed health related measurements can be detected or in a similar or equivalent form factor. The mobile device 3600 in this example includes one or more central processing units (CPUs) 3640, one or more graphic processing units (GPUs) 3630, a display 3620, a memory 3660, a communication platform 3610, such as a wireless communication module, storage 3690, and one or more input/output (I/O) devices 3650. The mobile device 3600 also includes in situ one or more sensors 3635 deployed for sensing various vital signs and health data of the person wearing the device. Furthermore, the mobile device 3600 includes a location tracker 3645 for continuously tracking the physical location of the device. Any other suitable component, including but not limited to a system bus or a controller (not shown), may also be included in the mobile device 3600. As shown in FIG. 36, a mobile operating system 3670, e.g., iOS, Android, Windows Phone, etc., and one or more applications 3680 may be loaded into the memory 3660 from the storage 3690 in order to be executed by the CPU 3640. The applications 3680 may include a browser or any other suitable mobile apps for receiving and rendering data on the mobile device 3600. User interactions with the received data may be achieved via the I/O devices 3650 and provided to the angel service engine 2410 or any other components in the service framework 2400 e.g., via the network 250.

To implement various modules, units, and their functionalities described in the present disclosure, computer hardware platforms may be used as the hardware platform(s) for one or more of the elements described herein (e.g., vital sign measurement unit 820, the health info measurement unit 815, the online health condition determiner 840, etc.). A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

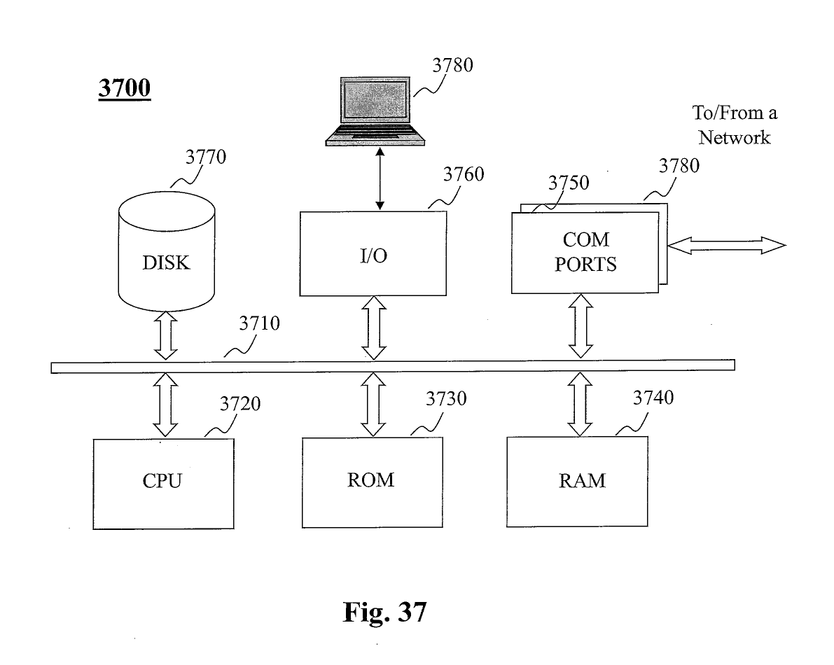

FIG. 37 depicts the architecture of a computing device which can be used to realize a specialized system implementing the present teaching related to different aspects of the angel service engine 2410. Such a specialized system incorporating the present teaching has a functional block diagram illustration of a hardware platform which includes user interface elements. The computer may be a general purpose computer or a special purpose computer. Both can be used to implement a specialized system for the present teaching. This computer 3700 may be used to implement any component or any aspect of the angel service engine 2410, as described herein. For example, the online health condition determiner 840 residing in the angel service engine 840, the response determiner 2940, the responding service network 2950, etc., may be implemented on a computer such as computer 3700, via its hardware, software program, firmware, or a combination thereof. Although only one such computer is shown, for convenience, the computer functions relating to the angel service engine as described herein may be implemented in a distributed fashion on a number of similar platforms, to distribute the processing load.

The computer 1800, for example, includes COM ports 3750 connected to and from a network connected thereto to facilitate data communications. The computer 3700 also includes a central processing unit (CPU) 3720, in the form of one or more processors, for executing program instructions. The exemplary computer platform includes an internal communication bus 3710, program storage and data storage of different forms, e.g., disk 3770, read only memory (ROM) 3730, or random access memory (RAM) 3740, for various data files to be processed and/or communicated by the computer, as well as possibly program instructions to be executed by the CPU. The computer 3700 also includes an I/O component 3760, supporting input/output flows between the computer and other components therein such as user interface elements 3780. The computer 3700 may also receive programming and data via network communications.

Hence, aspects of the methods of angel service engine and/or other related processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other types of server into the hardware platform(s) of a computing environment or other system implementing a computing environment or similar functionalities in connection with the disclosed health services via interconnected wearable devices and continuously monitored health related information of different individuals. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the angel service engine and its relevant functions as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a mobile device having at least one processor, storage, and a communication platform capable of connecting to a network for monitoring health condition of a user, comprising:
obtaining, automatically by a real time health monitor deployed on the mobile device, at least one health related measurement made based on one or more sensors sensing health information of the user;
computing, by the real time health monitor, at least one of a vitality index and a health index based on at least one health related measurement;
classifying, based on the at least one of the vitality index and the health index, health of the user into at least one of a plurality of predetermined health condition classes;
transmitting, via the network, the at least one health condition class to a health service provider; and
receiving health assistance information adaptively determined in accordance with the at least one health condition.

2. The method of claim 1, wherein the mobile device includes a watch, a smart phone, a tablet, a personal data assistant (PDA), and a handheld device.

3. The method of claim 1, wherein the one or more sensors reside in the mobile device or in one or more peripheral instruments, which include a wearable device or at least one of health related instruments, cooking equipment, and exercise equipment, wherein the one or more peripheral instruments sense the health information and transmit to the real time health monitor via a network connection.

4. The method of claim 3, wherein the wearable device includes a watch, a ring, a piece of cloth, a tracking device, an ear set, and a headset.

5. The method of claim 1, wherein
the at least one health related measurement includes a set of health data and a set of vital data associated with the user, wherein
the set of health data includes at least one of diet, sleeping, mode, and activity of the user, and
the set of vital data includes at least one of blood pressure, heart rate, body temperature, breathing rate, SPO2, body velocity, glucose, ECG, and skin conductivity.

6. The method of claim 4, wherein the plurality of predetermined health condition classes include at least one of normal, attention, caution, warning, emergency, healthy, sub-healthy, and not-healthy.

7. The method of claim 1, wherein the step of classifying is performed based on at least one of generic health models, individualized health models, disease-specific models, and disease-disease interaction models.

8. The method of claim 7, wherein the health assistance information includes at least one of real-time feedback, online physician instruction, health related recommendations, health report, and health intelligence.

9. The method according to claim 8, further comprising presenting the received health assistance information to the user in a manner that is adapted with respect to the user.

10. The method of claim 1, further comprising providing emergency related assistance to the user when the at least one health condition class corresponds to an emergency classification.

11. The method of claim 10, wherein the step of providing the emergency related assistance comprises contacting, by the wearable device via the network, at least one of
one or more contacts associated with the user;
at least one rescuers for soliciting help to rescue the user;
one or more health care professionals to provide emergency related assistance; and
the health service provider for coordinating the emergency related assistance.

12. The method of claim 10, wherein the step of providing the emergency related assistance comprises
receiving, by the real time health monitor via the network, information from at least one of
a contact associate with the user,
a rescuer,
a health care professional, and
the health service provider; and
presenting the received information to the user.

13. The method according to claim 12, wherein the received information is presented to the user in a manner that is dynamically adapted to the at least one health condition class with respect to the user.

14. A method, implemented on a computing device having at least one processor, storage, and a communication platform capable of connecting to a network for real time health assistance via a network connection, comprising:
receiving, by a health service engine via the network from a real time health monitor deployed on a mobile device, information about a location of a user and health information of the user, wherein the health information is estimated by the real time health monitor based on at least one of a vitality index and a health index associated with vitality and health of the user, respectively, computed by the real time health monitor in accordance with at least one health related measure made based on one or more sensors;
obtaining, at least one of a plurality of health condition classes, classified based on the at least one of the vitality index and the health index;
determining, adaptively with respect to the location of the user and the at least one of a plurality of health condition classes, health assistance to be provided to the user; and
delivering, via the network, the health assistance to the user of the real time health monitor.

15. The method of claim 14, wherein the step of obtaining comprises receiving the at least one of the plurality of health condition classes from the real time health monitor.

16. The method of claim 14, wherein the step of obtaining comprises:
retrieving past health information of the user;
accessing one or more models, at least some of which is derived based on the past health information of the user;
classifying, in accordance with the one or more models, health of the user into the at least one of the plurality of health condition classes based on the health information of the user received from the real time health monitor.

17. The method of claim 16, wherein the one or more models include at least one of generic health models, individualized health models, disease-specific models, and disease-disease interaction models.

18. The method of claim 14, wherein the mobile device includes a watch, a smart phone, a tablet, a personal data assistant, and a handheld device.

19. The method of claim 14, wherein the one or more sensors reside in the mobile device or in one or more peripheral instruments, wherein the one or more peripheral instruments include at least one of health related instruments, cooking equipment, and exercise equipment, which sense the health information of the user and send the sensed health information to the real time health monitor.

20. The method of claim 14, wherein the plurality of health condition classes include at least one of normal, attention, caution, warning, emergency, healthy, sub-healthy, and not-healthy.

21. The method of claim 14, wherein
the health index is determined based on a set of health data associated with the user and the vitality index is determined based on a set of vital data associated with the user,
the set of health data includes at least one of diet, sleeping, mode, and activity of the user, and
the set of vital data includes at least one of blood pressure, heart rate, body temperature, breathing rate, SPO2, body velocity, glucose, ECG, and skin conductivity.

22. The method of claim 14, wherein the health assistance includes providing health assistance information.

23. The method of claim 22, wherein the health assistance information includes at least one of real-time feedback, online physician instruction, health related recommendations, health report, and health intelligence.

24. The method according to claim 22, further comprising presenting the health assistance information to the user in a manner that is adapted with respect to the user.

25. The method of claim 14, further comprising providing emergency related assistance to the user at the location of the user when the at least one health condition class corresponds to an emergency classification.

26. The method of claim 25, wherein the step of providing the emergency related assistance comprises contacting, by the health service engine via the network, at least one of
the user;
one or more contacts associated with the user;
at least one rescuers for soliciting help to rescue the user; and
one or more health care professionals to provide emergency related assistance.

27. The method of claim 25, wherein the step of providing the emergency related assistance comprises
receiving, via the network, information from at least one of
the user;
a contact associate with the user,
a rescuer, and
a health care professional; and
presenting the received information to the user.

28. The method according to claim 27, wherein the received information is presented to the user in a manner that is dynamically adapted to the at least one health condition class with respect to the user.
